(19) United States
(12) Patent Application Publication
(10) Pub. No.: US 2012/0315364 A1
(43) Pub. Date: Dec. 13, 2012

(54) HEAT STABLE VESSEL

(75) Inventors: Cary Richard Champlin, Issaquah, WA (US); Lawrence Morgan Fowler, Redmond, WA (US); Zihong Guo, Bellevue, WA (US); Jenny E. Hu, Seattle, WA (US); Ian Fletcher Kent, Cambridge (GB); Ian Murray, Seattle, WA (US); Nathan John Pegram, Seattle, WA (US); Shannon Weise Stone, Redmond, WA (US); Sarah Patricia Walters, Bellevue, WA (US); Lowell L. Wood, JR., Bellevue, WA (US); Ozgur Emek Yildirim, Bellevue, WA (US); Christopher C. Young, Seattle, WA (US)

(73) Assignee: TOKITAE LLC, a limited liability company of the State of Delaware

(21) Appl. No.: 13/492,664

(22) Filed: Jun. 8, 2012

Related U.S. Application Data
(60) Provisional application No. 61/520,578, filed on Jun. 9, 2011.

(51) Int. Cl. A23C 3/02

(52) U.S. Cl. 426/522; 99/483; 426/521; 99/453

(57) ABSTRACT

The present disclosure relates to methods, systems, and devices that may be used to heat treat and store one or more fluids.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications, including any priority claims, is incorporated herein by reference to the extent such subject matter is not inconsistent herewith.

### RELATED APPLICATIONS

For purposes of the USPTO extra-statutory requirements, the present application constitutes a continuation-in part of U.S. Patent Application No. 61/520,578, entitled HEAT STABLE VESSEL, naming Zihong Guo; Ian Fletcher Kent; Ian Murray; Shannon Weise Stone; Lowell L. Wood, Jr.; Ozgur Emek Yildirim; Christopher C. Young as inventors, filed 9 Jun. 2011, which is currently co-pending or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above, but expressly points out that such designation(s) are not to be construed in any way as any type of commentary and/or admission as to whether or not the present application contains any new matter in addition to the matter of its parent application(s).

### TECHNICAL FIELD

The present disclosure relates to devices, systems, and methods that may be used to treat and store fluids. In some embodiments, the systems, devices, and methods may be used to treat, store, and transport milk.

### SUMMARY

In one aspect, a device includes but is not limited to a vessel that includes one or more container members, one or more heater units operably associated with the vessel, and one or more control units that are time and temperature integrators and configured to dynamically operate the one or more heater units in accordance with one or more predetermined time versus temperature parameter sets. In some embodiments, a device may optionally include one or more agitator units. In some embodiments, a device may optionally include one or more dispenser units. In some embodiments, a device may optionally include one or more monitoring units. In some embodiments, a device may optionally include one or more user interfaces. In some embodiments, a device may optionally include one or more alert units that are configured to process temperature data and time data in accordance with at least one predetermined time versus temperature parameter set and produce an alert when fluid contained within the vessel is safe for consumption. In addition to the foregoing, other device aspects are described in the claims, drawings, and text forming a part of the present disclosure.

In one aspect, a device includes but is not limited to a vessel that includes one or more container members, one or more heater units operably associated with the vessel one or more control units configured to operate the one or more heater units, and one or more alert units that include one or more microprocessors that are configured to process temperature data and time data in accordance with one or more predetermined time versus temperature parameter sets and produce an alert when fluid contained within the vessel is safe for consumption. In addition to the foregoing, other device aspects are described in the claims, drawings, and text forming a part of the present disclosure.

In one aspect, a fluid heating and storage method includes but is not limited to heating one or more fluids to one or more temperatures within a range from about 50 degrees Celsius to about 80 degrees Celsius and maintaining the one or more fluids for a time period greater than about 60 minutes within the temperature range from about 50 degrees Celsius to about 80 degrees Celsius. In addition to the foregoing, other device aspects are described in the claims, drawings, and text forming a part of the present disclosure.

In one aspect, a system includes but is not limited to circuitry configured to operate one or more control units that dynamically control one or more heater units in accordance with one or more predetermined time versus temperature parameter sets that are specific for one or more fluids that are to be pasteurized and circuitry configured to operate one or more heater units in response to the circuitry configured to operate one or more control units that dynamically control one or more heater units in accordance with one or more predetermined time versus temperature parameter sets that are specific for one or more fluids that are to be pasteurized. In some embodiments, a device may optionally include circuitry configured to control one or more agitator units. In some embodiments, a device may optionally include circuitry configured to control one or more dispenser units. In some embodiments, a device may optionally include circuitry configured to control one or more monitoring units. In some embodiments, a device may optionally include circuitry configured to control one or more user interfaces. In some embodiments, a device may optionally include circuitry configured to control one or more alert units that are configured to process temperature data and time data in accordance with one or more predetermined time versus temperature parameter sets that are specific for one or more fluids and produce an alert when the one or more fluids are safe for consumption. In addition to the foregoing, other device aspects are described in the claims, drawings, and text forming a part of the present disclosure.

In one aspect, system includes but is not limited to one or more instructions for operating one or more heater units and one or more instructions for operating one or more control units that are time and temperature integrators and configured to dynamically operate the one or more heater units in accordance with one or more predetermined time versus temperature parameter sets. In some embodiments, a device may optionally include one or more instructions for operating one or more agitator units. In some embodiments, a device may optionally include one or more instructions for operating one or more dispenser units. In some embodiments, a device may optionally include one or more instructions for operating one or more monitoring units. In some embodiments, a device may optionally include one or more instructions for operating one or more user interfaces. In some embodiments, a device may optionally include one or more instructions for operating one or more alert units that are configured to process temperature data and time data in accordance with at least one predetermined time versus temperature parameter set and produce an alert when fluid contained within the vessel is safe for consumption. In addition to the foregoing, other device aspects are described in the claims, drawings, and text forming a part of the present disclosure.

In one aspect, an agent delivery device includes but is not limited to one or more instructions for operating one or more heater units, one or more instructions for operating one or more control units configured to operate the one or more heater units, and one or more instructions for operating one or more alert units that include one or more microprocessors that are configured to process temperature data and time data in accordance with one or more predetermined time versus temperature parameter sets and produce an alert when fluid contained within the vessel is safe for consumption. In addition to the foregoing, other device aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 2 illustrates an example device 200 in which embodiments may be implemented.

FIG. 3 illustrates an example device 200 in which embodiments may be implemented.

FIG. 4 illustrates an example device 200 in which embodiments may be implemented.

FIG. 5 illustrates an example device 200 in which embodiments may be implemented.

FIG. 6 illustrates an example device 200 in which embodiments may be implemented.

FIG. 7 illustrates an example device 200 in which embodiments may be implemented.

FIG. 8 illustrates an example device 800 in which embodiments may be implemented.

FIG. 9 illustrates an example device 800 in which embodiments may be implemented.

FIG. 10 illustrates an example device 1000 in which embodiments may be implemented.

FIG. 11 illustrates an example device 1000 in which embodiments may be implemented.

FIG. 12 illustrates an example device 1200 in which embodiments may be implemented.

FIG. 13 illustrates an example device 1200 in which embodiments may be implemented.

FIG. 14 illustrates an example device 1200 in which embodiments may be implemented.

FIG. 15 illustrates an example device 1500 in which embodiments may be implemented.

FIG. 16 illustrates an example device 1500 in which embodiments may be implemented.

FIG. 17 illustrates an example device 1700 in which embodiments may be implemented.

FIG. 18 illustrates an example device 1700 in which embodiments may be implemented.

FIG. 19 illustrates an example device 1700 in which embodiments may be implemented.

FIG. 20 illustrates an example device 2000 in which embodiments may be implemented.

FIG. 21 illustrates an example device 2000 in which embodiments may be implemented.

FIG. 22 illustrates an example device 2000 in which embodiments may be implemented.

FIG. 23 illustrates an example device 2000 in which embodiments may be implemented.

FIG. 24 illustrates an example device 2000 in which embodiments may be implemented.

FIG. 25 illustrates an example device 2000 in which embodiments may be implemented.

FIG. 26 illustrates operation flow 2600 in which embodiments may be implemented.

FIG. 27 illustrates operation flow 2600 in which embodiments may be implemented.

FIG. 28 illustrates operation flow 2600 in which embodiments may be implemented.

FIG. 29 illustrates operation flow 2600 in which embodiments may be implemented.

FIG. 30 illustrates operation flow 2600 in which embodiments may be implemented.

FIG. 31 illustrates operation flow 2600 in which embodiments may be implemented.

FIG. 32 illustrates operation flow 2600 in which embodiments may be implemented.

FIG. 33 illustrates operation flow 2600 in which embodiments may be implemented.

FIG. 34 illustrates operation flow 2600 in which embodiments may be implemented.

FIG. 35 illustrates system 3500 in which embodiments may be implemented.

FIG. 36 illustrates system 3600 in which embodiments may be implemented.

FIG. 37 illustrates system 3700 in which embodiments may be implemented.

FIG. 38 illustrates system 3800 in which embodiments may be implemented.

FIG. 39 illustrates system 3900 in which embodiments may be implemented.

FIG. 40 illustrates system 4000 in which embodiments may be implemented.

FIG. 41 illustrates system 4100 in which embodiments may be implemented.

FIG. 42 illustrates a vessel 4200.

FIG. 43 illustrates vessel 4300.

FIG. 44 illustrates heater unit 4400.

FIG. 45 illustrates pump/agitator unit 4500.

FIG. 46 illustrates an agitator unit 4600.

FIG. 47 illustrates a temperature profile of milk throughout low temperature, extended time pasteurization and subsequent cooling.

FIG. 48 illustrates a temperature profile of milk throughout low temperature, extended time pasteurization and subsequent holding.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

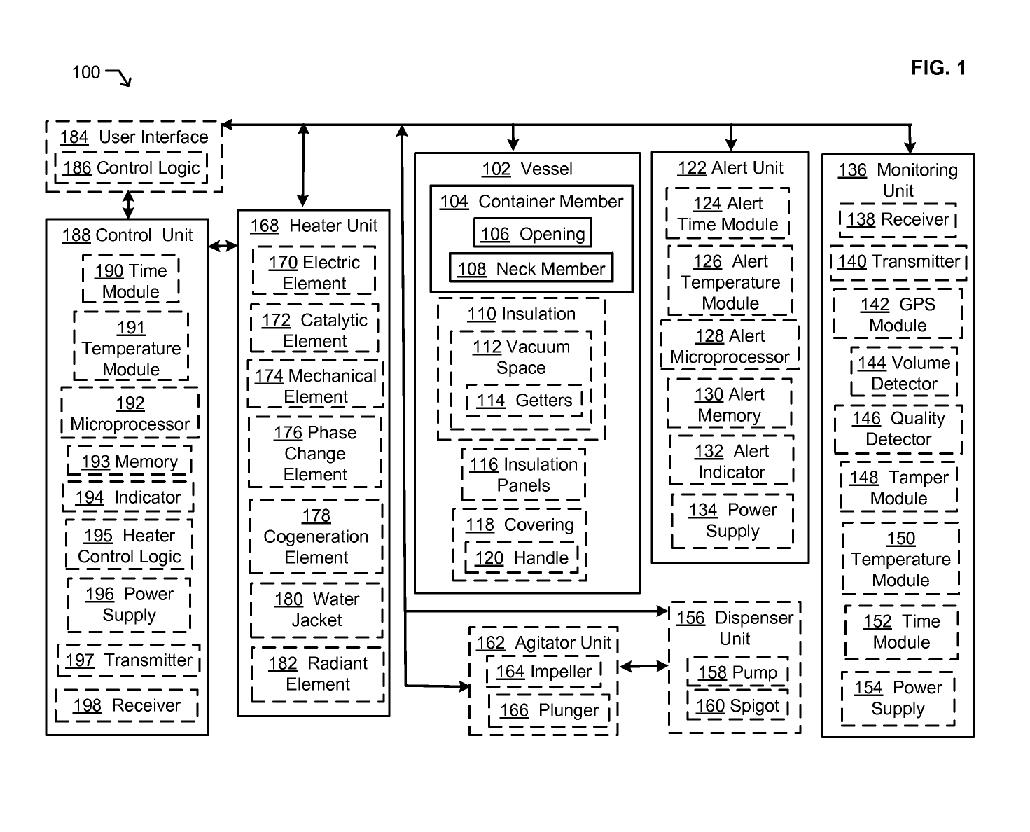

FIG. 1 illustrates an example system 100 in which embodiments may be implemented. The system 100 may include one or more vessels 102. The system 100 may include one or more alert units 122. The system 100 may include one or more monitoring units 136. The system 100 may include one or more dispenser units 156. The system 100 may include one or more agitator units 162. The system 100 may include one or more heater units 168. The system 100 may include one or more control units 188. The system 100 may include one or more user interfaces 184.

### Vessel

System 100 may include numerous types of vessels 102. Vessel 102 includes a container member 104. In some embodiments, a container member 104 may be fluid impermeable. In some embodiments, a container member 104 may be single walled. In some embodiments, a container member 104 may be double walled. In some embodiments, a container member 104 may include a nested series of container members 104. For example, in some embodiments, a container member 104 may be a nested container member 104 having one container member 104 nested within another container member 104. In some embodiments, a container member 104 may include a nested container member 104 having one container member 104 nested within another container member 104 and a flexible neck that connects the two container members 104. In some embodiments, system 100 may include a vessel 102 that is operably coupled to a heater unit 168. In some embodiments, system 100 may include a vessel 102 that is operably coupled to a control unit 188. In some embodiments, system 100 may include a vessel 102 that is operably coupled to an agitator unit 162. In some embodiments, system 100 may include a vessel 102 that is operably coupled to a dispenser unit 156. In some embodiments, system 100 may include a vessel 102 that is operably coupled to a monitoring unit 136. In some embodiments, system 100 may include a vessel 102 that includes a container member 104 having a vacuum space 112. In some embodiments, system 100 may include a vessel 102 that includes a container member 104 having a vacuum space 112 and one or more getters 114 within the vacuum space 112. In some embodiments, system 100 may include a vessel 102 that includes a container member 104 having insulation 110. In some embodiments, system 100 may include a vessel 102 that includes a container member 104 having insulation 110 that includes insulation panels 116. In some embodiments, system 100 may include a vessel 102 that includes a container member 104 having insulation 110 that includes vacuum insulation panels 116. Examples of additional types of insulation include, but are not limited to, foams, aerogels, metal building insulation, phase change materials, and the like. In some embodiments, vessel 102 may include numerous combinations of different types of insulation. In some embodiments, system 100 may include a vessel 102 that includes a container member 104 having a neck member 108. In some embodiments, system 100 may include a vessel 102 that includes a container member 104 having a flexible neck member 108. In some embodiments, system 100 may include a vessel 102 that includes a covering 118. In some embodiments, system 100 may include a vessel 102 that includes a covering 118 that includes one or more handles 120. A vessel 102 and a container member 104 may be constructed of numerous types of materials. Examples of such materials include, but are not limited to, metals, glasses, polymers, ceramics, composite materials, and the like. In some embodiments, a vessel 102 and a container member 104 may be constructed from combinations of materials. Examples of such combinations of materials include, but are not limited to, combinations of metals, glasses, polymers, ceramics, composite materials, and the like. A vessel 102 may be configured in numerous ways. Examples of such configurations include, but are not limited to, round configurations, square configurations, rectangular configurations, and the like. In some embodiments, a vessel 102 may be configured for attachment to a vehicle. For example, in some embodiments, a vessel 102 may be configured to attachment to a motorcycle. In some embodiments, a vessel 102 may be configured for attachment to a bicycle. In some embodiments, a vessel 102 may be configured for attachment to an automobile. In some embodiments, a vessel 102 may be configured for attachment to a truck.

### Heater Unit

System 100 may include numerous types of heater units 168 and combinations of heater units 168. Examples of such heater units 168 include, but are not limited to, electric heater units 170 (e.g., electric heater elements, direct ohmic heaters, and the like), catalytic heater units 172, water/steam jackets 180, cogeneration heater units 178 (e.g., one or more heater units 168 that collect heat from vehicle exhaust), radiant heater units 182 (e.g., one or more heater units that collect heat from sunlight), mechanical heater units 174, phase change material based heater units 176, inductive heater unit, and the like. In some embodiments, a catalyst may be used for low-temperature oxidation of fuel-gas-grade hydrocarbons (e.g., propane, butane, and the like) to maintain systems at low to moderate temperatures. For example, in some embodiments, a thermostatically-driven valve on a tank of such a fuel-gas may be input to such a ‘flameless catalyst’ (after air-mixing) that would oxidize the gas to produce heat and a countercurrent flow heat-exchanger may be used to extract the total heat-of-combustion. In some embodiments, a heater unit 168 may be operably coupled to one or more control units 188. In some embodiments, a heater unit 168 may be operably coupled to one or more monitoring units 136. In some embodiments, a heater unit 168 may be operably coupled to one or more user interfaces 184. Heater unit 168 may be configured to heat one or more fluids that are contained in vessel 102 to numerous temperatures. Heater unit 168 may be configured to maintain one or more fluids that are contained in vessel 102 at numerous temperatures. Heater unit 168 may be configured to maintain one or more fluids that are contained in vessel 102 at numerous temperatures for numerous time periods. In some embodiments, one or more heater units 168 may be operably coupled with one or more cooling units that act to cool one or more fluids. For example, in some embodiments, one or more cooling units may include a refrigeration capacity. Such units include, but are not limited to, cooling units that utilize a compressor and a phase change material to cool a fluid. In some embodiments, a cooling unit may utilize ice to cool one or more fluids. In some embodiments, a cooling unit may utilize one or more water jackets to cool one or more fluids. Accordingly, numerous methodologies may be used to cool one or more fluids.

### Control Unit

System 100 may include numerous types of control units 188 and combinations of control units 188. Examples of such control units 188 include, but are not limited to, electronic control units 188, mechanical control units 188, and the like. In some embodiments, a control unit 188 may include one or more time modules 190 that determine time. In some embodiments, a control unit 188 may include one or more temperature modules 191 that determine temperature. In some embodiments, a control unit 188 may include one or more microprocessors 192. Such microprocessors 192 may be configured to access one or more databases that contain time and temperature related information related to pasteurization of specific food products. For example, in some embodiments, a database may include time and temperature curves that indicate what times and temperatures are used to pasteurize milk. For example, in some embodiments, a database may include time and temperature curves that indicate what times and temperatures are used to pasteurize fruit juice. In some embodiments, a control unit 188 may include memory 193. In some embodiments, a control unit 188 may include one or more indicators 194 that indicate when fluid contained within a vessel 102 is safe for consumption following heat treatment. In some embodiments, a control unit 188 may include heater control logic 195 which is programmed to control one or more heater units 168 to follow a predetermined time and temperature profile to pasteurize a specific product. In some embodiments, a control unit 188 may include one or more microprocessors 192. Such microprocessors 192 may be configured to access one or more databases that contain time and temperature related information related to sanitization of specific food products. For example, in some embodiments, a database may include time and temperature curves that indicate what times and temperatures are used to sanitization milk. For example, in some embodiments, a database may include time and temperature curves that indicate what times and temperatures are used to sanitization fruit juice. In some embodiments, a control unit 188 may include memory 193. In some embodiments, a control unit 188 may include one or more indicators 194 that indicate when fluid contained within a vessel 102 is safe for consumption following heat treatment. In some embodiments, a control unit 188 may include heater control logic 195 which is programmed to control one or more heater units 168 to follow a predetermined time and temperature profile to sanitize a specific product. In some embodiments, a control unit 188 may include heater control logic 195 that is programmed to control one or more heater units 168 to follow an equation that utilizes time and temperature data to pasteurize and/or sanitize a specific product. In some embodiments, a control unit 188 may include one or more microprocessors 192. Such microprocessors 192 may be configured to access one or more databases that contain time and temperature related information related to pasteurization and/or sanitization of specific food products. For example, in some embodiments, a database may include equations that utilize time and temperature data to indicate what times and temperatures can be used to pasteurize and/or sanitization milk. In some embodiments, a control unit 188 may include one or more power supplies 196. Numerous types of power supplies 196 may be used within system 100. Examples of such power supplies 196 include, but are not limited to, batteries, capacitors, solar panels, generators, and the like. In some embodiments, a control unit 188 may be operably coupled to one or more user interfaces 184. In some embodiments, a control unit 188 may be operably coupled to one or more heater units 168. In some embodiments, a control unit 188 may be operably coupled to one or more agitator units 162. In some embodiments, a control unit 188 may be operably coupled to one or more monitoring units 136. In some embodiments, a control unit 188 may include one or more receivers 198. In some embodiments, a control unit 188 may be operably coupled to one or more transmitters 197. In some embodiments, a control unit 188 may be configured to communicate with an independent device. Examples of wireless devices include, but are not limited to, cellular telephones, personal digital assistants, and the like. Control units 188 may be configured to control one or more heater units 168 to heat one or more fluids that are contained in vessel 102 to numerous temperatures. Control units 188 may be configured to control one or more heater units 168 to maintain one or more fluids that are contained in vessel 102 at numerous temperatures. Control units 188 may be configured to control one or more heater units 168 to heat one or more fluids that are contained in vessel 102 to numerous temperatures and maintain numerous temperatures for numerous time periods.

### Agitator Unit

System 100 may include numerous types of agitator units 162 and combinations of agitator units 162. Examples of such agitator units 162 include, but are not limited to, impellers, French-press type agitator units 162, mechanical agitator units 162, hand operated agitator units 162, electrically operated agitator units 162, and the like. In some embodiments, one or more agitator units 162 may be configured to agitate milk to avoid separation of the milk.

### Dispenser Unit

System 100 may include numerous types of dispenser units 156 and combinations of dispenser units 156. Examples of such dispenser units 156 include, but are not limited to, hand-pumped dispenser units 156, gas operated dispenser units 156, gravity operated dispenser units 156, and the like. One or more dispenser units 156 may be operably coupled to numerous types of pumps. Examples of such pumps include, but are not limited to, peristaltic pumps, hand pumps, vacuum pumps, suction pumps, and the like. In some embodiments, one or more dispenser units 156 may be operably coupled to one or more agitator units 162. In some embodiments, one or more dispenser units 156 may be operably coupled to one or more control units 188. In some embodiments, one or more dispenser units 156 may be operably coupled to one or more monitoring units 136.

### Monitoring Unit

System 100 may include numerous types of monitoring units 136 and combinations of monitoring units 136. Examples of such monitoring units 136 include, but are not limited to, mechanical monitoring units 136, electronic monitoring units 136, and the like. Monitoring unit 136 may be configured to monitor numerous parameters. Examples of such parameters include, but are not limited to, time, temperature, fluid level, fluid characteristics, location, temperature history, fluid level history, fluid characteristic history, location history, and the like. In some embodiments, one or more monitoring units 136 may include one or more transmitters 140. In some embodiments, one or more monitoring units 136 may include one or more receivers 138. In some embodiments, one or more monitoring units 136 may be configured to communicate with an independent device. Examples of wireless devices include, but are not limited to, cellular telephones, personal digital assistants, and the like. In some embodiments, one or more monitoring units 136 may be configured to include security features. Examples of such security features include, but are not limited to, biometric security features (e.g., fingerprint analysis, retinal scan, voice recognition, facial recognition), magnetic detectors that monitoring opening and/or closing of a device, and combinations thereof. In some embodiments, one or more monitoring units 136 may include one or more quality detectors 146. Such quality detectors may determine the quality of a produce contained within a vessel 102. For example, in some embodiments, a quality detector may determine the quality of milk contained within a vessel 102. In some embodiments, one or more monitoring units 136 may include one or more global positioning systems 142. In some embodiments, one or more monitoring units 136 may include one or more power supplies 154.

### Alert Unit

System 100 may include one or more alert units 122. In some embodiments, an alert unit 122 may include one or more alert microprocessors 128. In some embodiments, an alert unit 122 may include alert memory 130. In some embodiments, an alert unit 122 may include one or more alert temperature modules 126 that determine temperature of a product contained within a vessel 102. In some embodiments, an alert unit 122 may include one or more alert time modules 124 that determine the time that a product contained within a vessel 102 has been heat treated. In some embodiments, an alert unit 122 may include one or more power supplies 134. In some embodiments, an alert unit 122 may include one or more alert indicators 132. In some embodiments, an alert unit 122 may use an alert indicator 132 to indicate that a product contained within a vessel 102 is safe for consumption after being heat treated. In some embodiments, an alert unit may utilize a time and temperature integrator function to determine if and when a product that is contained within a vessel 102 is safe for consumption. For example, in some embodiments, an alert unit 122 may utilize time and temperature data to determine that milk has been adequately pasteurized. In some embodiments, an alert unit 122 may utilize time and temperature data to determine that milk has been adequately pasteurized and then send a signal indicating that the milk is safe to consume. Such signals may be optical, auditory, and the like.

### User Interface

System 100 may include one or more user interfaces 184. Numerous types of user interfaces 184 may be used within system 100. Examples of such user interfaces 184 include, but are not limited to, interfaces with mobile devices, keyboards, keypads, touchpads, and the like. Accordingly, in some embodiments, a user may interact with system 100 wirelessly. In some embodiments, a user interface 184 may include control logic 186 which may be configured to control aspects of system 100. For example, in some embodiments, a user interface 184 may include control logic 186 that is configured to control a control unit 188, a heater unit 168, an alert unit 122, a dispenser unit 156, an agitator unit 162, a monitoring unit 136, and/or any combination thereof.

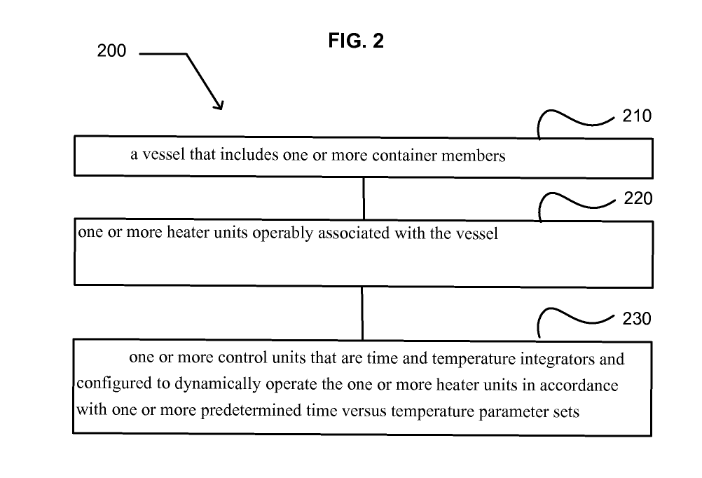

FIG. 2 illustrates an example device 200 in which embodiments may be implemented. Device 200 includes a vessel 210 and a heating unit 220 that is operably coupled to a control unit 230. In some embodiments, the control unit 230 is configured to operate the heating unit 220 to maintain fluid contained within the vessel 210 at a temperature between 40-80 degrees Celsius. In some embodiments, the control unit 230 is configured to operate the heating unit 220 to maintain fluid contained within the vessel 210 at a temperature between 50-80 degrees Celsius. In some embodiments, the control unit 230 is configured to operate the heating unit 220 to maintain fluid contained within the vessel 210 at a temperature between 50-70 degrees Celsius. In some embodiments, the control unit 230 is configured to operate the heating unit 220 to maintain fluid contained within the vessel at a temperature between 55-65 degrees Celsius. In some embodiments, one or more control units 230 that are time and temperature integrators and configured to dynamically operate the one or more heater units 220 in accordance with one or more predetermined time versus temperature parameter sets. For example, in some embodiments, a control unit may operate the heating unit 220 according to a predetermined temperature profile that is specific for pasteurization of a specific fluid. In some embodiments, a control unit may operate the heating unit 220 according to a predetermined temperature profile that is specific for pasteurization of milk.

FIG. 2 illustrates embodiment 200 of device 200 within system 100. In FIG. 2, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 200 may include vessel 210 that includes one or more container members. The embodiment 200 may include heater unit 220 that may operably associate with vessel 210. The embodiment 200 may include control unit 230 that is a time and temperature integrator and configured to dynamically operate the one or more heater units in accordance with one or more predetermined time versus temperature parameter sets.

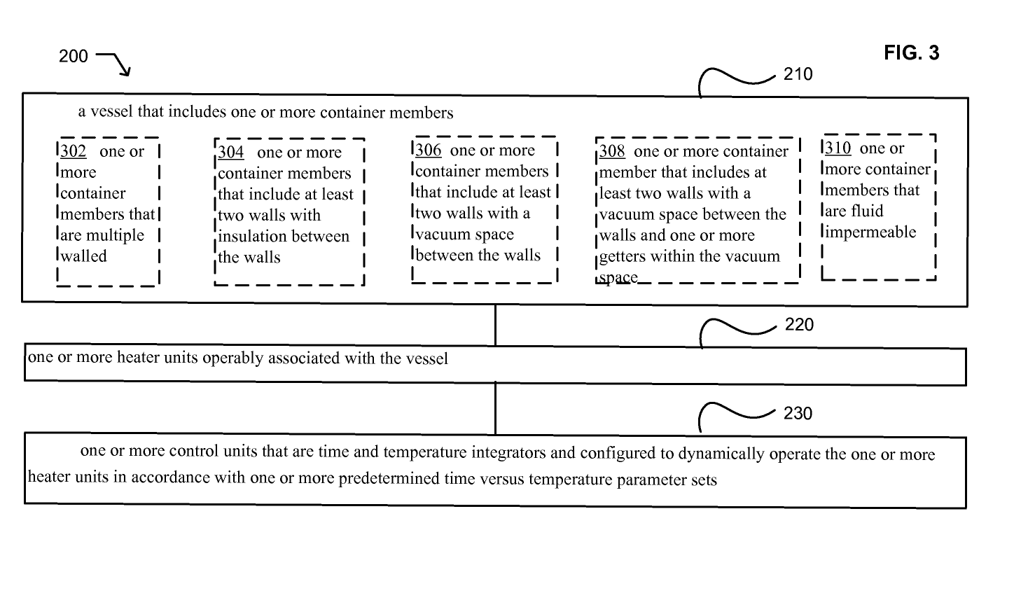

FIG. 3 illustrates alternative embodiments of vessel 210 of device 200 within system 100 of FIG. 1. FIG. 3 illustrates example embodiments of vessel 210. Additional embodiments may include an embodiment 302, an embodiment 304, an embodiment 306, an embodiment 308, and/or an embodiment 310.

At embodiment 302, vessel 210 may include one or more container members that are multiple walled. In some embodiments, device 200 may include a vessel 210 having one or more container members that are multiple walled. For example, in some embodiments, a container member may be a series of nested vessels.

At embodiment 304, vessel 210 may include one or more container members that include at least two walls with insulation between the walls. In some embodiments, device 200 may include a vessel 210 having one or more container members that include at least two walls with insulation between the walls. For example, in some embodiments, a container member may be a series of nested vessels with insulation between the walls. Numerous types of insulation may be used within a vessel.

At embodiment 306, vessel 210 may include one or more container members that include at least two walls with a vacuum space between the walls. In some embodiments, device 200 may include a vessel 210 having one or more container members that include at least two walls with a vacuum space between the walls.

At embodiment 308, vessel 210 may include one or more container members that include at least two walls with a vacuum space between the walls and one or more getters within the vacuum space. In some embodiments, device 200 may include a vessel 210 having one or more container members having at least two walls with a vacuum space between the walls and one or more getters within the vacuum space.

At embodiment 310, vessel 210 may include one or more container members that are fluid impermeable. In some embodiments, device 200 may include a vessel 210 having one or more container members that are fluid impermeable.

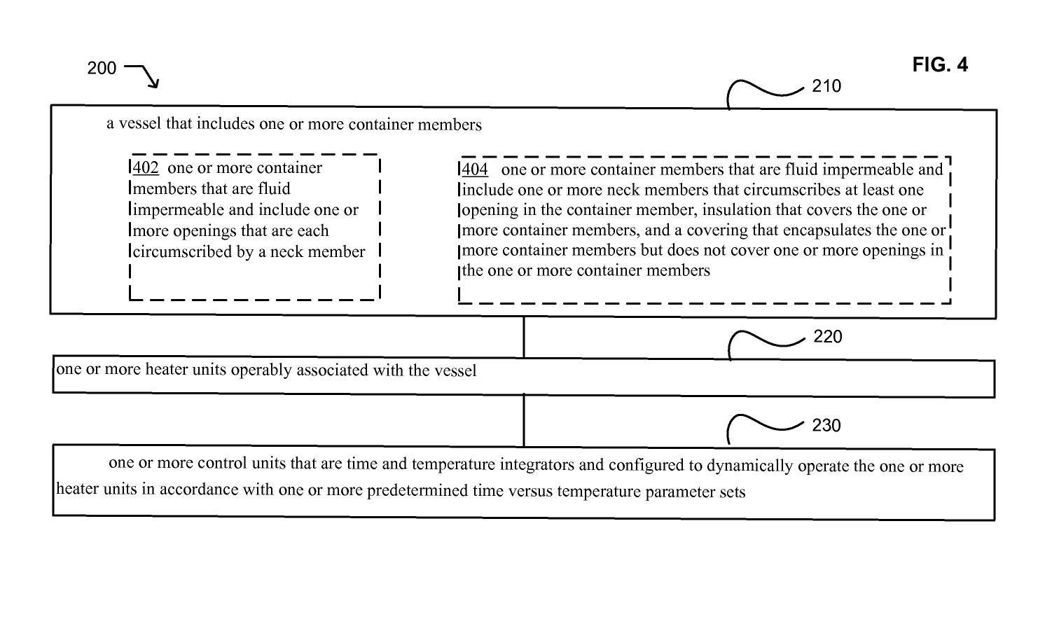

FIG. 4 illustrates alternative embodiments of vessel 210 of device 200 within system 100 of FIG. 1. FIG. 4 illustrates example embodiments of vessel 210. Additional embodiments may include an embodiment 402 and/or an embodiment 404.

At embodiment 402, vessel 210 may include one or more container members that are fluid impermeable and include one or more openings that are each circumscribed by a neck member. In some embodiments, device 200 may include a vessel 210 having one or more container members that include one or more openings that are each circumscribed by a neck member that is threaded. In some embodiments, a vessel 210 may include one or more container members that include openings that are each circumscribed by a neck member that is coupled to covering that covers the vessel 210.

At embodiment 404, vessel 210 may include one or more container members that are fluid impermeable and include one or more neck members that circumscribes at least one opening in the container member, insulation that covers the one or more container members, and a covering that encapsulates the one or more container members but does not cover one or more openings in the one or more container members.

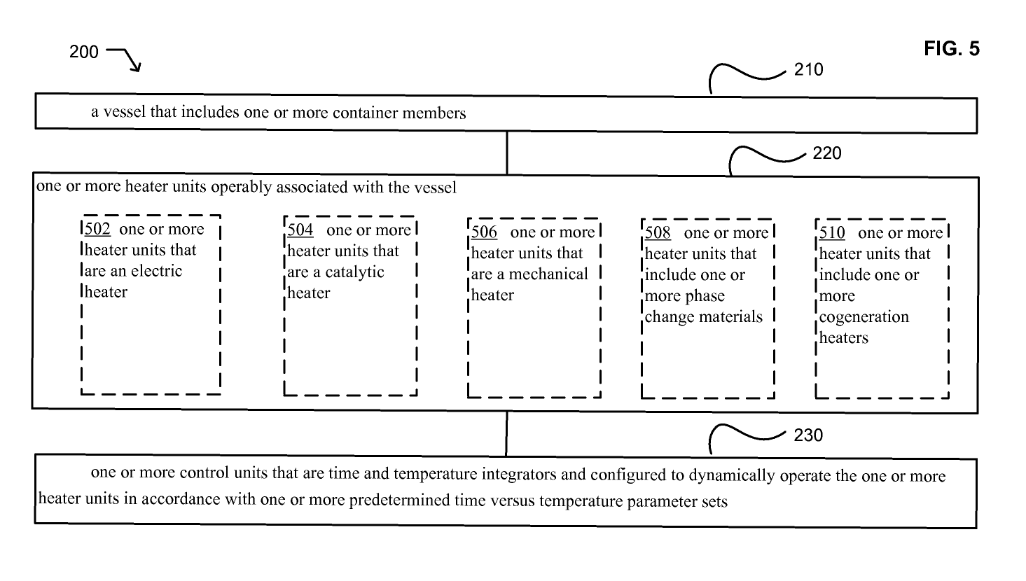

FIG. 5 illustrates alternative embodiments of heater unit 220 of device 200 within system 100 of FIG. 1. FIG. 5 illustrates example embodiments of heater unit 220. Additional embodiments may include an embodiment 502, an embodiment 504, an embodiment 506, an embodiment 508, and/or an embodiment 510.

At embodiment 502, heater unit 220 may include one or more heater units that are an electric heater. A device 200 may include numerous types of electrical heaters that include, but are not limited to, emersion heaters, resistive heaters, and the like.

At embodiment 504, heater unit 220 may include one or more heater units that are a catalytic heater. A device 200 may include numerous types of catalytic heaters that include, but are not limited to, heaters that combust a gas to produce heat.

At embodiment 506, heater unit 220 may include one or more heater units that are a mechanical heater. A device 200 may include one or more mechanical heaters that may generate heat through friction between one or more moving members. Such mechanical heaters may be hand cranked. In some embodiments, such mechanical heaters may be coupled to another device such as a bicycle.

At embodiment 508, heater unit 220 may include one or more heater units that include one or more phase change materials. A device 200 may include one or more phase change materials. Numerous types of phase change materials may be included within a heater unit 220 (e.g., Farid et al., A review on phase change energy storage: materials and applications, Energy Conservation and Management (45), pgs. 1597-1615 (2004)).

At embodiment 510, heater unit 220 may include one or more heater units that include one or more cogeneration heaters. A device 200 may include one or more cogeneration heaters. For example, in some embodiments, a cogeneration heater may utilize energy derived from the operation of a vehicle to produce heat.

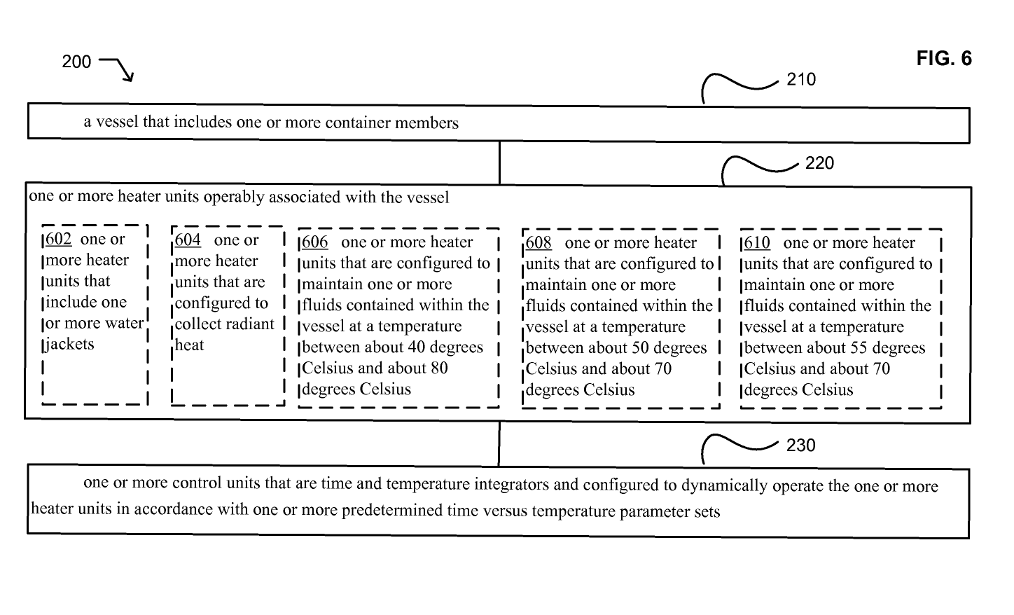

FIG. 6 illustrates alternative embodiments of heater unit 220 of device 200 within system 100 of FIG. 1. FIG. 6 illustrates example embodiments of heater unit 220. Additional embodiments may include an embodiment 602, an embodiment 604, an embodiment 606, an embodiment 608, and/or an embodiment 610.

At embodiment 602, heater unit 220 may include one or more heater units that include one or more water jackets. A device 200 may include one or more heater units 220 that include one or more water jackets. Hot water may be circulated through the heater unit 220 to heat fluid contained within a vessel 210. In some embodiments, water may be heated through use of energy derived from secondary sources. For example, the heat output from a vehicle may be used to heat water.

At embodiment 604, heater unit 220 may include one or more heater units that are configured to collect radiant heat. A device 200 may include one or more heater units 220 that are configured to collect radiant heat. For example, in some embodiments, a heater unit 220 may collect sun light to heat water.

At embodiment 606, heater unit 220 may include one or more heater units that are configured to maintain one or more fluids contained within the vessel at a temperature between about 40 degrees Celsius and about 80 degrees Celsius. A device 200 may include one or more heater units 220 that are configured to maintain one or more fluids contained within the vessel 210 at a temperature between about 40 degrees Celsius and about 80 degrees Celsius. In some embodiments, one or more control units 230 may control one or more heater units 220 to maintain one or more fluids contained within the vessel 210 at a temperature between about 40 degrees Celsius and about 80 degrees Celsius.

At embodiment 608, heater unit 220 may include one or more heater units that are configured to maintain one or more fluids contained within the vessel at a temperature between about 50 degrees Celsius and about 70 degrees Celsius. A device 200 may include one or more heater units 220 that are configured to maintain one or more fluids contained within the vessel 210 at a temperature between about 50 degrees Celsius and about 70 degrees Celsius. In some embodiments, one or more control units 230 may control one or more heater units 220 to maintain one or more fluids contained within the vessel 210 at a temperature between about 50 degrees Celsius and about 70 degrees Celsius.

At embodiment 610, heater unit 220 may include one or more heater units that are configured to maintain one or more fluids contained within the vessel at a temperature between about 55 degrees Celsius and about 70 degrees Celsius. A device 200 may include one or more heater units 220 that are configured to maintain one or more fluids contained within the vessel 210 at a temperature between about 55 degrees Celsius and about 70 degrees Celsius. In some embodiments, one or more control units 230 may control one or more heater units 220 to maintain one or more fluids contained within the vessel 210 at a temperature between about 55 degrees Celsius and about 70 degrees Celsius.

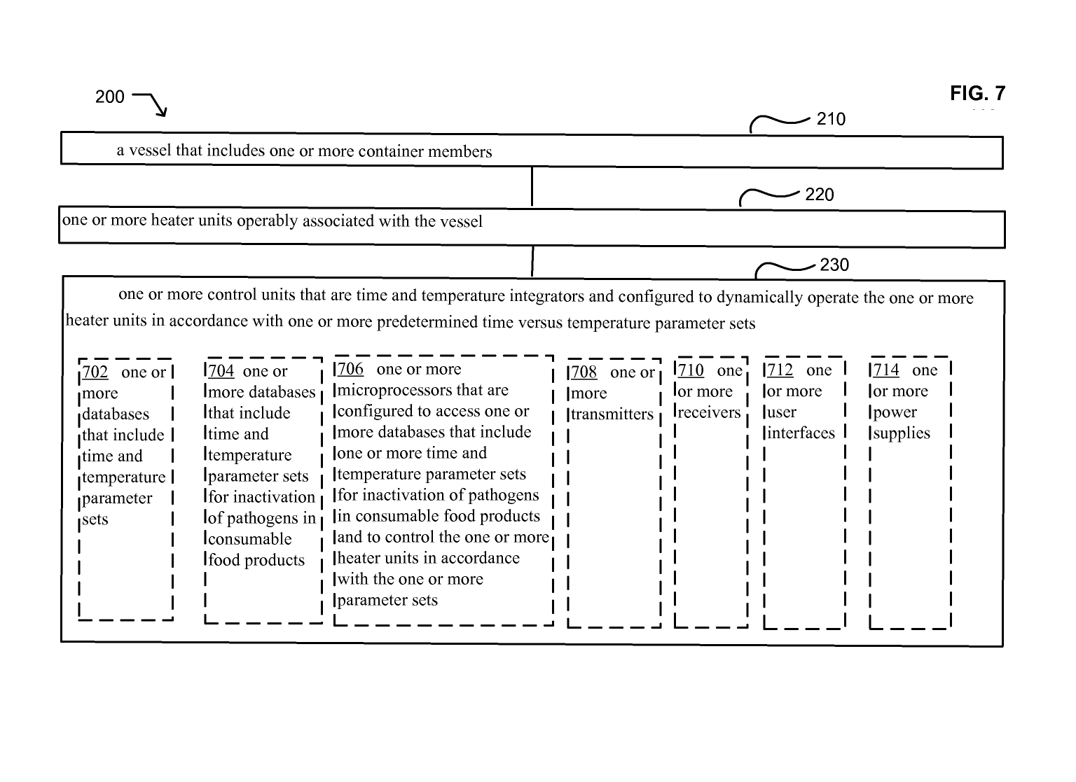

FIG. 7 illustrates alternative embodiments of control unit 230 of device 200 within system 100 of FIG. 1. FIG. 7 illustrates example embodiments of control unit 230. Additional embodiments may include an embodiment 702, an embodiment 704, an embodiment 706, an embodiment 708, an embodiment 710, an embodiment 712, and/or an embodiment 714.

At embodiment 702, control unit 230 may include one or more databases that include time and temperature parameter sets. A device 200 may include one or more control units 230 that include one or more databases that include time and temperature parameters that are related to a specific food product. For example, in some embodiments, a time and temperature parameter set may be specifically designed for milk pasteurization. In some embodiments, a time and temperature parameter set may be specifically designed for fruit juice pasteurization.

At embodiment 704, control unit 230 may include one or more databases that include time and temperature parameter sets for inactivation of pathogens in consumable food products. A device 200 may include one or more control units 230 that include one or more databases that include time and temperature parameters that are related to one or more pathogens in a food product. For example, in some embodiments, a time and temperature parameter set may be specifically designed to inactivate Escherichia coli. In some embodiments, time and temperature parameter sets may be designed to inactivate and/or kill a specific pathogen in a specific food product. For example, in some embodiments, a time and temperature parameter set may be specifically designed to kill specific pathogens that are found in milk.

At embodiment 706, control unit 230 may include one or more microprocessors that are configured to access one or more databases that include one or more time and temperature parameter sets for inactivation of pathogens in consumable food products and to control the one or more heater units in accordance with the one or more parameter sets. A device 200 may include one or more control units 230 that are configured to access one or more databases. Numerous technologies may be used to access one or more databases. For example, in some embodiments, a wireless device may be used to access a database.

At embodiment 708, control unit 230 may include one or more transmitters. A device 200 may include one or more control units 230 that include one or more transmitters. Numerous types of transmitters may be included in a control unit 230. For example, in some embodiments, a transmitter may be configured to transmit an infrared signal, a digital signal, an analog signal, a wireless signal, a radiofrequency signal, and the like.

At embodiment 710, control unit 230 may include one or more receivers. A device 200 may include one or more control units 230 that include one or more receivers. Numerous types of receivers may be included in a control unit 230. For example, in some embodiments, a receiver may be configured to receive an infrared signal, a digital signal, an analog signal, a wireless signal, a radiofrequency signal, and the like.

At embodiment 712, control unit 230 may include one or more user interfaces. A device 200 may include one or more control units 230 that include one or more user interfaces. Numerous types of user interfaces may be include in a control unit 230. Examples of such user interfaces include, but are not limited to, touchpads, keypads, wireless devices, and the like.

At embodiment 714, control unit 230 may include one or more power supplies. A device 200 may include one or more control units 230 that include one or more power supplies. Examples of such power supplies include, but are not limited to, batteries, capacitors, line current, and the like.

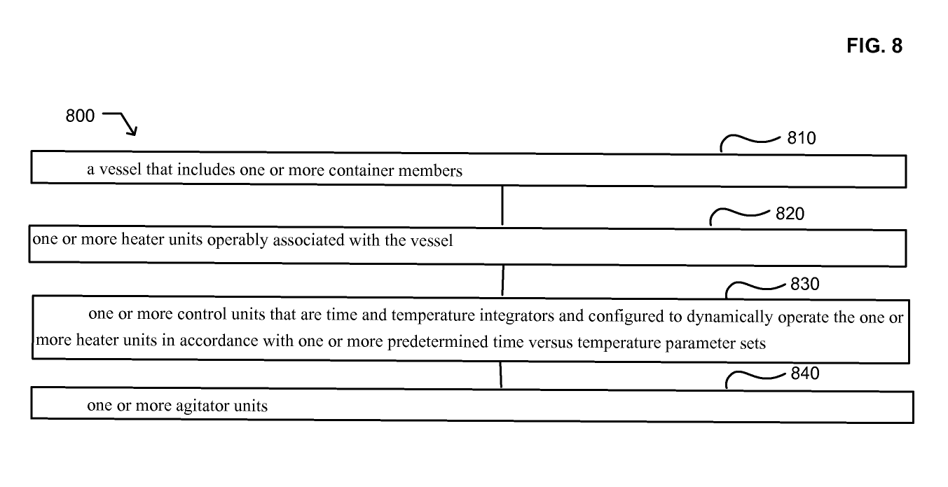

FIG. 8 illustrates an embodiment of device 800 within system 100. In FIG. 8, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 800 may include vessel 810 that includes one or more container members. The embodiment 800 may include heater unit 820 that may operably associate with vessel 810. The embodiment 800 may include control unit 830 that is a time and temperature integrator and configured to dynamically operate the one or more heater units in accordance with one or more predetermined time versus temperature parameter sets. The embodiment 800 may include agitator unit 840.

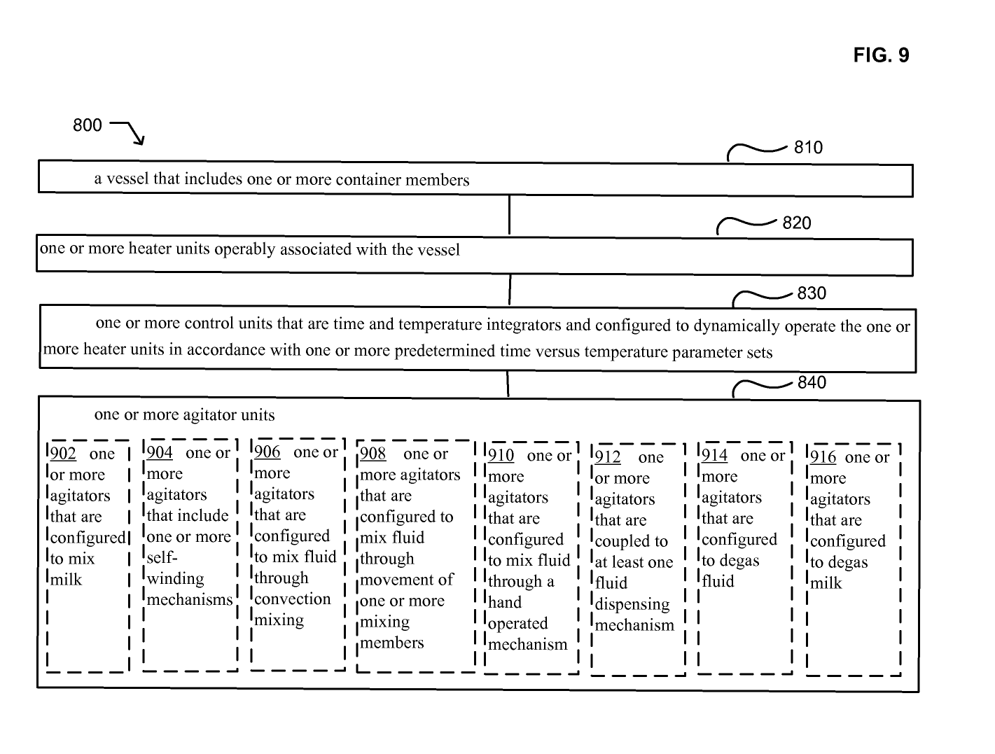

FIG. 9 illustrates alternative embodiments of agitator unit 840 of device 800 within system 100 of FIG. 1. FIG. 9 illustrates example embodiments of agitator unit 840. Additional embodiments may include an embodiment 902, an embodiment 904, an embodiment 906, an embodiment 908, an embodiment 910, an embodiment 912, an embodiment 914, and/or an embodiment 916.

At embodiment 902, agitator unit 840 may include one or more agitators that are configured to mix milk. A device 800 may include one or more agitators that are configured to mix milk. For example, in some embodiments, an agitator may be configured as a propeller, a paint mixer, an impeller, and the like.

At embodiment 904, agitator unit 840 may include one or more agitators that include one or more self-winding mechanisms. A device 800 may include one or more agitators that include one or more self-winding mechanisms such as a coil spring that is passively wound. For example, in some embodiments, a spring may be wound through wind power or water power.

At embodiment 906, agitator unit 840 may include one or more agitators that are configured to mix fluid through convection mixing. A device 800 may include one or more agitators that are configured to circulate water through a water jacket to facilitate convection mixing of fluid contained within a vessel.

At embodiment 908, agitator unit 840 may include one or more agitators that are configured to mix fluid through movement of one or more mixing members. A device 800 may include one or more agitators that are configured to mix fluid through movement of one or more impellers, propellers, French-style press type members, and the like.

At embodiment 910, agitator unit 840 may include one or more agitators that are configured to mix fluid through a hand operated mechanism. A device 800 may include one or more agitators that are configured to mix fluid through a hand crank mechanism. For example, in some embodiments, an impeller may be attached to a drive shaft that can be turned by hand to mix fluid contained within a vessel.

At embodiment 912, agitator unit 840 may include one or more agitators that are coupled to at least one fluid dispensing mechanism. A device 800 may include one or more agitators that are coupled to a fluid dispensing system such that fluids may be mixed and dispensed at the same time. For example, in some embodiments, an impeller may serve to mix fluid and to drive the fluid out of a dispenser.

At embodiment 914, agitator unit 840 may include one or more agitators that are configured to degas fluid. A device 800 may include one or more agitators that are configured to degas fluid. For example, in some embodiments, an agitator may be configured to turn a propeller very rapidly to cause degassing from a fluid.

At embodiment 916, agitator unit 840 may include one or more agitators that are configured to degas milk. A device 800 may include one or more agitators that are configured to degas milk. For example, in some embodiments, an agitator may be configured to turn a propeller very rapidly to cause degassing from milk.

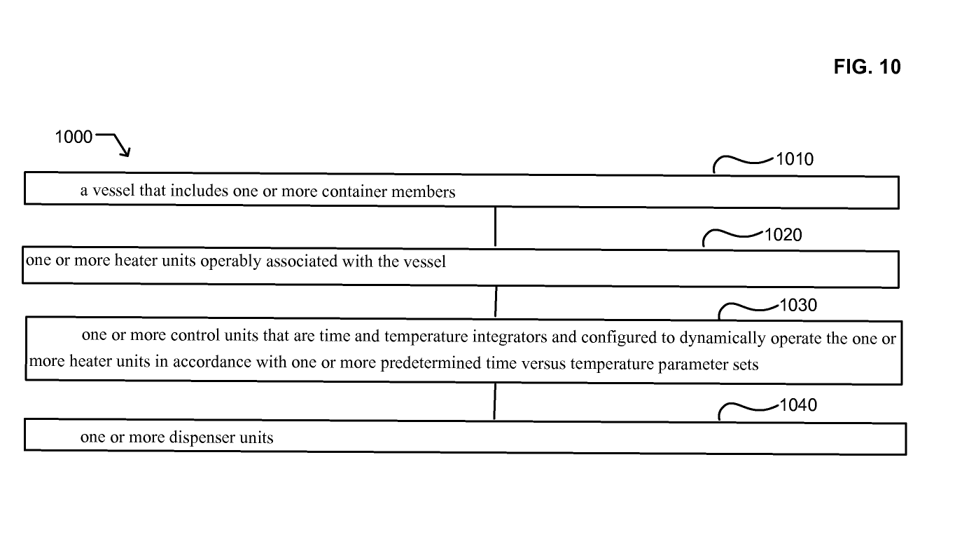

FIG. 10 illustrates an embodiment of device 1000 within system 100. In FIG. 10, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 1000 may include vessel 1010 that includes one or more container members. The embodiment 1000 may include heater unit 1020 that may operably associate with vessel 1010. The embodiment 1000 may include control unit 1030 that is a time and temperature integrator and configured to dynamically operate the one or more heater units in accordance with one or more predetermined time versus temperature parameter sets. The embodiment 1000 may include dispenser unit 1040

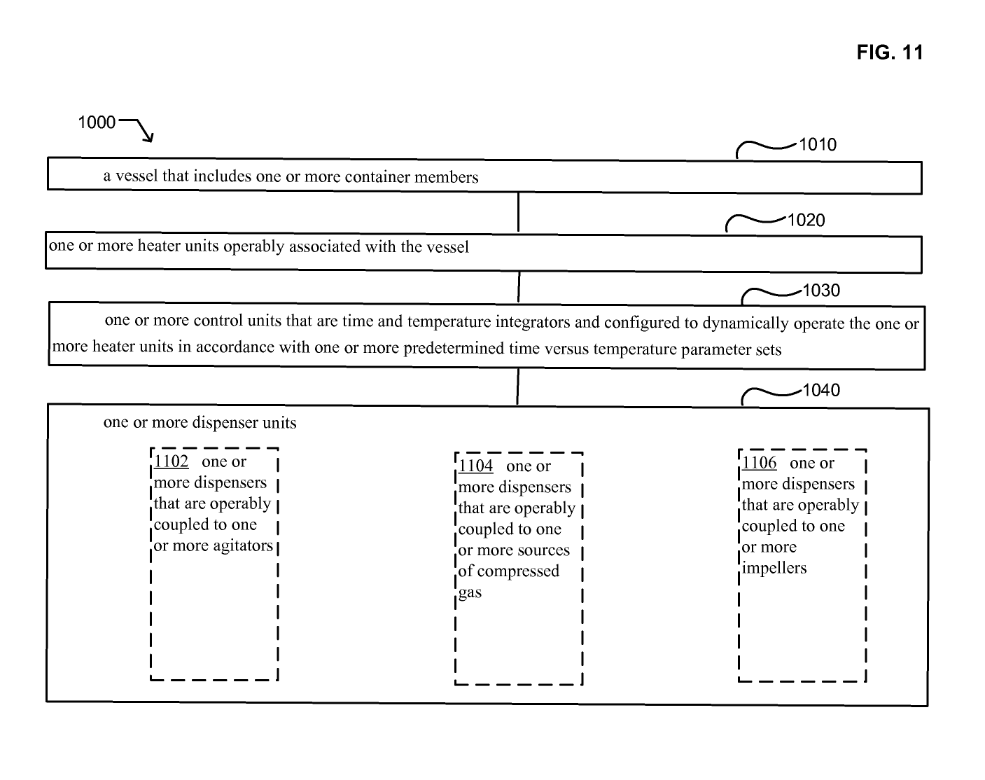

FIG. 11 illustrates alternative embodiments of embodiment 1040 of device 1000 within system 100 of FIG. 1. FIG. 11 illustrates example embodiments of dispenser unit 1040. Additional embodiments may include an embodiment 1102, an embodiment 1104, and/or an embodiment 1106.

At embodiment 1102, dispenser unit 1040 may include one or more dispensers that are operably coupled to one or more agitators. A device 1000 may include one or more dispensers that are operably coupled to one or more agitators such that a fluid is dispensed and mixed at the same time. For example, in some embodiments, an impeller may serve to mix fluid and to drive the fluid out of a dispenser.

At embodiment 1104, dispenser unit 1040 may include one or more dispensers that are operably coupled to one or more sources of compressed gas. A device 1000 may include one or more dispensers that are operably coupled to a source of compressed gas that will push fluid out of a vessel.

At embodiment 1106, dispenser unit 1040 may include one or more dispensers that are operably coupled to one or more impellers. A device 1000 may include one or more dispensers that are operably coupled to one or more impellers that serve to drive fluid out of a dispenser.

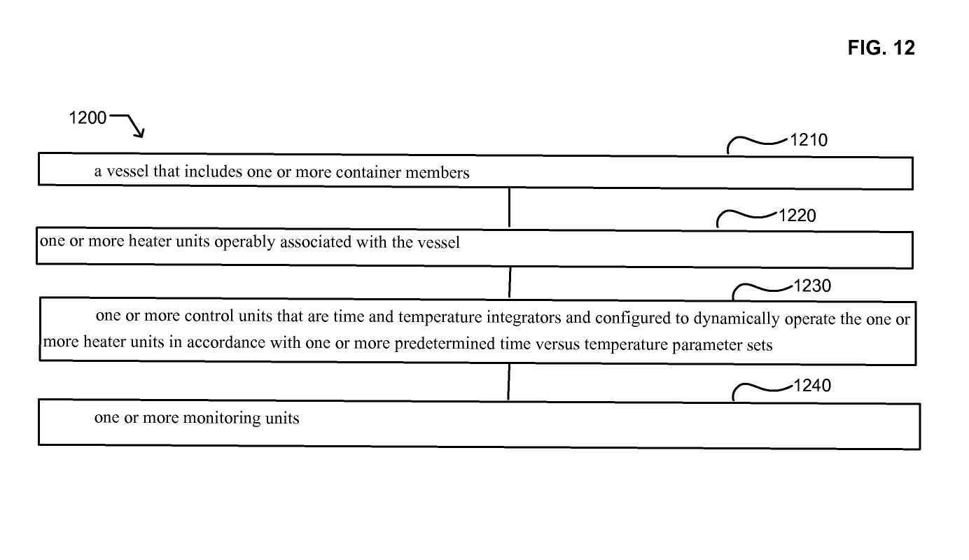

FIG. 12 illustrates an embodiment of device 1200 within system 100. In FIG. 12, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 1200 may include vessel 1210 that includes one or more container members. The embodiment 1200 may include heater unit 1220 that may operably associate with vessel 1210. The embodiment 1200 may include control unit 1230 that is a time and temperature integrator and configured to dynamically operate the one or more heater units in accordance with one or more predetermined time versus temperature parameter sets. The embodiment 1200 may include monitoring unit 1240.

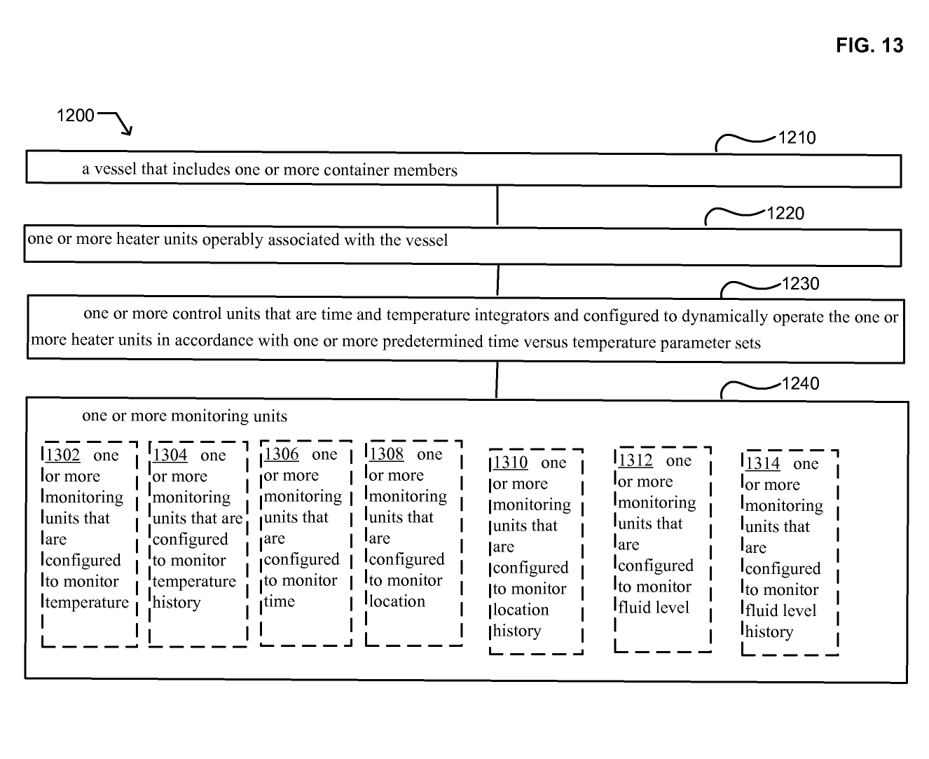

FIG. 13 illustrates alternative embodiments of a monitoring unit 1240 of device 1200 within system 100 of FIG. 1. FIG. 13 illustrates example embodiments of monitoring unit 1240. Additional embodiments may include an embodiment 1302, an embodiment 1304, an embodiment 1306, an embodiment 1308, an embodiment 1310, an embodiment 1312, and/or an embodiment 1314.

At embodiment 1302, monitoring unit 1240 may include one or more monitoring units that are configured to monitor temperature. A device 1200 may include one or more monitoring units 1240 that include one or more modules that are configured to measure temperature. Examples of modules that may be used to measure temperature include, but are not limited to, thermometers, resistivity meters, thermocouples, and the like.

At embodiment 1304, monitoring unit 1240 may include one or more monitoring units that are configured to monitor temperature history. A device 1200 may include one or more monitoring units 1240 that include one or more modules that are configured to monitor temperature history through use of memory. For example, a monitoring unit 1240 may include memory in which temperature data is saved and stored for analysis.

At embodiment 1306, monitoring unit 1240 may include one or more monitoring units that are configured to monitor time. A device 1200 may include one or more monitoring units 1240 that include one or more modules that are configured to monitor time. For example, a monitoring unit 1240 may include a clock or have a wireless connection that allows the monitoring unit to obtain time information. In some embodiments, a monitoring unit 1240 may include memory in which time data is saved and stored for analysis.

At embodiment 1308, monitoring unit 1240 may include one or more monitoring units that are configured to monitor location. A device 1200 may include one or more monitoring units 1240 that include a global positioning system that allows the monitoring unit 1240 to monitor location. In some embodiments, a monitoring unit 1240 may include a motion detector to allow the monitoring unit 1240 to monitor location.

At embodiment 1310, monitoring unit 1240 may include one or more monitoring units that are configured to monitor location history. A device 1200 may include one or more monitoring units 1240 that include a global positioning system that allows the monitoring unit 1240 to monitor location and memory which allows a monitoring unit 1240 to record location history information. In some embodiments, a monitoring unit 1240 may include a motion detector to allow the monitoring unit 1240 to monitor location and memory to record the location information.

At embodiment 1312, monitoring unit 1240 may include one or more monitoring units that are configured to monitor fluid level. A device 1200 may include one or more monitoring units 1240 that are configured to monitor fluid level through use of a mechanical device such as a float. In some embodiments, a monitoring unit 1240 may utilize optical methods to determine fluid levels. Accordingly, numerous methods may be used to determine fluid levels.

At embodiment 1314, monitoring unit 1240 may include one or more monitoring units that are configured to monitor fluid level history. A device 1200 may include one or more monitoring units 1240 that are configured to monitor fluid levels and to record the information into memory.

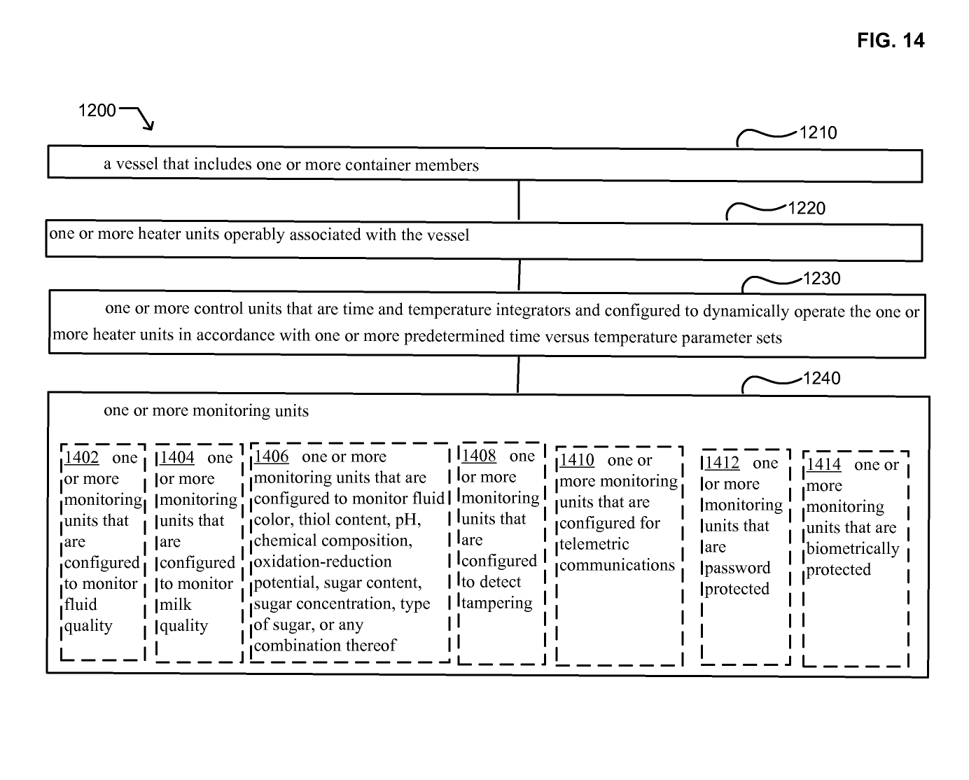

FIG. 14 illustrates alternative embodiments of monitoring unit 1240 of device 1200 within system 100 of FIG. 1. FIG. 14 illustrates example embodiments of monitoring unit 1240. Additional embodiments may include an embodiment 1402, an embodiment 1404, an embodiment 1406, an embodiment 1408, an embodiment 1410, an embodiment 1412, and/or an embodiment 1414.

At embodiment 1402, monitoring unit 1240 may include one or more monitoring units that are configured to monitor fluid quality. A device 1200 may include one or more monitoring units 1240 that are configured to monitor fluid quality through use of optical methods. For example, in some embodiments, optical methods may be used to assay fluid clarity as a measure of bacterial contamination. In some embodiments, chemical methods may be used to assay fluid quality as measured by the presence of contaminants in the fluid.

At embodiment 1404, monitoring unit 1240 may include one or more monitoring units that are configured to monitor milk quality. A device 1200 may include one or more monitoring units 1240 that are configured to monitor milk quality through use of optical methods. For example, in some embodiments, optical methods may be used to assay milk clarity as a measure of bacterial contamination. In some embodiments, chemical methods may be used to assay milk quality as measured by the presence of contaminants in the fluid.

At embodiment 1406, monitoring unit 1240 may include one or more monitoring units that are configured to monitor fluid color, thiol content, pH, chemical composition, oxidation-reduction potential, sugar content, sugar concentration, type of sugar, or any combination thereof. A device 1200 may include one or more monitoring units 1240 that are configured to monitor fluid color, thiol content, pH, chemical composition, oxidation-reduction potential, sugar content, sugar concentration, type of sugar, or any combination thereof.

At embodiment 1408, monitoring unit 1240 may include one or more monitoring units that are configured to detect tampering. A device 1200 may include one or more monitoring units 1240 that are configured to detect unauthorized access to a vessel. For example, in some embodiments, a monitoring unit 1240 may include an alarm that sounds if the interior of the vessel is accessed. In some embodiments, a monitoring unit 1240 may include an alarm that sounds if fluid is added to a vessel without authorization.

At embodiment 1410, monitoring unit 1240 may include one or more monitoring units that are configured for telemetric communications. A device 1200 may include one or more monitoring units 1240 that are configured to utilize cellular telephone based communications and other forms of wireless communication.

At embodiment 1412, monitoring unit 1240 may include one or more monitoring units that are password protected. A device 1200 may include one or more monitoring units 1240 that are password protected.

At embodiment 1414, monitoring unit 1240 may include one or more monitoring units that are biometrically protected. A device 1200 may include one or more monitoring units 1240 that are biometrically protected. For example, a monitoring unit 1240 may require an eye scan, a fingerprint, or facial recognition to allow access to data contained by the monitoring unit.

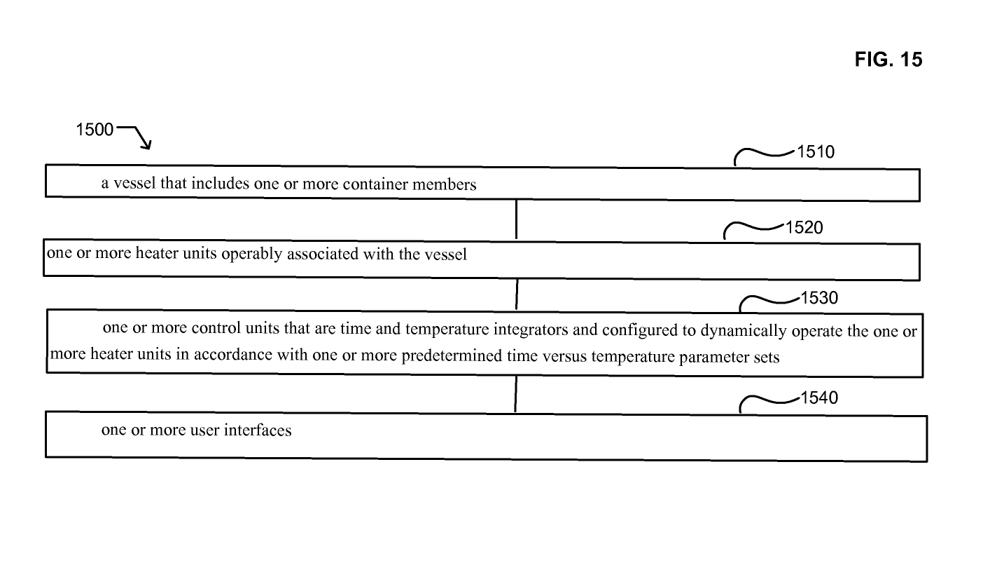

FIG. 15 illustrates an embodiment of device 1500 within system 100. In FIG. 15, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 1500 may include vessel 1510 that includes one or more container members. The embodiment 1500 may include heater unit 1520 that may operably associate with vessel 1510. The embodiment 1500 may include control unit 1530 that is a time and temperature integrator and configured to dynamically operate the one or more heater units in accordance with one or more predetermined time versus temperature parameter sets. The embodiment 1500 may include user interface 1540.

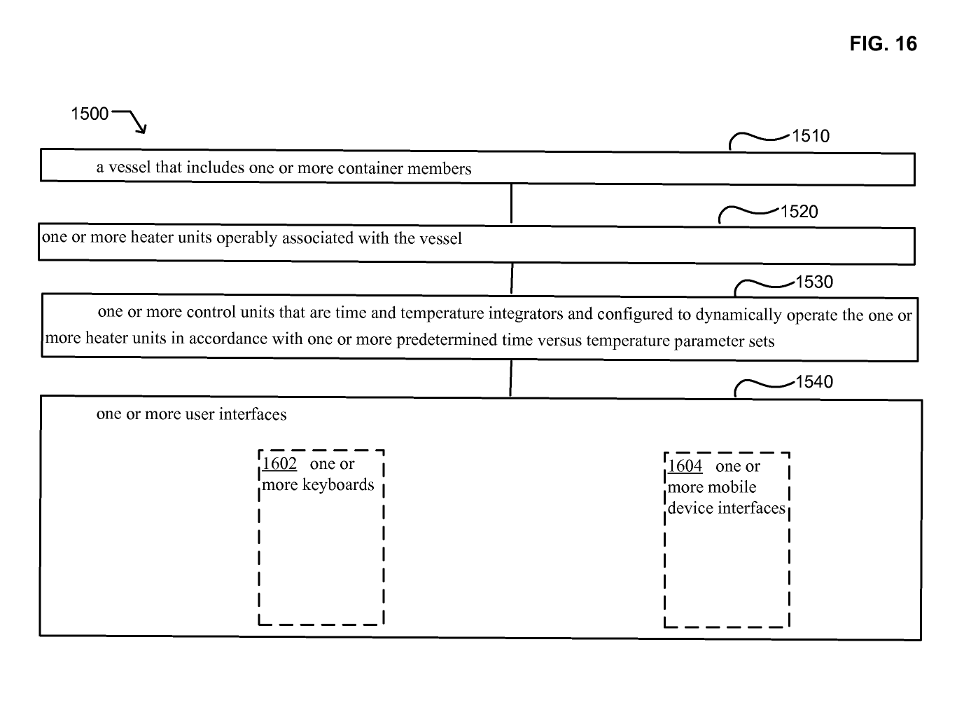

FIG. 16 illustrates alternative embodiments of a user interface of device 1540 within system 100 of FIG. 1. FIG. 16 illustrates example embodiments of user interface 1540. Additional embodiments may include an embodiment 1602 and/or an embodiment 1604.

At embodiment 1602, user interface 1540 may include one or more keyboards. A device 1500 may include one or more user interfaces 1540 that are keyboards.

At embodiment 1604, user interface 1540 may include one or more mobile device interfaces. A device 1500 may include one or more user interfaces 1540 that are mobile device interfaces.

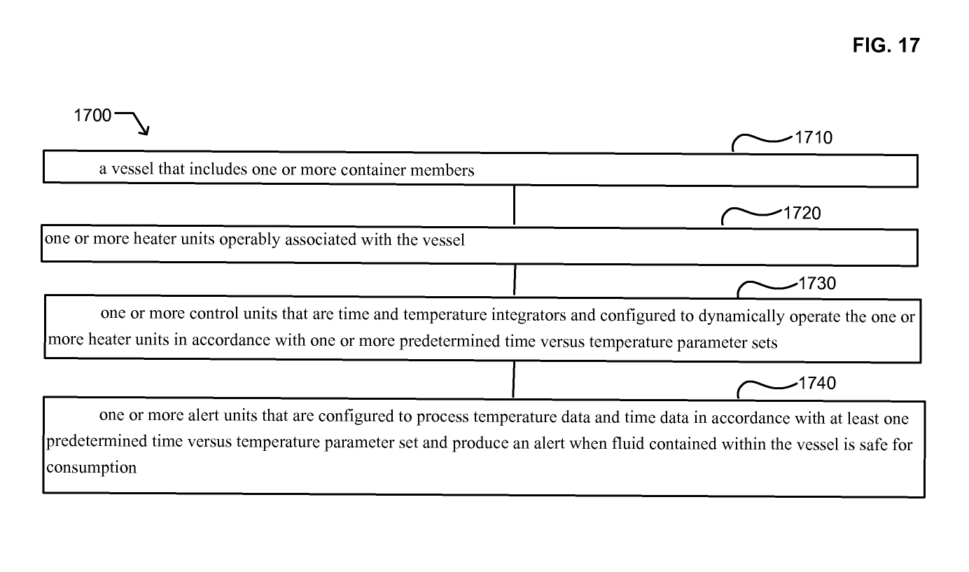

FIG. 17 illustrates an embodiment of device 1700 within system 100. In FIG. 17, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 1700 may include vessel 1710 that includes one or more container members. The embodiment 1700 may include heater unit 1720 that may operably associate with vessel 1710. The embodiment 1700 may include control unit 1730 that is a time and temperature integrator and configured to dynamically operate the one or more heater units in accordance with one or more predetermined time versus temperature parameter sets. The embodiment 1700 may include alert unit 1740.

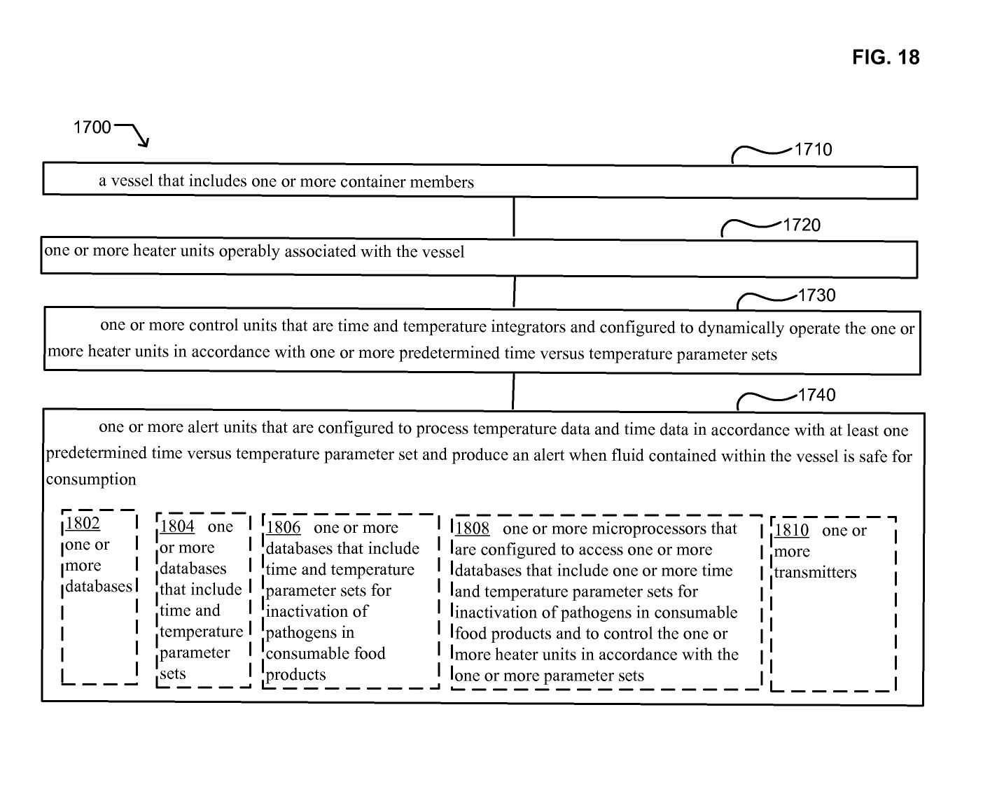

FIG. 18 illustrates alternative embodiments of alert unit 1740 of device 1700 within system 100 of FIG. 1. FIG. 18 illustrates example embodiments of alert unit 1740. Additional embodiments may include an embodiment 1802, an embodiment 1804, an embodiment 1806, an embodiment 1808, and/or an embodiment 1810.

At embodiment 1802, alert unit 1740 may include one or more databases. A device 1700 may include one or more alert units 1740 that include one or more databases. A device 1700 may include one or more alert units 1740 that include one or more databases that include location information. Accordingly, in some embodiments, an alert unit 1740 may produce an alert if a device is moved into an unauthorized area. In some embodiments, an alert unit 1740 may produce an alert if a device 1700 is not cleaned on an adequate basis.

At embodiment 1804, alert unit 1740 may include one or more databases that include time and temperature parameter sets. A device 1700 may include one or more alert units 1740 that include one or more databases that include time and temperature parameters that are related to a specific food product. For example, in some embodiments, a time and temperature parameter set may be specifically designed for milk pasteurization. In some embodiments, a time and temperature parameter set may be specifically designed for fruit juice pasteurization. Accordingly, in some embodiments, an alert unit 1740 may produce an alert if fluid contained in a vessel is adequately treated and is safe to consume. In some embodiments, an alert unit 1740 may produce an alert if fluid contained in a vessel is inadequately treated and is not safe to consume.

At embodiment 1806, alert unit 1740 may include one or more databases that include time and temperature parameter sets for inactivation of pathogens in consumable food products. A device 1700 may include one or more alert units 1740 that include one or more databases that include time and temperature parameters that are related to one or more pathogens in a food product. For example, in some embodiments, a time and temperature parameter set may be specifically designed to inactivate Escherichia coli. In some embodiments, time and temperature parameter sets may be designed to inactivate and/or kill a specific pathogen in a specific food product. For example, in some embodiments, a time and temperature parameter set may be specifically designed to kill specific pathogens that are found in milk. Accordingly, in some embodiments, an alert unit 1740 may produce an alert if fluid contained in a vessel is adequately treated and is safe to consume. In some embodiments, an alert unit 1740 may produce an alert if fluid contained in a vessel is inadequately treated and is not safe to consume.

At embodiment 1808, alert unit 1740 may include one or more microprocessors that are configured to access one or more databases that include one or more time and temperature parameter sets for inactivation of pathogens in consumable food products and to control the one or more heater units in accordance with the one or more parameter sets. A device 1700 may include one or more alert units 1740 that are configured to access one or more databases. Numerous technologies may be used to access one or more databases. For example, in some embodiments, a wireless device may be used to access a database.

At embodiment 1810, alert unit 1740 may include one or more transmitters. A device 1700 may include one or more alert units 1740 that include one or more transmitters. Numerous types of transmitters may be included in an alert unit. For example, in some embodiments, a transmitter may be configured to transmit an infrared signal, a digital signal, an analog signal, a wireless signal, a radiofrequency signal, and the like.

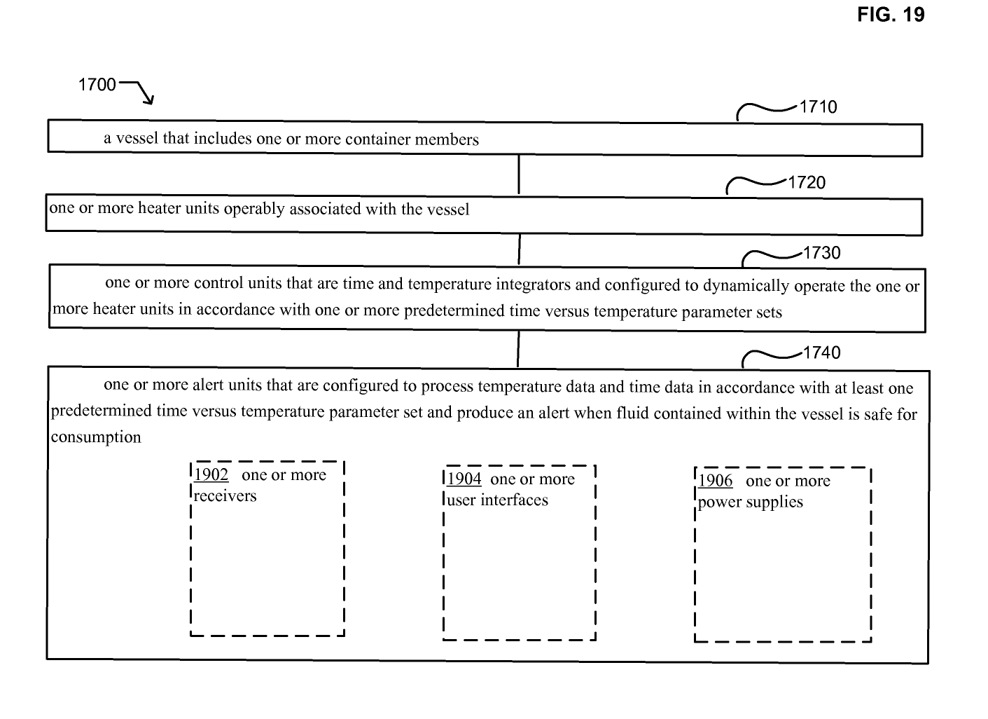

FIG. 19 illustrates alternative embodiments of embodiment 1740 of device 1700 within system 100 of FIG. 1. FIG. 18 illustrates example embodiments of alert unit 1740. Additional embodiments may include an embodiment 1902, an embodiment 1904, and/or an embodiment 1906.

At embodiment 1902, alert unit 1740 may include one or more receivers. A device 1700 may include one or more alert units 1740 that include one or more receivers. Numerous types of receivers may be included in an alert unit. For example, in some embodiments, a receiver may be configured to receive an infrared signal, a digital signal, an analog signal, a wireless signal, a radiofrequency signal, and the like.

At embodiment 1904, alert unit 1740 may include one or more user interfaces. A device 1700 may include one or more alert units 1740 that include one or more user interfaces. Numerous types of user interfaces may be include in an alert unit 1740. Examples of such user interfaces include, but are not limited to, touchpads, keypads, wireless devices, and the like.

At embodiment 1906, alert unit 1740 may include one or more power supplies. A device 1700 may include one or more alert units 1740 that include one or more power supplies. Examples of such power supplies include, but are not limited to, batteries, capacitors, line current, and the like.

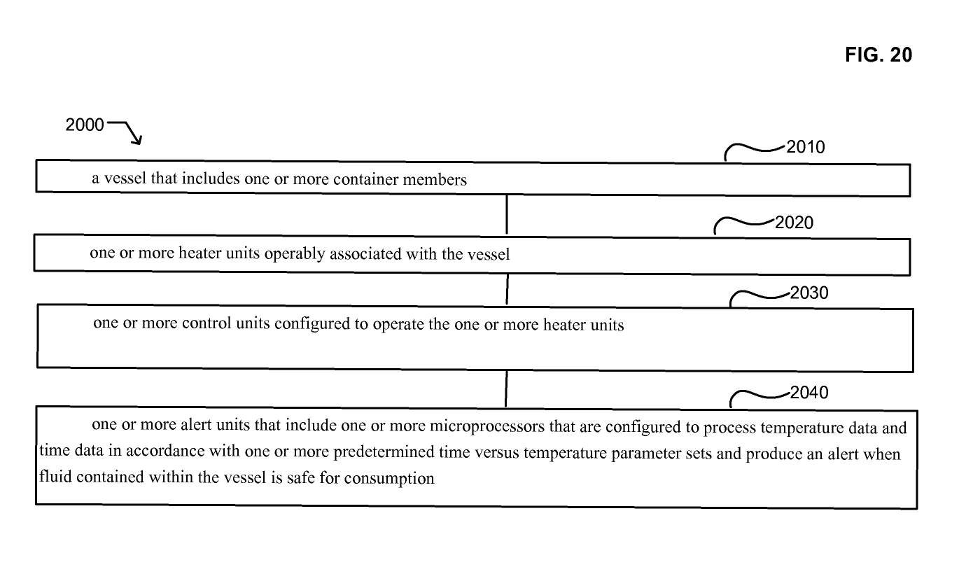

FIG. 20 illustrates an embodiment of device 2000 within system 100. In FIG. 20, discussion and explanation may be provided with respect to the above-described example of FIG. 1, and/or with respect to other examples and contexts. However, it should be understood that the modules may execute operations in a number of other environments and contexts, and/or modified versions of FIG. 1. Also, although the various modules are presented in the sequence(s) illustrated, it should be understood that the various modules may be configured in numerous orientations. The embodiment 2000 may include vessel 2010 that includes one or more container members. The embodiment 2000 may include heater unit 2020 that may operably associate with vessel 2010. The embodiment 2000 may include control unit 2030 that is configured to operate one or more heater units 2020. The embodiment 2000 may include alert unit 2040 that includes one or more microprocessors that are configured to process temperature data and time data in accordance with one or more predetermined time versus temperature parameter sets and produce an alert when fluid contained with the vessel is safe for consumption.

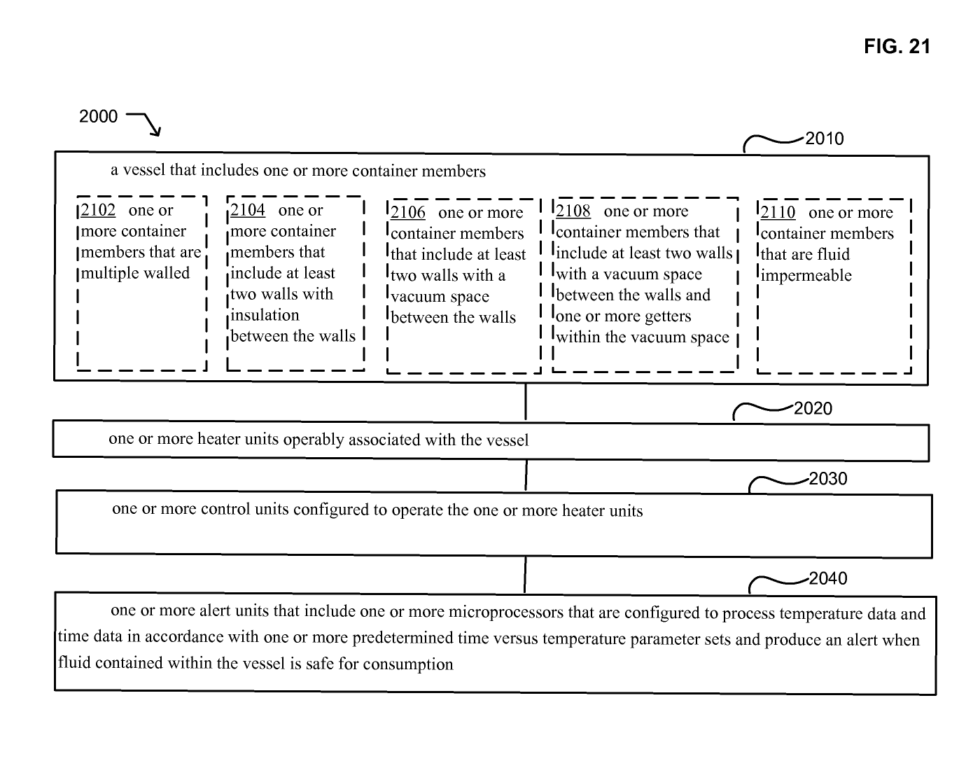

FIG. 21 illustrates alternative embodiments of a vessel 2010 of device 2000 within system 100 of FIG. 1. FIG. 21 illustrates example embodiments of vessel 2010. Additional embodiments may include an embodiment 2102, an embodiment 2104, an embodiment 2106, an embodiment 2108, and/or an embodiment 2110.

At embodiment 2102, vessel 2010 may include one or more container members that are multiple walled. In some embodiments, device 2000 may include a vessel 2010 having one or more container members that are multiple walled. For example, in some embodiments, a container member may be a series of nested vessels.

At embodiment 2104, vessel 2010 may include one or more container members that include at least two walls with insulation between the walls. In some embodiments, device 2000 may include a vessel 2010 having one or more container members that include at least two walls with insulation between the walls. For example, in some embodiments, a container member may be a series of nested vessels with insulation between the walls. Numerous types of insulation may be used within a vessel.

At embodiment 2106, vessel 2010 may include one or more container members that include at least two walls with a vacuum space between the walls. In some embodiments, device 2000 may include a vessel 2010 having one or more container members that include at least two walls with a vacuum space between the walls.

At embodiment 2108, vessel 2010 may include one or more container members that include at least two walls with a vacuum space between the walls and one or more getters within the vacuum space. In some embodiments, device 2000 may include a vessel 2010 having one or more container members having at least two walls with a vacuum space between the walls and one or more getters within the vacuum space.

At embodiment 2110, vessel 2010 may include one or more container members that are fluid impermeable. In some embodiments, device 2000 may include a vessel 2010 having one or more container members that are fluid impermeable.

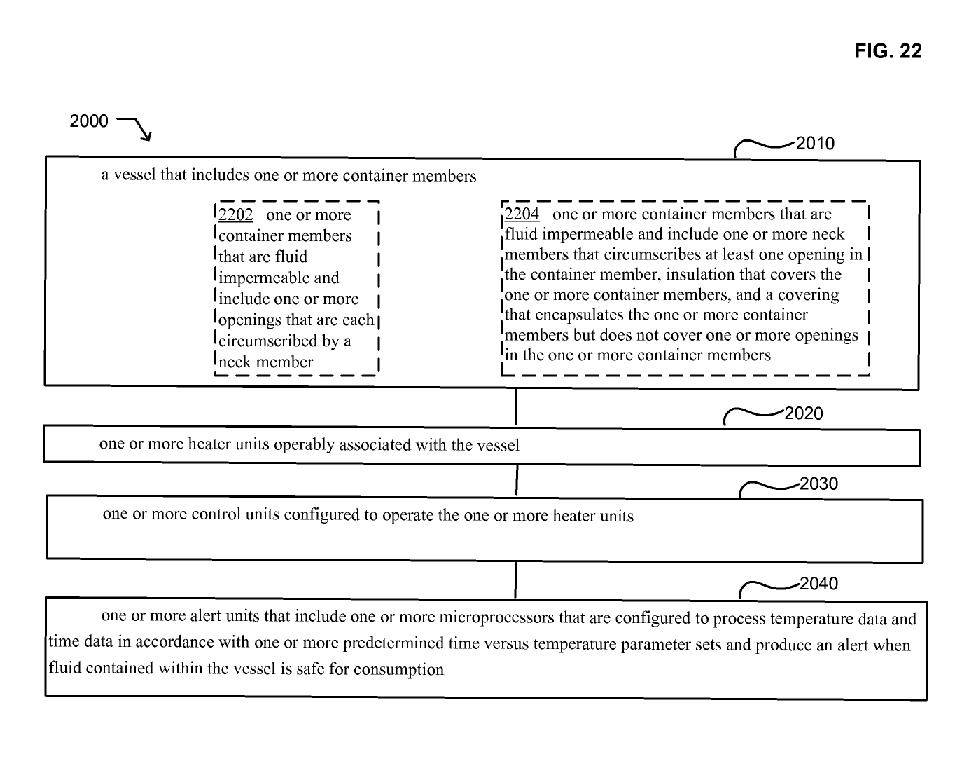

FIG. 22 illustrates alternative embodiments of embodiment 2010 of device 2000 within system 100 of FIG. 1. FIG. 22 illustrates example embodiments of vessel 2010. Additional embodiments may include an embodiment 2202 and/or an embodiment 2204.

At embodiment 2202, vessel 2010 may include one or more container members that are fluid impermeable and include one or more openings that are each circumscribed by a neck member. In some embodiments, device 2000 may include a vessel 2010 having one or more container members that include one or more openings that are each circumscribed by a neck member that is threaded. In some embodiments, a vessel 2010 may include one or more container members that include openings that are each circumscribed by a neck member that is coupled to covering that covers the vessel.

At embodiment 2204, vessel 2010 may include one or more container members that are fluid impermeable and include one or more neck members that circumscribes at least one opening in the container member, insulation that covers the one or more container members, and a covering that encapsulates the one or more container members but does not cover one or more openings in the one or more container members.

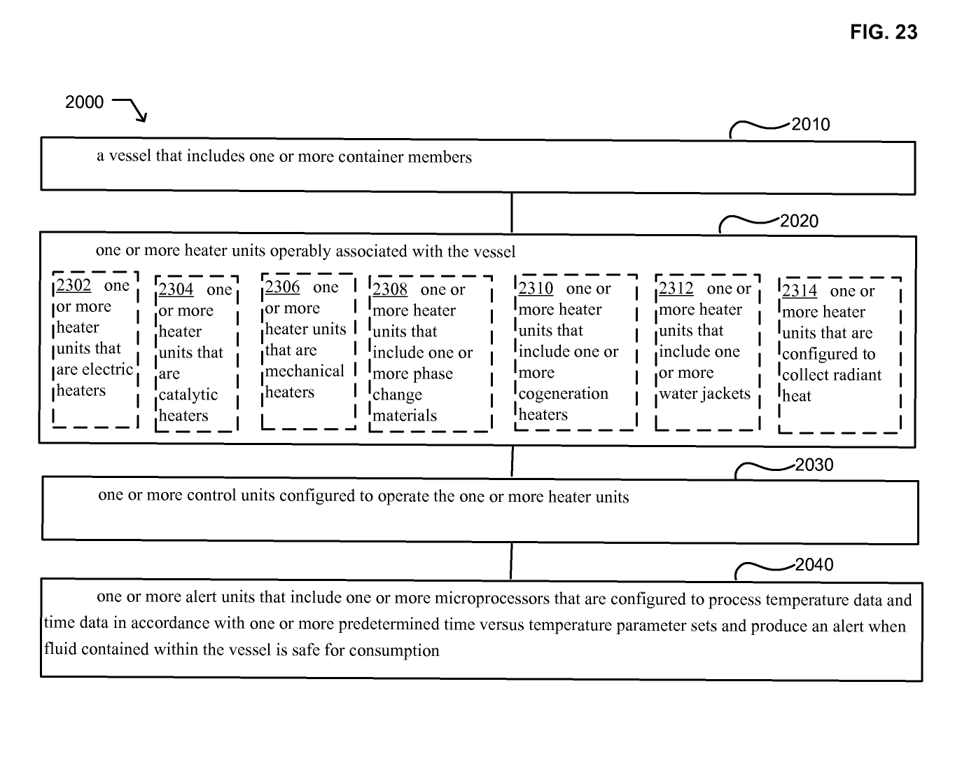

FIG. 23 illustrates alternative embodiments of heater unit 2020 of device 2000 within system 100 of FIG. 1. FIG. 23 illustrates example embodiments of heater unit 2020. Additional embodiments may include an embodiment 2302, an embodiment 2304, an embodiment 2306, an embodiment 2308, an embodiment 2310, an embodiment 2312, and/or an embodiment 2314.

At embodiment 2302, heater unit 2020 may include one or more heater units that are electric heaters. A device 2000 may include numerous types of electrical heaters that include, but are not limited to, emersion heaters, resistive heaters, and the like.

At embodiment 2304, heater unit 2020 may include one or more heater units that are catalytic heaters. A device 2000 may include numerous types of catalytic heaters that include, but are not limited to, heaters that combust a gas to produce heat.

At embodiment 2306, heater unit 2020 may include one or more heater units that are mechanical heaters. A device 2000 may include one or more mechanical heaters that may generate heat through friction between one or more moving members. Such mechanical heaters may be hand cranked. In some embodiments, such mechanical heaters may be coupled to another device such as a bicycle.

At embodiment 2308, heater unit 2020 may include one or more heater units that include one or more phase change materials. A device 2000 may include one or more phase change materials. Numerous types of phase change materials may be included within a heater unit (e.g., Farid et al., A review on phase change energy storage: materials and applications, Energy Conservation and Management (45), pgs. 1597-1615 (2004)).

At embodiment 2310, heater unit 2020 may include one or more heater units that include one or more cogeneration heaters. A device 2000 may include one or more cogeneration heaters. For example, in some embodiments, a cogeneration heater may utilize energy derived from the operation of a vehicle to produce heat.

At embodiment 2312, heater unit 2020 may include one or more heater units that include one or more water jackets. A device 2000 may include one or more heater units 2020 that include one or more water jackets. Hot water may be circulated through the heater unit to heat fluid contained within a vessel. In some embodiments, water may be heated through use of energy derived from secondary sources. For example, the heat output from a vehicle may be used to heat water.

At embodiment 2314, heater unit 2020 may include one or more heater units that are configured to collect radiant heat. A device 2000 may include one or more heater units 2020 that are configured to collect radiant heat. For example, in some embodiments, a heater unit may collect sun light to heat water.

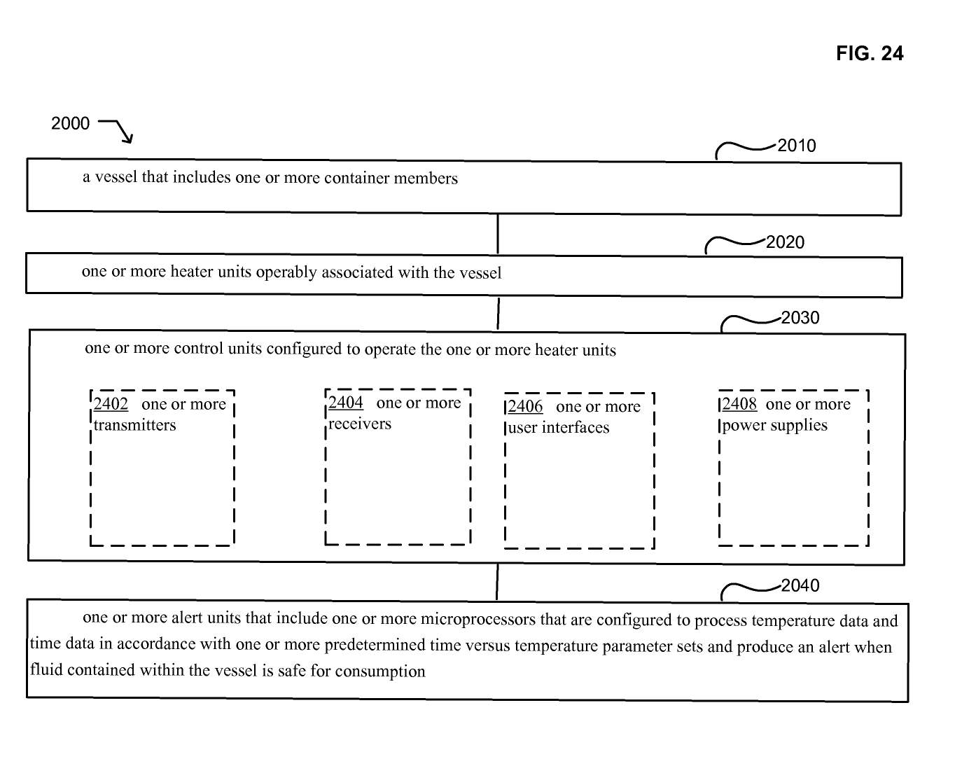

FIG. 24 illustrates alternative embodiments of control unit 2030 of device 2000 within system 100 of FIG. 1. FIG. 24 illustrates example embodiments of control unit 2030. Additional embodiments may include an embodiment 2402, an embodiment 2404, an embodiment 2406, and/or an embodiment 2408.

At embodiment 2402, control unit 2030 may include one or more transmitters. A device 2000 may include one or more control units 2030 that include one or more transmitters. Numerous types of transmitters may be included in a control unit 2030. For example, in some embodiments, a transmitter may be configured to transmit an infrared signal, a digital signal, an analog signal, a wireless signal, a radiofrequency signal, and the like.

At embodiment 2404, control unit 2030 may include one or more receivers. A device 2000 may include one or more control units 2030 that include one or more receivers. Numerous types of receivers may be included in a control unit 2030. For example, in some embodiments, a receiver may be configured to receive an infrared signal, a digital signal, an analog signal, a wireless signal, a radiofrequency signal, and the like.

At embodiment 2406, control unit 2030 may include one or more user interfaces. A device 2000 may include one or more control units 2030 that include one or more user interfaces. Numerous types of user interfaces may be included in a control unit 2030. Examples of such user interfaces include, but are not limited to, touchpads, keypads, wireless devices, and the like.

At embodiment 2408, control unit 2030 may include one or more power supplies. A device 2000 may include one or more control units 2030 that include one or more power supplies. Examples of such power supplies include, but are not limited to, batteries, capacitors, line current, and the like.

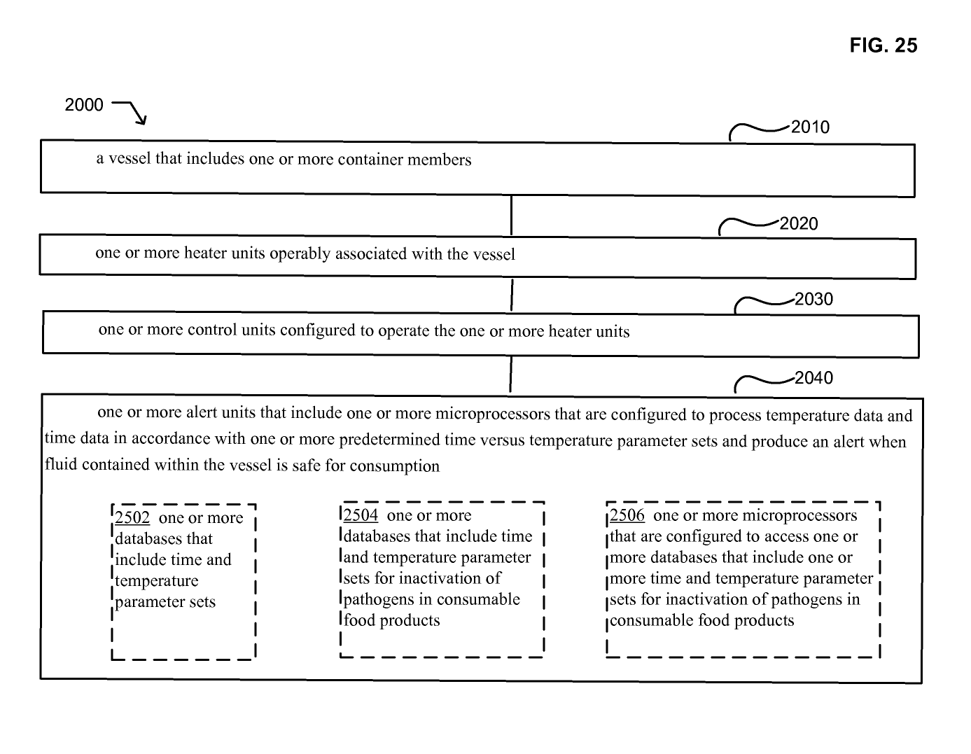

FIG. 25 illustrates alternative embodiments of alert unit 2040 of device 2000 within system 100 of FIG. 1. FIG. 25 illustrates example embodiments of alert unit 2040. Additional embodiments may include an embodiment 2502, an embodiment 2504, and/or an embodiment 2506.

At embodiment 2502, alert unit 2040 may include one or more databases that include time and temperature parameter sets. A device 2000 may include one or more alert units 2040 that include one or more databases that include time and temperature parameters that are related to a specific food product. For example, in some embodiments, a time and temperature parameter set may be specifically designed for milk pasteurization. In some embodiments, a time and temperature parameter set may be specifically designed for fruit juice pasteurization.

At embodiment 2504, alert unit 2040 may include one or more databases that include time and temperature parameter sets for inactivation of pathogens in consumable food products. A device 2000 may include one or more alert units 2040 that include one or more databases that include time and temperature parameters that are related to one or more pathogens in a food product. For example, in some embodiments, a time and temperature parameter set may be specifically designed to inactivate Escherichia coli. In some embodiments, time and temperature parameter sets may be designed to inactivate and/or kill a specific pathogen in a specific food product. For example, in some embodiments, a time and temperature parameter set may be specifically designed to kill specific pathogens that are found in milk.

At embodiment 2506, alert unit 2040 may include one or more microprocessors that are configured to access one or more databases that include one or more time and temperature parameter sets for inactivation of pathogens in consumable food products. A device 2000 may include one or more alert units 2040 that are configured to access one or more databases. Numerous technologies may be used to access one or more databases. For example, in some embodiments, a wireless device may be used to access a database.

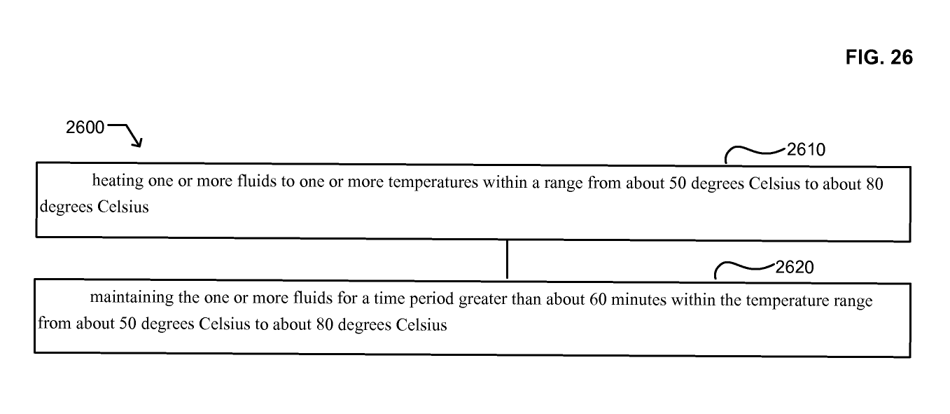

FIG. 26 illustrates operational flow 2600 that includes heating operation 2610 and maintaining operation 2620. In FIG. 26 and in following figures that include various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

After a start operation, the operational flow 2600 includes a heating operation 2610 involving heating one or more fluids to one or more temperatures within a range from about 50 degrees Celsius to about 80 degrees Celsius. In some embodiments, one or more heater units 168 may be used to heat one or more fluids. In some embodiments, one or more control units 188 may be used to control one or more heater units 168 to heat one or more fluids. In some embodiments, one or more control units 188 control one or more heater units 168 to heat one or more fluids to a temperature according to a predetermined time versus temperature relationship that is specific for a specific food product. For example, in some embodiments, a control unit 188 may control a heater unit 168 according to a time versus temperature relationship that is specific for sanitizing milk. I some embodiments, a control unit 188 may control a heater unit 168 according to a time versus temperature relationship that is specific for sanitizing fruit juice.

After a start operation, the operational flow 2600 includes a maintaining operation 2620 involving maintaining the one or more fluids for a time period greater than about 60 minutes within the temperature range from about 50 degrees Celsius to about 80 degrees Celsius. In some embodiments, one or more heater units 168 may be used to maintain one or more fluids within a temperature range. In some embodiments, one or more control units 188 may be used to control one or more heater units 168 to maintain one or more fluids within a temperature range. In some embodiments, one or more control units 188 can control one or more heater units 168 to maintain one or more fluids at one or more temperatures at which grow of pathogens contained within a fluid is inhibited. In some embodiments, one or more control units 188 can control one or more heater units 168 to maintain one or more fluids at one or more temperatures at which pathogens contained within a fluid are inactivated.

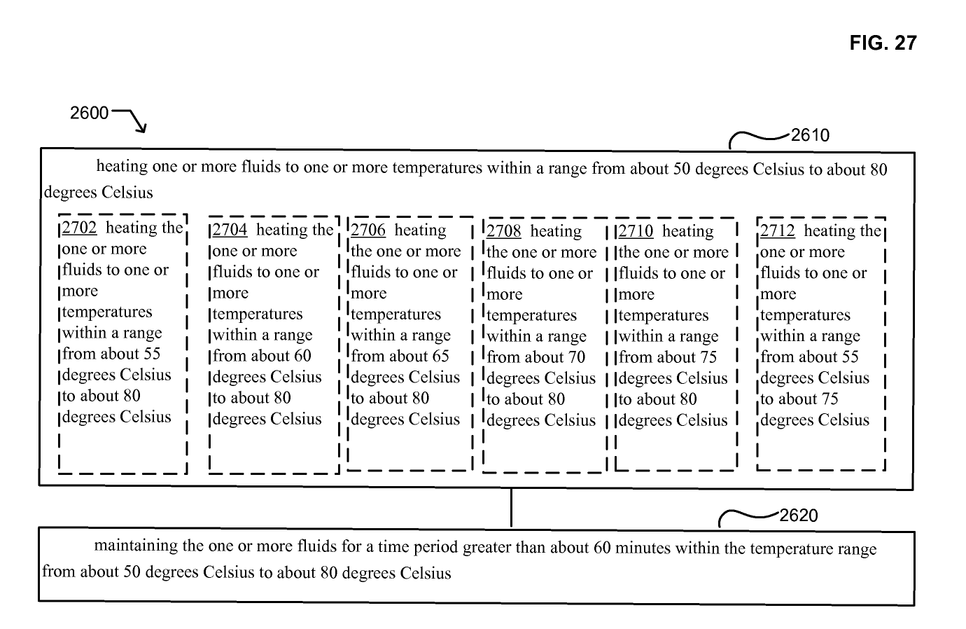

FIG. 27 illustrates alternative embodiments of the example operational flow 2600 of FIG. 26. FIG. 27 illustrates example embodiments where the heating operation 2610 may include at least one additional operation. Additional operations may include an operation 2702, an operation 2704, an operation 2706, an operation 2708, an operation 2710, and/or operation 2712.

At operation 2702, the heating operation 2610 may include heating the one or more fluids to one or more temperatures within a range from about 55 degrees Celsius to about 80 degrees Celsius. In some embodiments, one or more heater units 168 may heat one or more fluids to one or more temperatures within a range from about 55 degrees Celsius to about 80 degrees Celsius. In some embodiments, one or more control units 188 may control one or more heater units 168 to heat one or more fluids to one or more temperatures within a range from about 55 degrees Celsius to about 80 degrees Celsius.

At operation 2704, the heating operation 2610 may include heating the one or more fluids to one or more temperatures within a range from about 60 degrees Celsius to about 80 degrees Celsius. In some embodiments, one or more heater units 168 may heat one or more fluids to one or more temperatures within a range from about 60 degrees Celsius to about 80 degrees Celsius. In some embodiments, one or more control units 188 may control one or more heater units 168 to heat one or more fluids to one or more temperatures within a range from about 60 degrees Celsius to about 80 degrees Celsius.

At operation 2706, the heating operation 2610 may include heating the one or more fluids to one or more temperatures within a range from about 65 degrees Celsius to about 80 degrees Celsius. In some embodiments, one or more heater units 168 may heat one or more fluids to one or more temperatures within a range from about 65 degrees Celsius to about 80 degrees Celsius. In some embodiments, one or more control units 188 may control one or more heater units 168 to heat one or more fluids to one or more temperatures within a range from about 65 degrees Celsius to about 80 degrees Celsius.

At operation 2708, the heating operation 2610 may include heating the one or more fluids to one or more temperatures within a range from about 70 degrees Celsius to about 80 degrees Celsius. In some embodiments, one or more heater units 168 may heat one or more fluids to one or more temperatures within a range from about 70 degrees Celsius to about 80 degrees Celsius. In some embodiments, one or more control units 188 may control one or more heater units 168 to heat one or more fluids to one or more temperatures within a range from about 70 degrees Celsius to about 80 degrees Celsius.

At operation 2710, the heating operation 2610 may include heating the one or more fluids to one or more temperatures within a range from about 75 degrees Celsius to about 80 degrees Celsius. In some embodiments, one or more heater units 168 may heat one or more fluids to one or more temperatures within a range from about 75 degrees Celsius to about 80 degrees Celsius. In some embodiments, one or more control units 188 may control one or more heater units 168 to heat one or more fluids to one or more temperatures within a range from about 75 degrees Celsius to about 80 degrees Celsius.

At operation 2712, the heating operation 2610 may include heating the one or more fluids to one or more temperatures within a range from about 55 degrees Celsius to about 75 degrees Celsius. In some embodiments, one or more heater units 168 may heat one or more fluids to one or more temperatures within a range from about 55 degrees Celsius to about 75 degrees Celsius. In some embodiments, one or more control units 188 may control one or more heater units 168 to heat one or more fluids to one or more temperatures within a range from about 55 degrees Celsius to about 75 degrees Celsius.

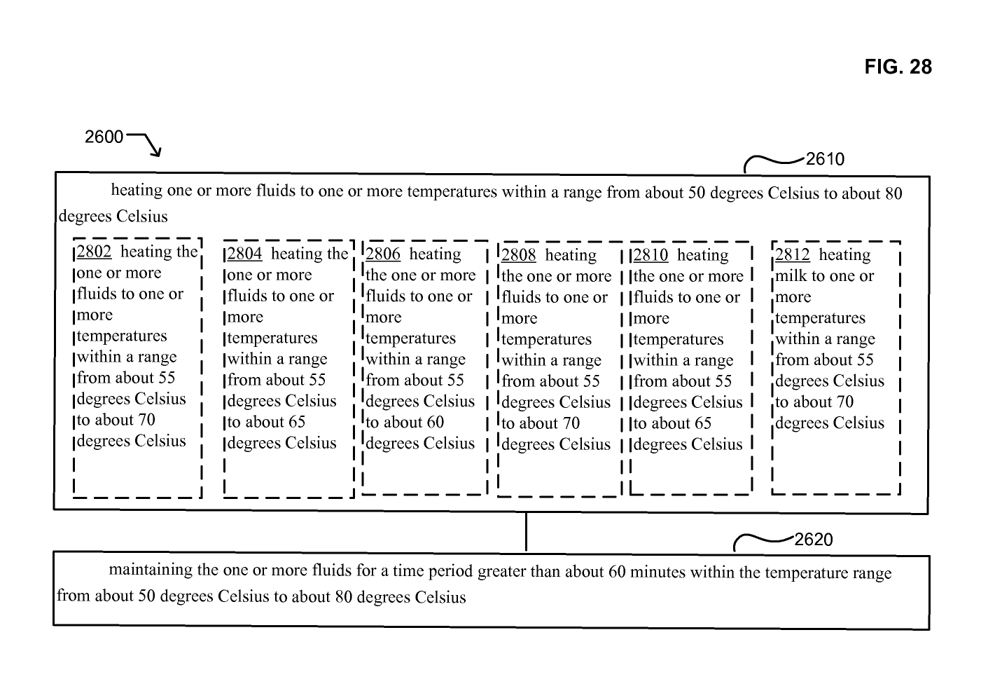

FIG. 28 illustrates alternative embodiments of the example operational flow 2600 of FIG. 26. FIG. 28 illustrates example embodiments where the heating operation 2610 may include at least one additional operation. Additional operations may include an operation 2802, an operation 2804, an operation 2806, an operation 2808, an operation 2810, and/or operation 2812.

At operation 2802, the heating operation 2610 may include heating the one or more fluids to one or more temperatures within a range from about 55 degrees Celsius to about 70 degrees Celsius. In some embodiments, one or more heater units 168 may heat one or more fluids to one or more temperatures within a range from about 55 degrees Celsius to about 70 degrees Celsius. In some embodiments, one or more control units 188 may control one or more heater units 168 to heat one or more fluids to one or more temperatures within a range from about 55 degrees Celsius to about 70 degrees Celsius.

At operation 2804, the heating operation 2610 may include heating the one or more fluids to one or more temperatures within a range from about 55 degrees Celsius to about 65 degrees Celsius. In some embodiments, one or more heater units 168 may heat one or more fluids to one or more temperatures within a range from about 55 degrees Celsius to about 65 degrees Celsius. In some embodiments, one or more control units 188 may control one or more heater units 168 to heat one or more fluids to one or more temperatures within a range from about 55 degrees Celsius to about 65 degrees Celsius.

At operation 2806, the heating operation 2610 may include heating the one or more fluids to one or more temperatures within a range from about 55 degrees Celsius to about 60 degrees Celsius. In some embodiments, one or more heater units 168 may heat one or more fluids to one or more temperatures within a range from about 55 degrees Celsius to about 60 degrees Celsius. In some embodiments, one or more control units 188 may control one or more heater units 168 to heat one or more fluids to one or more temperatures within a range from about 55 degrees Celsius to about 60 degrees Celsius.

At operation 2808, the heating operation 2610 may include heating the one or more fluids to one or more temperatures within a range from about 55 degrees Celsius to about 70 degrees Celsius. In some embodiments, one or more heater units 168 may heat one or more fluids to one or more temperatures within a range from about 55 degrees Celsius to about 70 degrees Celsius. In some embodiments, one or more control units 188 may control one or more heater units 168 to heat one or more fluids to one or more temperatures within a range from about 55 degrees Celsius to about 70 degrees Celsius.

At operation 2810, the heating operation 2610 may include heating the one or more fluids to one or more temperatures within a range from about 55 degrees Celsius to about 65 degrees Celsius. In some embodiments, one or more heater units 168 may heat one or more fluids to one or more temperatures within a range from about 55 degrees Celsius to about 65 degrees Celsius. In some embodiments, one or more control units 188 may control one or more heater units 168 to heat one or more fluids to one or more temperatures within a range from about 55 degrees Celsius to about 65 degrees Celsius.

At operation 2812, the heating operation 2610 may include heating milk to one or more temperatures within a range from about 55 degrees Celsius to about 70 degrees Celsius. In some embodiments, one or more heater units 168 may heat milk to one or more temperatures within a range from about 55 degrees Celsius to about 70 degrees Celsius. In some embodiments, one or more control units 188 may control one or more heater units 168 to heat milk to one or more temperatures within a range from about 55 degrees Celsius to about 70 degrees Celsius.

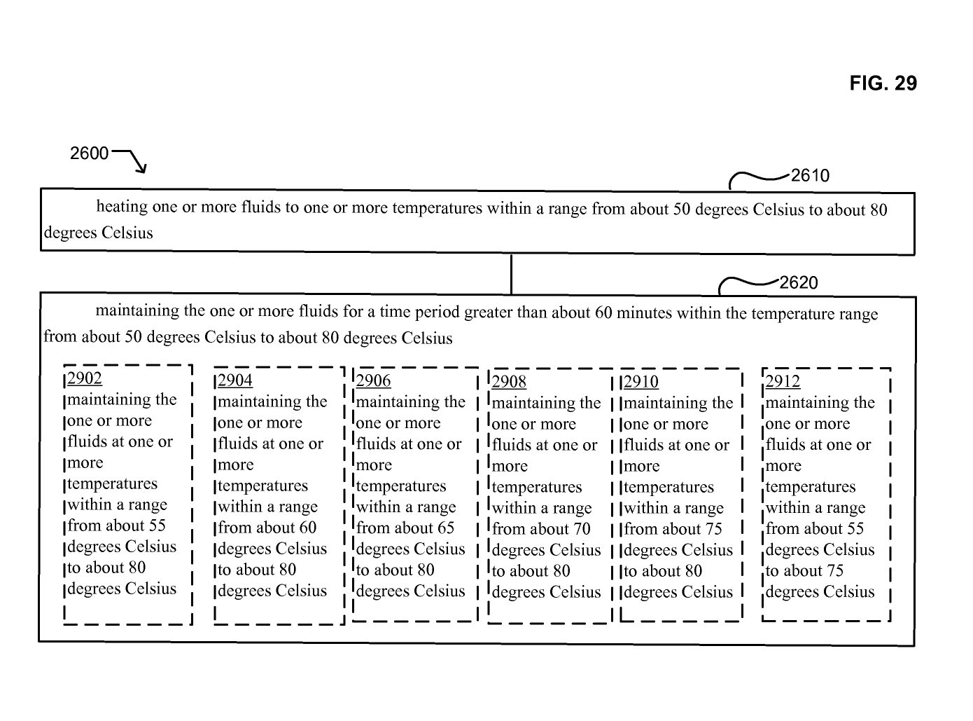

FIG. 29 illustrates alternative embodiments of the example operational flow 2600 of FIG. 26. FIG. 29 illustrates example embodiments where the maintaining operation 2620 may include at least one additional operation. Additional operations may include an operation 2902, an operation 2904, an operation 2906, an operation 2908, an operation 2910, and/or operation 2912.

At operation 2902, the maintaining operation 2620 may include maintaining the one or more fluids at one or more temperatures within a range from about 55 degrees Celsius to about 80 degrees Celsius. In some embodiments, one or more heater units 168 may maintain one or more fluids at one or more temperatures within a range from about 55 degrees Celsius to about 80 degrees Celsius. In some embodiments, one or more control units 188 may control one or more heater units 168 to maintain one or more fluids at one or more temperatures within a range from about 55 degrees Celsius to about 80 degrees Celsius.

At operation 2904, the maintaining operation 2620 may include maintaining the one or more fluids at one or more temperatures within a range from about 60 degrees Celsius to about 80 degrees Celsius. In some embodiments, one or more heater units 168 may maintain one or more fluids at one or more temperatures within a range from about 60 degrees Celsius to about 80 degrees Celsius. In some embodiments, one or more control units 188 may control one or more heater units 168 to maintain one or more fluids at one or more temperatures within a range from about 60 degrees Celsius to about 80 degrees Celsius.

At operation 2906, the maintaining operation 2620 may include maintaining the one or more fluids at one or more temperatures within a range from about 65 degrees Celsius to about 80 degrees Celsius. In some embodiments, one or more heater units 168 may maintain one or more fluids at one or more temperatures within a range from about 65 degrees Celsius to about 80 degrees Celsius. In some embodiments, one or more control units 188 may control one or more heater units 168 to maintain one or more fluids at one or more temperatures within a range from about 65 degrees Celsius to about 80 degrees Celsius.

At operation 2908, the maintaining operation 2620 may include maintaining the one or more fluids at one or more temperatures within a range from about 70 degrees Celsius to about 80 degrees Celsius. In some embodiments, one or more heater units 168 may maintain one or more fluids at one or more temperatures within a range from about 70 degrees Celsius to about 80 degrees Celsius. In some embodiments, one or more control units 188 may control one or more heater units 168 to maintain one or more fluids at one or more temperatures within a range from about 70 degrees Celsius to about 80 degrees Celsius.

At operation 2910, the maintaining operation 2620 may include maintaining the one or more fluids at one or more temperatures within a range from about 75 degrees Celsius to about 80 degrees Celsius. In some embodiments, one or more heater units 168 may maintain one or more fluids at one or more temperatures within a range from about 75 degrees Celsius to about 80 degrees Celsius. In some embodiments, one or more control units 188 may control one or more heater units 168 to maintain one or more fluids at one or more temperatures within a range from about 75 degrees Celsius to about 80 degrees Celsius.

At operation 2912, the maintaining operation 2620 may include maintaining the one or more fluids at one or more temperatures within a range from about 55 degrees Celsius to about 75 degrees Celsius. In some embodiments, one or more heater units 168 may maintain one or more fluids at one or more temperatures within a range from about 55 degrees Celsius to about 75 degrees Celsius. In some embodiments, one or more control units 188 may control one or more heater units 168 to maintain one or more fluids at one or more temperatures within a range from about 55 degrees Celsius to about 75 degrees Celsius.

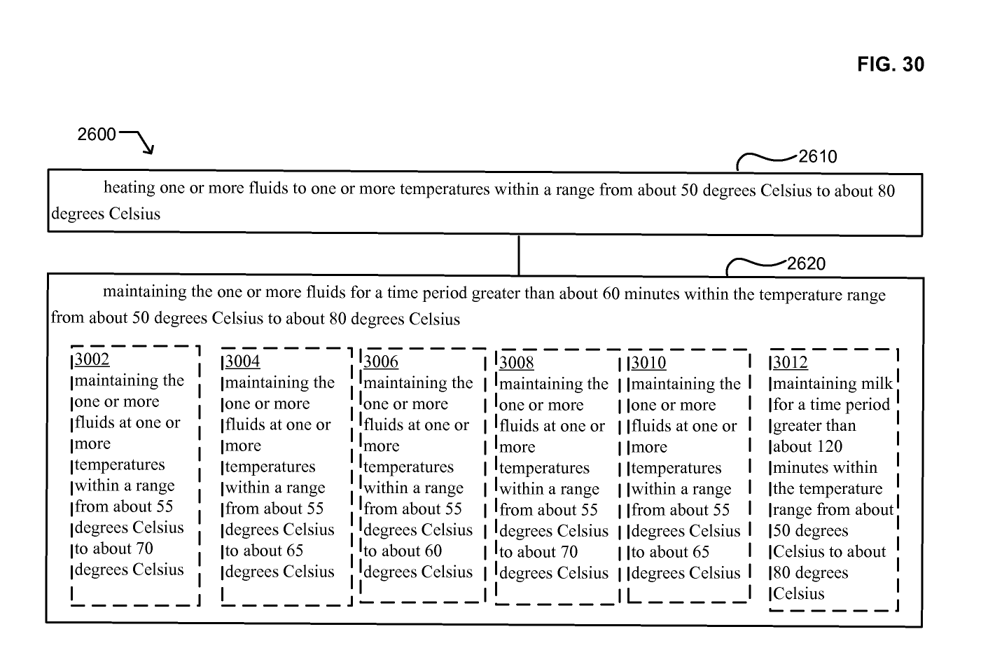

FIG. 30 illustrates alternative embodiments of the example operational flow 2600 of FIG. 26. FIG. 30 illustrates example embodiments where the maintaining operation 2620 may include at least one additional operation. Additional operations may include an operation 3002, an operation 3004, an operation 3006, an operation 3008, an operation 3010, and/or operation 3012.

At operation 3002, the maintaining operation 2620 may include maintaining the one or more fluids at one or more temperatures within a range from about 55 degrees Celsius to about 70 degrees Celsius. In some embodiments, one or more heater units 168 may maintain one or more fluids at one or more temperatures within a range from about 55 degrees Celsius to about 70 degrees Celsius. In some embodiments, one or more control units 188 may control one or more heater units 168 to maintain one or more fluids at one or more temperatures within a range from about 55 degrees Celsius to about 70 degrees Celsius.

At operation 3004, the maintaining operation 2620 may include maintaining the one or more fluids at one or more temperatures within a range from about 55 degrees Celsius to about 65 degrees Celsius. In some embodiments, one or more heater units 168 may maintain one or more fluids at one or more temperatures within a range from about 55 degrees Celsius to about 65 degrees Celsius. In some embodiments, one or more control units 188 may control one or more heater units 168 to maintain one or more fluids at one or more temperatures within a range from about 55 degrees Celsius to about 65 degrees Celsius.

At operation 3006, the maintaining operation 2620 may include maintaining the one or more fluids at one or more temperatures within a range from about 55 degrees Celsius to about 60 degrees Celsius. In some embodiments, one or more heater units 168 may maintain one or more fluids at one or more temperatures within a range from about 55 degrees Celsius to about 60 degrees Celsius. In some embodiments, one or more control units 188 may control one or more heater units 168 to maintain one or more fluids at one or more temperatures within a range from about 55 degrees Celsius to about 60 degrees Celsius.

At operation 3008, the maintaining operation 2620 may include maintaining the one or more fluids at one or more temperatures within a range from about 55 degrees Celsius to about 70 degrees Celsius. In some embodiments, one or more heater units 168 may maintain one or more fluids at one or more temperatures within a range from about 55 degrees Celsius to about 70 degrees Celsius. In some embodiments, one or more control units 188 may control one or more heater units 168 to maintain one or more fluids at one or more temperatures within a range from about 55 degrees Celsius to about 70 degrees Celsius.

At operation 3010, the maintaining operation 2620 may include maintaining the one or more fluids at one or more temperatures within a range from about 55 degrees Celsius to about 65 degrees Celsius. In some embodiments, one or more heater units 168 may maintain one or more fluids at one or more temperatures within a range from about 55 degrees Celsius to about 65 degrees Celsius. In some embodiments, one or more control units 188 may control one or more heater units 168 to maintain one or more fluids at one or more temperatures within a range from about 55 degrees Celsius to about 65 degrees Celsius.

At operation 3012, the maintaining operation 2620 may include maintaining milk for a time period greater than about 120 minutes within the temperature range from about 50 degrees Celsius to about 80 degrees Celsius. In some embodiments, one or more heater units 168 may maintain milk for a time period greater than about 120 minutes within the temperatures from about 50 degrees Celsius to about 80 degrees Celsius. In some embodiments, one or more control units 188 may control one or more heater units 168 to maintain milk at one or more temperatures within a range from about 50 degrees Celsius to about 80 degrees Celsius.

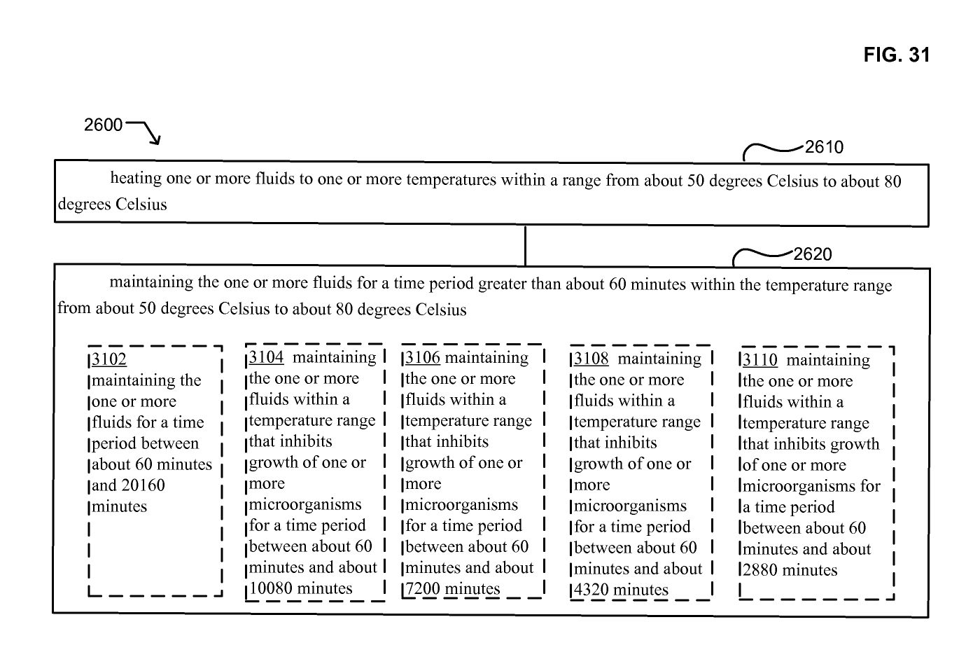

FIG. 31 illustrates alternative embodiments of the example operational flow 2600 of FIG. 26. FIG. 31 illustrates example embodiments where the maintaining operation 2620 may include at least one additional operation. Additional operations may include an operation 3102, an operation 3104, an operation 3106, an operation 3108, and/or operation 3110.

At operation 3102, the maintaining operation 2620 may include maintaining the one or more fluids for a time period between about 60 minutes and 20160 minutes. In some embodiments, one or more heater units 168 may maintain one or more fluids for a time period between about 60 minutes and about 20160 minutes. In some embodiments, one or more control units 188 may control one or more heater units 168 to maintain one or more fluids for a time period between about 60 minutes and about 20160 minutes.

At operation 3104, the maintaining operation 2620 may include maintaining the one or more fluids within a temperature range that inhibits growth of one or more microorganisms for a time period between about 60 minutes and about 10080 minutes. In some embodiments, one or more heater units 168 may maintain one or more fluids within a temperature range that inhibits growth of the one or more microorganisms for a time period between about 60 minutes and about 10080 minutes. In some embodiments, one or more control units 188 may control one or more heater units 168 to maintain one or more fluids for a time period between about 60 minutes and about 10080 minutes.

At operation 3106, the maintaining operation 2620 may include maintaining the one or more fluids within a temperature range that inhibits growth of one or more microorganisms for a time period between about 60 minutes and about 7200 minutes. In some embodiments, one or more heater units 168 may maintain one or more fluids within a temperature range that inhibits growth of the one or more microorganisms for a time period between about 60 minutes and about 7200 minutes. In some embodiments, one or more control units 188 may control one or more heater units 168 to maintain one or more fluids for a time period between about 60 minutes and about 7200 minutes.

At operation 3108, the maintaining operation 2620 may include maintaining the one or more fluids within a temperature range that inhibits growth of one or more microorganisms for a time period between about 60 minutes and about 4320 minutes. In some embodiments, one or more heater units 168 may maintain one or more fluids within a temperature range that inhibits growth of the one or more microorganisms for a time period between about 60 minutes and about 4320 minutes. In some embodiments, one or more control units 188 may control one or more heater units 168 to maintain one or more fluids for a time period between about 60 minutes and about 4320 minutes.

At operation 3110, the maintaining operation 2620 may include maintaining the one or more fluids within a temperature range that inhibits growth of one or more microorganisms for a time period between about 60 minutes and about 2880 minutes. In some embodiments, one or more heater units 168 may maintain one or more fluids within a temperature range that inhibits growth of the one or more microorganisms for a time period between about 60 minutes and about 2880 minutes. In some embodiments, one or more control units 188 may control one or more heater units 168 to maintain one or more fluids for a time period between about 60 minutes and about 2880 minutes.

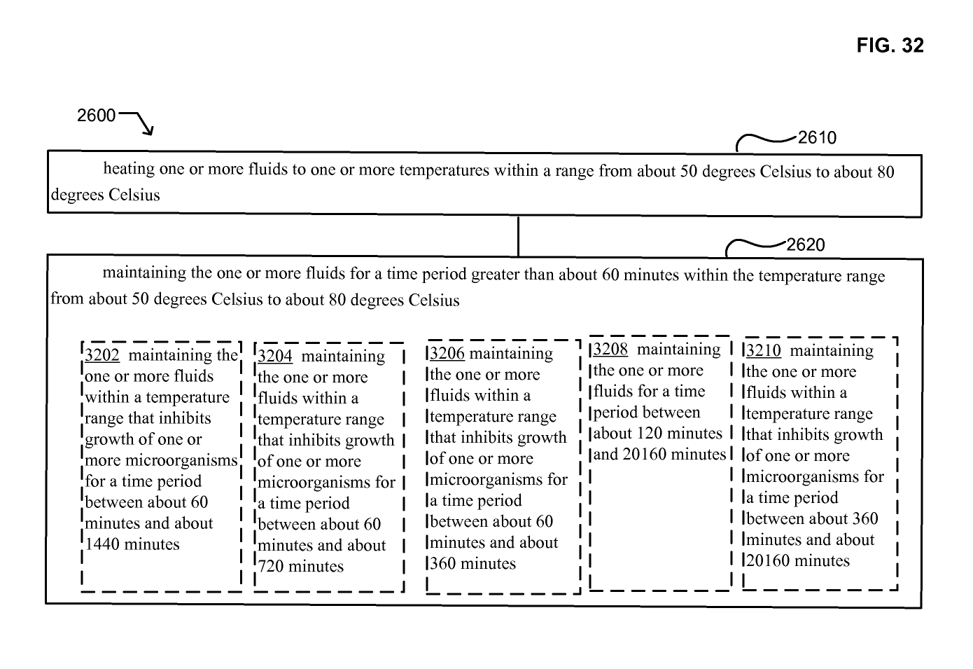

FIG. 32 illustrates alternative embodiments of the example operational flow 2600 of FIG. 26. FIG. 32 illustrates example embodiments where the maintaining operation 2620 may include at least one additional operation. Additional operations may include an operation 3202, an operation 3204, an operation 3206, an operation 3208, and/or operation 3210.

At operation 3202, the maintaining operation 2620 may include maintaining the one or more fluids within a temperature range that inhibits growth of one or more microorganisms for a time period between about 60 minutes and about 1440 minutes. In some embodiments, one or more heater units 168 may maintain one or more fluids within a temperature range that inhibits growth of the one or more microorganisms for a time period between about 60 minutes and about 1440 minutes. In some embodiments, one or more control units 188 may control one or more heater units 168 to maintain one or more fluids for a time period between about 60 minutes and about 1440 minutes.

At operation 3204, the maintaining operation 2620 may include maintaining the one or more fluids within a temperature range that inhibits growth of one or more microorganisms for a time period between about 60 minutes and about 720 minutes. In some embodiments, one or more heater units 168 may maintain one or more fluids within a temperature range that inhibits growth of the one or more microorganisms for a time period between about 60 minutes and about 720 minutes. In some embodiments, one or more control units 188 may control one or more heater units 168 to maintain one or more fluids for a time period between about 60 minutes and about 720 minutes.

At operation 3206, the maintaining operation 2620 may include maintaining the one or more fluids within a temperature range that inhibits growth of one or more microorganisms for a time period between about 60 minutes and about 360 minutes. In some embodiments, one or more heater units 168 may maintain one or more fluids within a temperature range that inhibits growth of the one or more microorganisms for a time period between about 60 minutes and about 360 minutes. In some embodiments, one or more control units 188 may control one or more heater units 168 to maintain one or more fluids for a time period between about 60 minutes and about 360 minutes.

At operation 3208, the maintaining operation 2620 may include maintaining the one or more fluids for a time period between about 120 minutes and 20160 minutes. In some embodiments, one or more heater units 168 may maintain one or more fluids within a temperature range from about 50 degrees Celsius to about 80 degrees Celsius for a time period between about 120 minutes and about 20160 minutes. In some embodiments, one or more control units 188 may control one or more heater units 168 to maintain one or more fluids for a time period between about 120 minutes and about 20160 minutes.

At operation 3210, the maintaining operation 2620 may include maintaining the one or more fluids within a temperature range that inhibits growth of one or more microorganisms for a time period between about 360 minutes and about 20160 minutes. In some embodiments, one or more heater units 168 may maintain one or more fluids within a temperature range from about 50 degrees Celsius to about 80 degrees Celsius for a time period between about 360 minutes and about 20160 minutes. In some embodiments, one or more control units 188 may control one or more heater units 168 to maintain one or more fluids for a time period between about 360 minutes and about 20160 minutes.

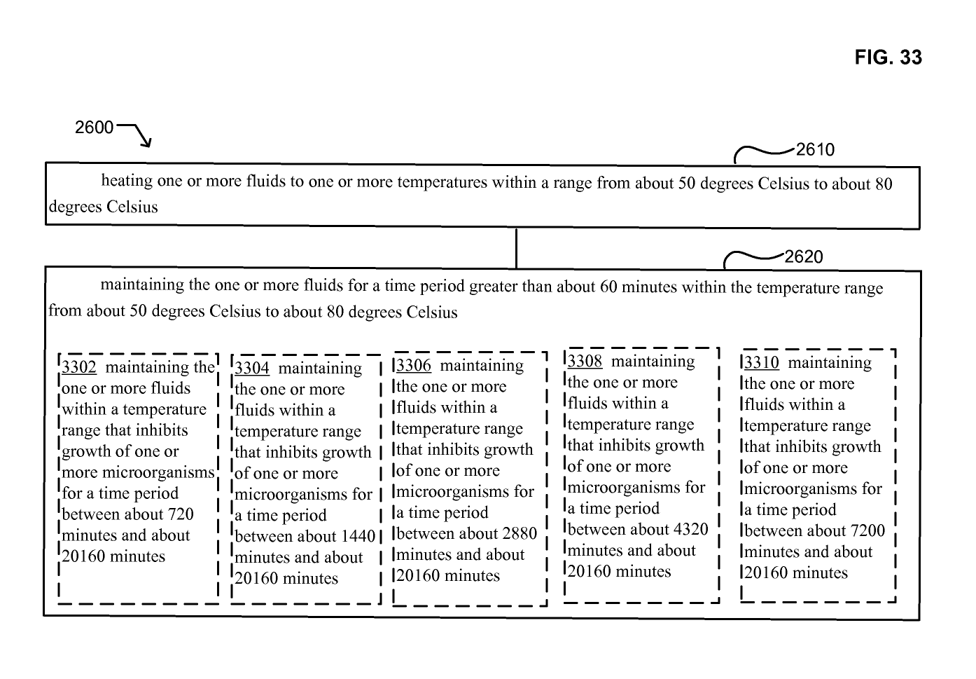

FIG. 33 illustrates alternative embodiments of the example operational flow 2600 of FIG. 26. FIG. 33 illustrates example embodiments where the maintaining operation 2620 may include at least one additional operation. Additional operations may include an operation 3302, an operation 3304, an operation 3306, an operation 3308, and/or operation 3310.

At operation 3302, the maintaining operation 2620 may include maintaining the one or more fluids within a temperature range that inhibits growth of one or more microorganisms for a time period between about 720 minutes and about 20160 minutes. In some embodiments, one or more heater units 168 may maintain one or more fluids within a temperature range from about 50 degrees Celsius to about 80 degrees Celsius for a time period between about 720 minutes and about 20160 minutes. In some embodiments, one or more control units 188 may control one or more heater units 168 to maintain one or more fluids for a time period between about 720 minutes and about 20160 minutes.

At operation 3304, the maintaining operation 2620 may include maintaining the one or more fluids within a temperature range that inhibits growth of one or more microorganisms for a time period between about 1440 minutes and about 20160 minutes. In some embodiments, one or more heater units 168 may maintain one or more fluids within a temperature range from about 50 degrees Celsius to about 80 degrees Celsius for a time period between about 1440 minutes and about 20160 minutes. In some embodiments, one or more control units 188 may control one or more heater units 168 to maintain one or more fluids for a time period between about 1440 minutes and about 20160 minutes.

At operation 3306, the maintaining operation 2620 may include maintaining the one or more fluids within a temperature range that inhibits growth of one or more microorganisms for a time period between about 2880 minutes and about 20160 minutes. In some embodiments, one or more heater units 168 may maintain one or more fluids within a temperature range from about 50 degrees Celsius to about 80 degrees Celsius for a time period between about 2880 minutes and about 20160 minutes. In some embodiments, one or more control units 188 may control one or more heater units 168 to maintain one or more fluids for a time period between about 2880 minutes and about 20160 minutes.

At operation 3308, the maintaining operation 2620 may include maintaining the one or more fluids within a temperature range that inhibits growth of one or more microorganisms for a time period between about 4320 minutes and about 20160 minutes. In some embodiments, one or more heater units 168 may maintain one or more fluids within a temperature range from about 50 degrees Celsius to about 80 degrees Celsius for a time period between about 4320 minutes and about 20160 minutes. In some embodiments, one or more control units 188 may control one or more heater units 168 to maintain one or more fluids for a time period between about 4320 minutes and about 20160 minutes.

At operation 3310, the maintaining operation 2620 may include maintaining the one or more fluids within a temperature range that inhibits growth of one or more microorganisms for a time period between about 7200 minutes and about 20160 minutes. In some embodiments, one or more heater units 168 may maintain one or more fluids within a temperature range from about 50 degrees Celsius to about 80 degrees Celsius for a time period between about 7200 minutes and about 20160 minutes. In some embodiments, one or more control units 188 may control one or more heater units 168 to maintain one or more fluids for a time period between about 7200 minutes and about 20160 minutes.

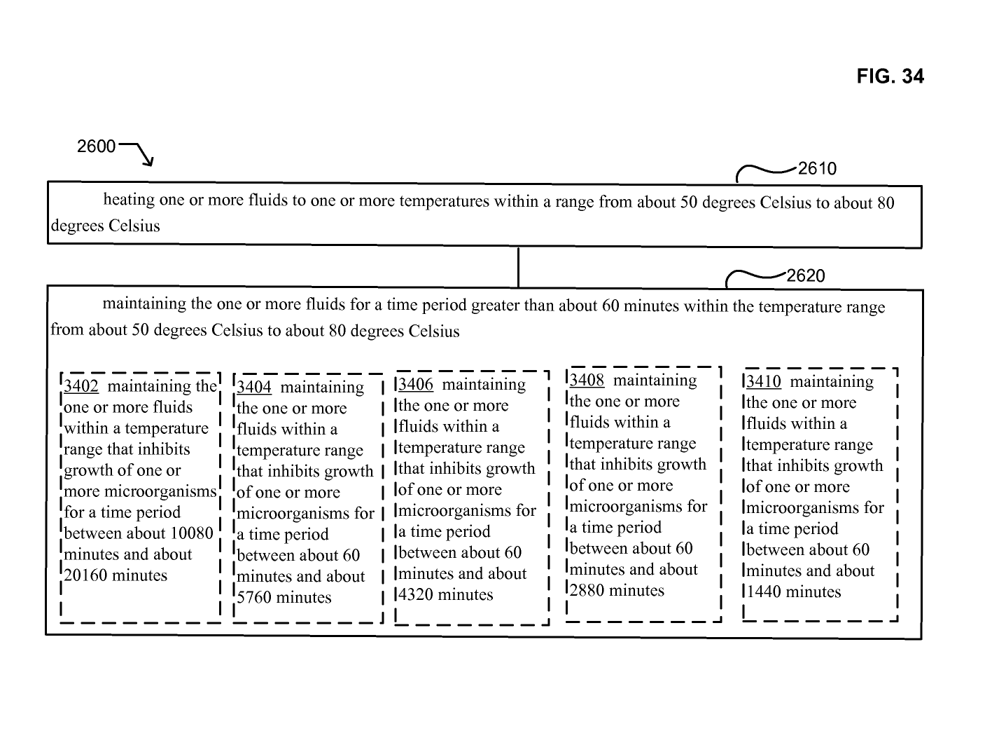

FIG. 34 illustrates alternative embodiments of the example operational flow 2600 of FIG. 26. FIG. 34 illustrates example embodiments where the maintaining operation 2620 may include at least one additional operation. Additional operations may include an operation 3402, an operation 3404, an operation 3406, an operation 3408, and/or operation 3410.

At operation 3402, the maintaining operation 2620 may include maintaining the one or more fluids within a temperature range that inhibits growth of one or more microorganisms for a time period between about 10080 minutes and about 20160 minutes. In some embodiments, one or more heater units 168 may maintain one or more fluids within a temperature range from about 50 degrees Celsius to about 80 degrees Celsius for a time period between about 10080 minutes and about 20160 minutes. In some embodiments, one or more control units 188 may control one or more heater units 168 to maintain one or more fluids for a time period between about 10080 minutes and about 20160 minutes.

At operation 3404, the maintaining operation 2620 may include maintaining the one or more fluids within a temperature range that inhibits growth of one or more microorganisms for a time period between about 60 minutes and about 5760 minutes. In some embodiments, one or more heater units 168 may maintain one or more fluids within a temperature range from about 50 degrees Celsius to about 80 degrees Celsius for a time period between about 60 minutes and about 5760 minutes. In some embodiments, one or more control units 188 may control one or more heater units 168 to maintain one or more fluids for a time period between about 60 minutes and about 5760 minutes.

At operation 3406, the maintaining operation 2620 may include maintaining the one or more fluids within a temperature range that inhibits growth of one or more microorganisms for a time period between about 60 minutes and about 4320 minutes. In some embodiments, one or more heater units 168 may maintain one or more fluids within a temperature range from about 50 degrees Celsius to about 80 degrees Celsius for a time period between about 60 minutes and about 4320 minutes. In some embodiments, one or more control units 188 may control one or more heater units 168 to maintain one or more fluids for a time period between about 60 minutes and about 4320 minutes.

At operation 3408, the maintaining operation 2620 may include maintaining the one or more fluids within a temperature range that inhibits growth of one or more microorganisms for a time period between about 60 minutes and about 2880 minutes. In some embodiments, one or more heater units 168 may maintain one or more fluids within a temperature range from about 50 degrees Celsius to about 80 degrees Celsius for a time period between about 60 minutes and about 2880 minutes. In some embodiments, one or more control units 188 may control one or more heater units 168 to maintain one or more fluids for a time period between about 60 minutes and about 2880 minutes.

At operation 3410, the maintaining operation 2620 may include maintaining the one or more fluids within a temperature range that inhibits growth of one or more microorganisms for a time period between about 60 minutes and about 1440 minutes. In some embodiments, one or more heater units 168 may maintain one or more fluids within a temperature range from about 50 degrees Celsius to about 80 degrees Celsius for a time period between about 60 minutes and about 1440 minutes. In some embodiments, one or more control units 188 may control one or more heater units 168 to maintain one or more fluids for a time period between about 60 minutes and about 1440 minutes.

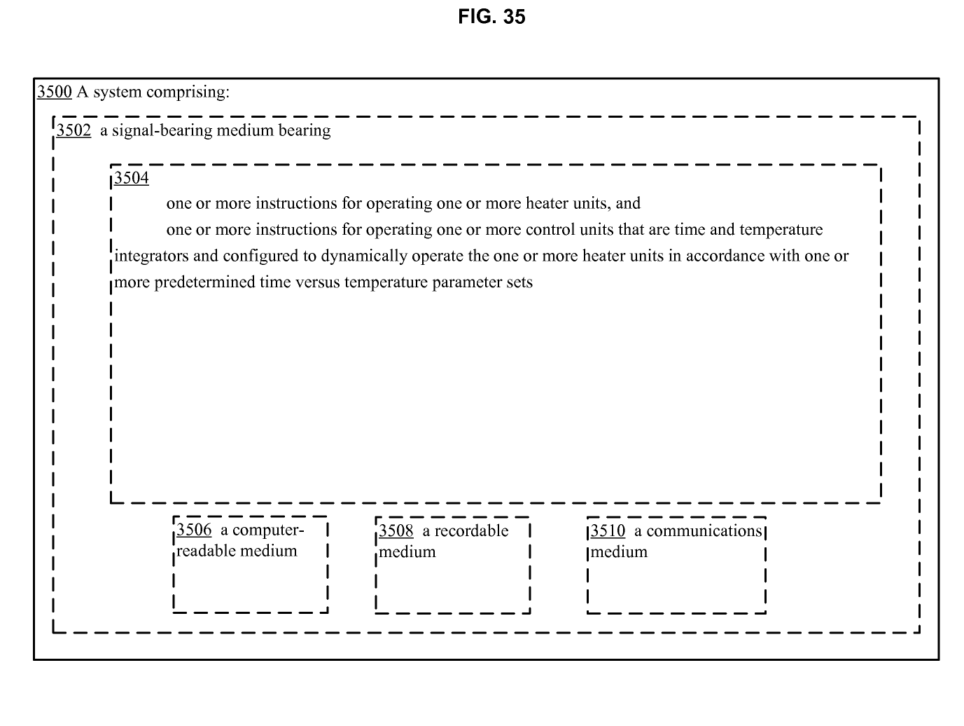

FIG. 35 illustrates a partial view of a system 3500 that includes a computer program 3504 for executing a computer process on a computing device. An embodiment of system 3500 is provided using a signal-bearing medium 3502 bearing one or more instructions for operating one or more heater units and one or more instructions for operating one or more control units that are time and temperature integrators and configured to dynamically operate the one or more heater units in accordance with one or more predetermined time versus temperature parameter sets. The one or more instructions may be, for example, computer executable and/or logic-implemented instructions. In some embodiments, the signal-bearing medium 3502 may include a computer-readable medium 3506. In some embodiments, the signal-bearing medium 3502 may include a recordable medium 3508. In some embodiments, the signal-bearing medium 3502 may include a communications medium 3510.

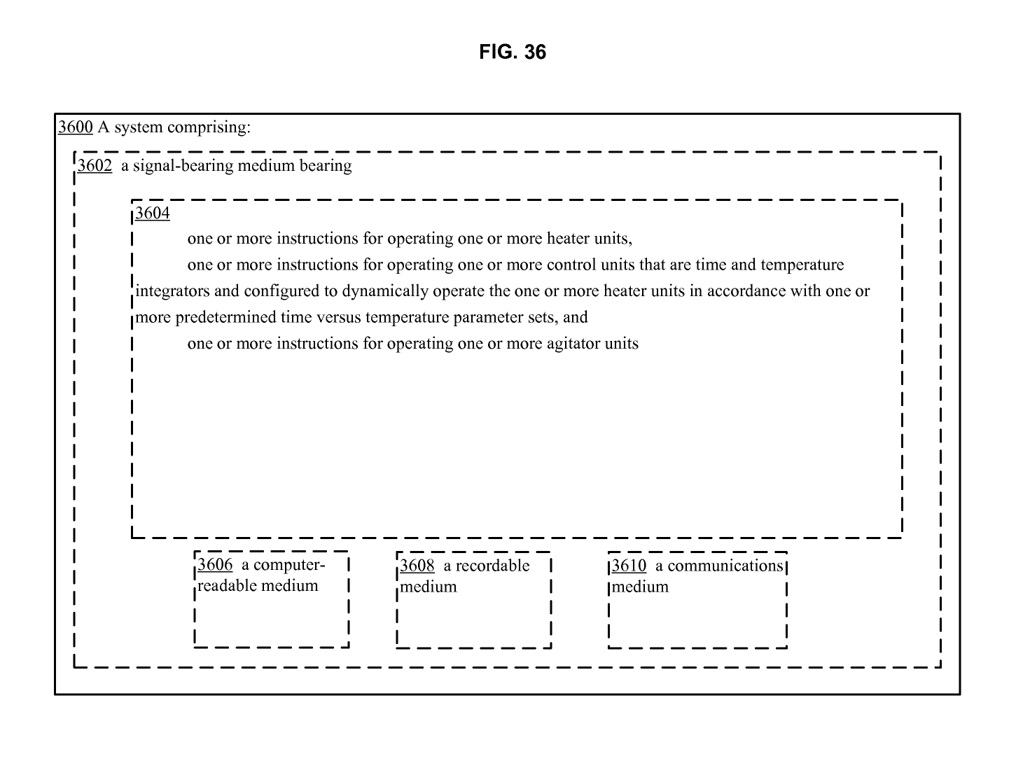

FIG. 36 illustrates a partial view of a system 3600 that includes a computer program 3604 for executing a computer process on a computing device. An embodiment of system 3600 is provided using a signal-bearing medium 3602 bearing one or more instructions for operating one or more heater units, one or more instructions for operating one or more control units that are time and temperature integrators and configured to dynamically operate the one or more heater units in accordance with one or more predetermined time versus temperature parameter sets, and one or more instructions for operating one or more agitator units. The one or more instructions may be, for example, computer executable and/or logic-implemented instructions. In some embodiments, the signal-bearing medium 3602 may include a computer-readable medium 3606. In some embodiments, the signal-bearing medium 3602 may include a recordable medium 3608. In some embodiments, the signal-bearing medium 3602 may include a communications medium 3610.

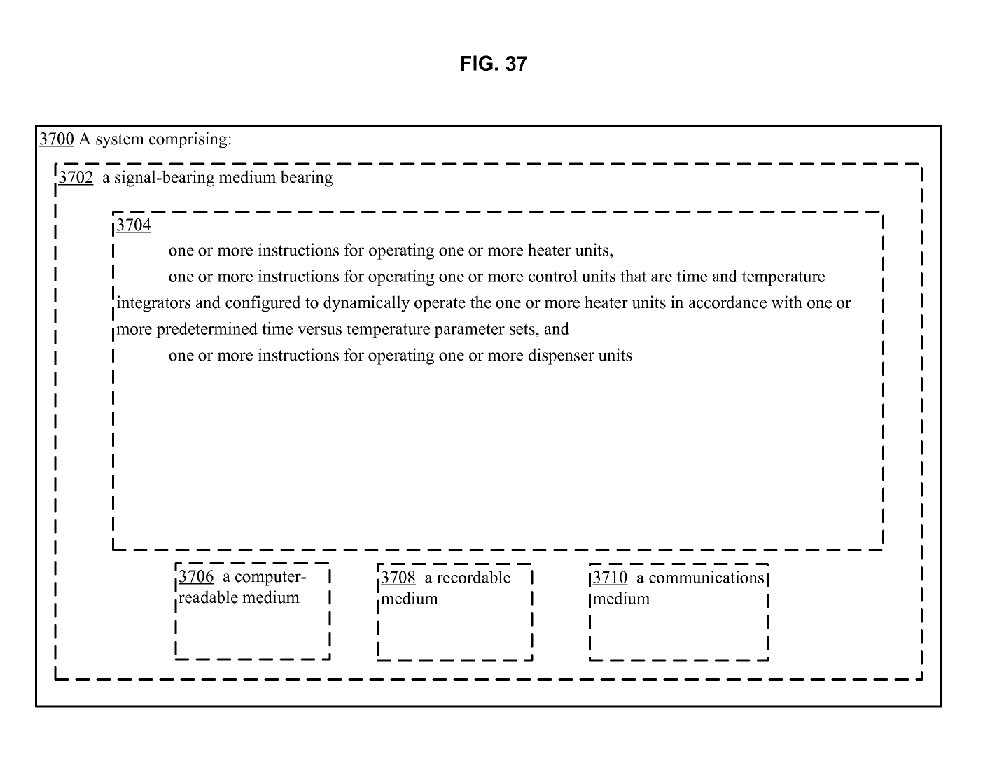

FIG. 37 illustrates a partial view of a system 3700 that includes a computer program 3704 for executing a computer process on a computing device. An embodiment of system 3700 is provided using a signal-bearing medium 3702 bearing one or more instructions for operating one or more heater units, one or more instructions for operating one or more control units that are time and temperature integrators and configured to dynamically operate the one or more heater units in accordance with one or more predetermined time versus temperature parameter sets, and one or more instructions for operating one or more dispenser units. The one or more instructions may be, for example, computer executable and/or logic-implemented instructions. In some embodiments, the signal-bearing medium 3702 may include a computer-readable medium 3706. In some embodiments, the signal-bearing medium 3702 may include a recordable medium 3708. In some embodiments, the signal-bearing medium 3702 may include a communications medium 3710.

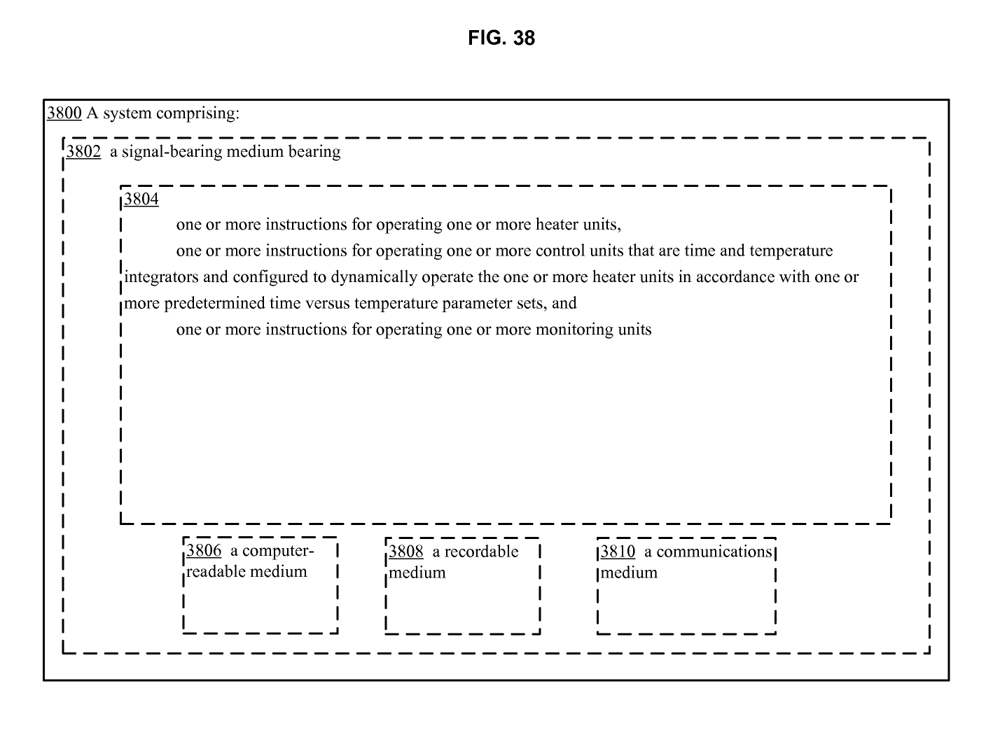

FIG. 38 illustrates a partial view of a system 3800 that includes a computer program 3804 for executing a computer process on a computing device. An embodiment of system 3800 is provided using a signal-bearing medium 3802 bearing one or more instructions for operating one or more heater units, one or more instructions for operating one or more control units that are time and temperature integrators and configured to dynamically operate the one or more heater units in accordance with one or more predetermined time versus temperature parameter sets, and one or more instructions for operating one or more monitoring units. The one or more instructions may be, for example, computer executable and/or logic-implemented instructions. In some embodiments, the signal-bearing medium 3802 may include a computer-readable medium 3806. In some embodiments, the signal-bearing medium 3802 may include a recordable medium 3808. In some embodiments, the signal-bearing medium 3802 may include a communications medium 3810.

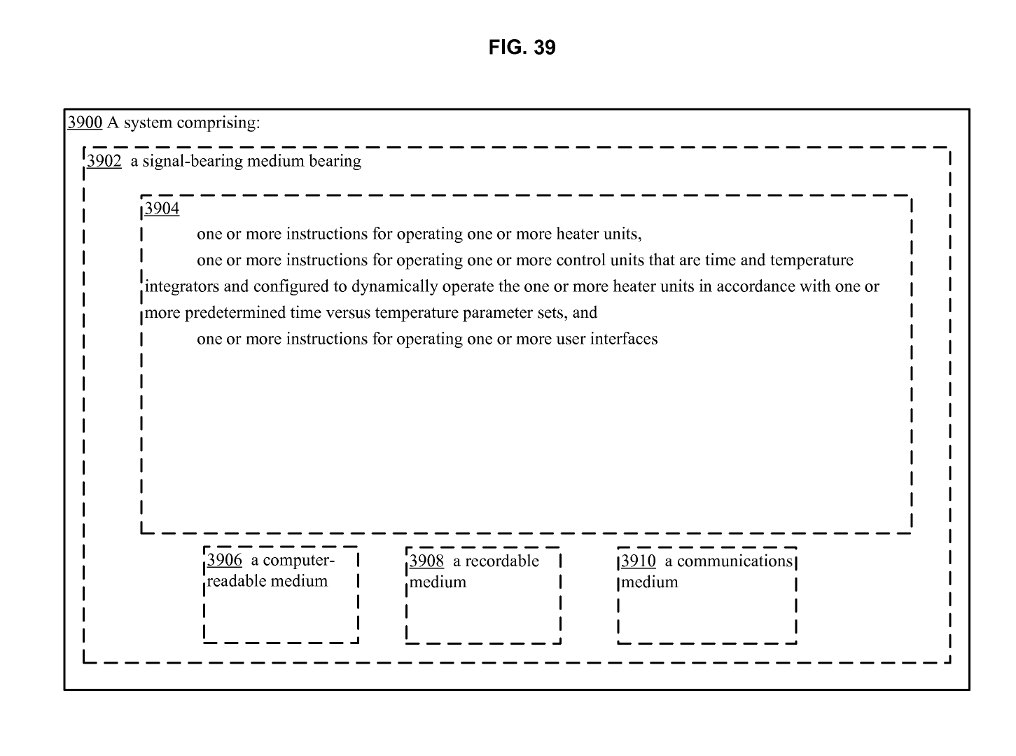

FIG. 39 illustrates a partial view of a system 3900 that includes a computer program 3904 for executing a computer process on a computing device. An embodiment of system 3900 is provided using a signal-bearing medium 3902 bearing one or more instructions for operating one or more heater units, one or more instructions for operating one or more control units that are time and temperature integrators and configured to dynamically operate the one or more heater units in accordance with one or more predetermined time versus temperature parameter sets, and one or more instructions for operating one or more user interfaces. The one or more instructions may be, for example, computer executable and/or logic-implemented instructions. In some embodiments, the signal-bearing medium 3902 may include a computer-readable medium 3906. In some embodiments, the signal-bearing medium 3902 may include a recordable medium 3908. In some embodiments, the signal-bearing medium 3902 may include a communications medium 3910.

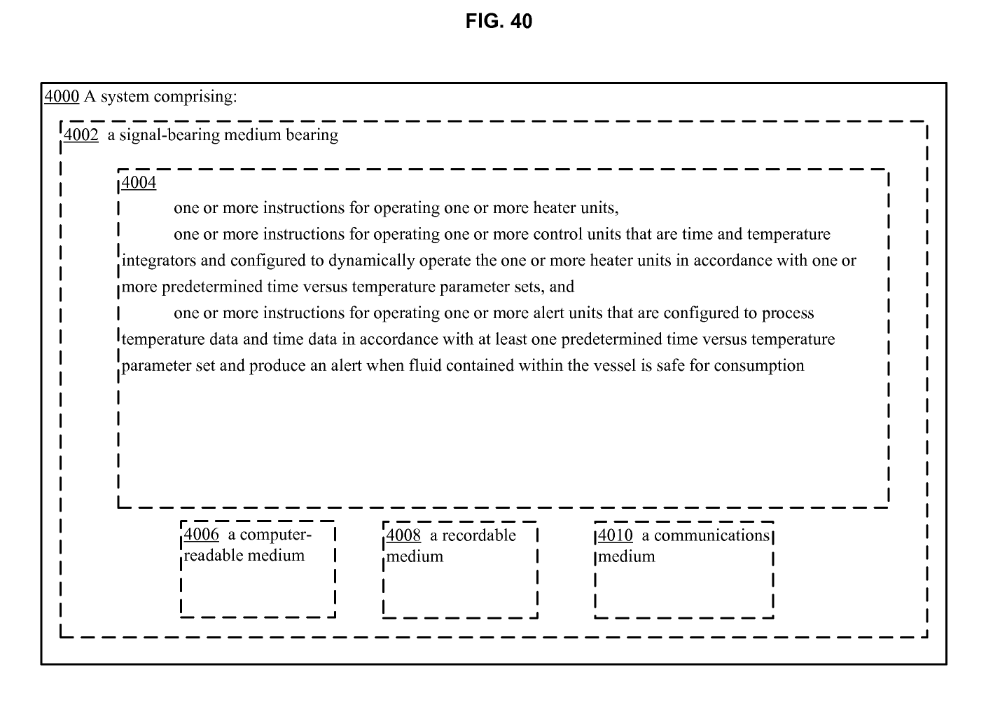

FIG. 40 illustrates a partial view of a system 4000 that includes a computer program 4004 for executing a computer process on a computing device. An embodiment of system 4000 is provided using a signal-bearing medium 4002 bearing one or more instructions for operating one or more heater units, one or more instructions for operating one or more control units that are time and temperature integrators and configured to dynamically operate the one or more heater units in accordance with one or more predetermined time versus temperature parameter sets, and one or more instructions for operating one or more alert units that are configured to process temperature data and time data in accordance with at least one predetermined time versus temperature parameter set and produce an alert when fluid contained within the vessel is safe for consumption. The one or more instructions may be, for example, computer executable and/or logic-implemented instructions. In some embodiments, the signal-bearing medium 4002 may include a computer-readable medium 4006. In some embodiments, the signal-bearing medium 4002 may include a recordable medium 4008. In some embodiments, the signal-bearing medium 4002 may include a communications medium 4010.

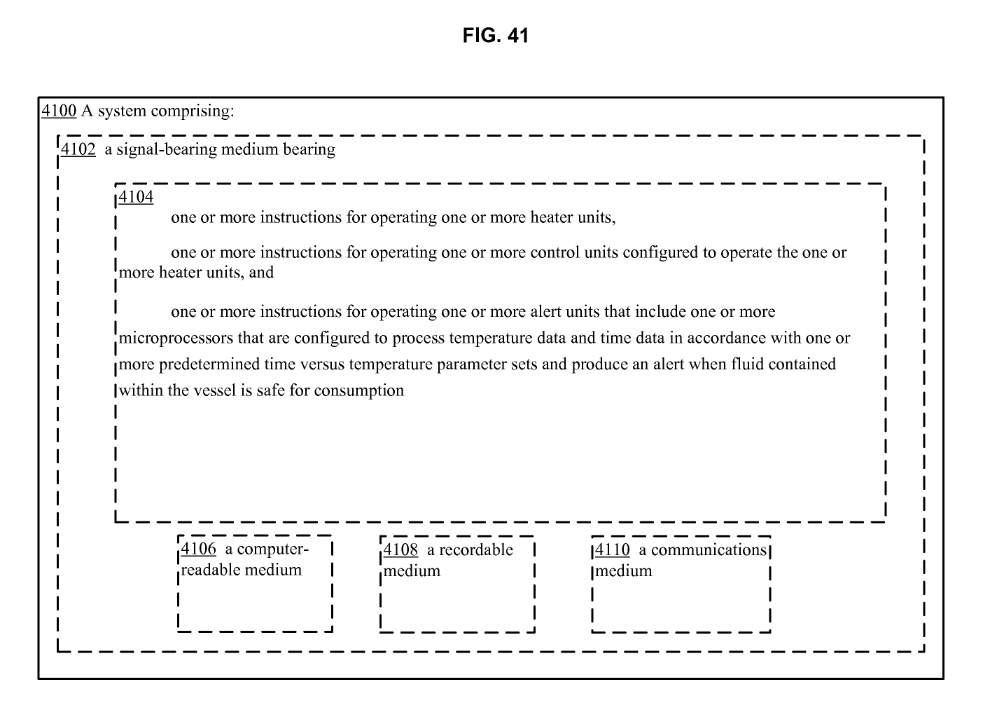

FIG. 41 illustrates a partial view of a system 4100 that includes a computer program 4104 for executing a computer process on a computing device. An embodiment of system 4100 is provided using a signal-bearing medium 4102 bearing one or more instructions for operating one or more heater units, one or more instructions for operating one or more control units configured to operate the one or more heater units, and one or more instructions for operating one or more alert units that include one or more microprocessors that are configured to process temperature data and time data in accordance with one or more predetermined time versus temperature parameter sets and produce an alert when fluid contained within the vessel is safe for consumption. The one or more instructions may be, for example, computer executable and/or logic-implemented instructions. In some embodiments, the signal-bearing medium 4102 may include a computer-readable medium 4106. In some embodiments, the signal-bearing medium 4102 may include a recordable medium 4108. In some embodiments, the signal-bearing medium 4102 may include a communications medium 4110.

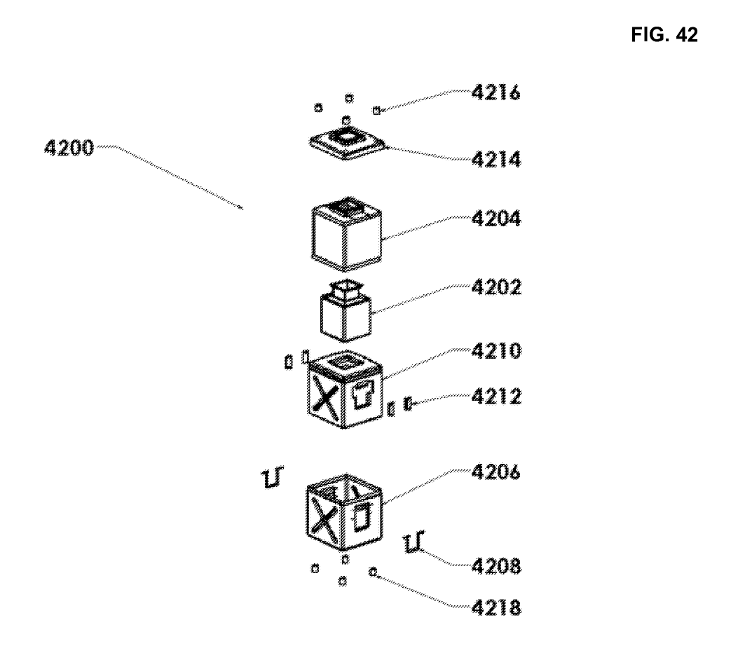

FIG. 42 illustrates one embodiment of a vessel 4200. Vessel 4200 includes a container member 4202. Vessel 4200 includes vacuum insulation panels 4204. Vessel 4200 includes a covering 4206. Vessel 4200 includes a handle 4208. Vessel 4200 includes flow insulation 4210. Vessel 4200 includes handle stiffeners 4212. Vessel 4200 includes a top enclosure 4214. Vessel 4200 includes a top stacking support 4216. Vessel 4200 includes foot members 4218.

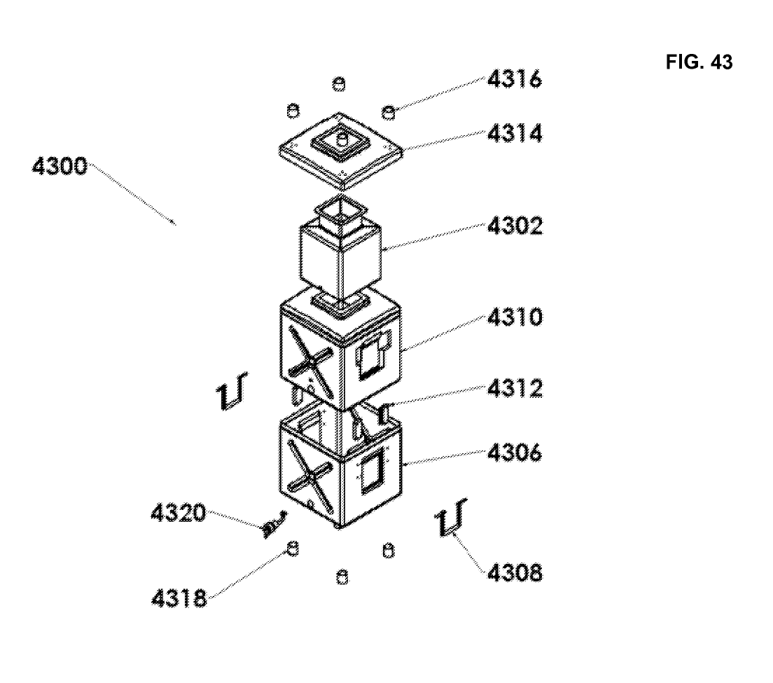

FIG. 43 illustrates one embodiment of a vessel 4300. Vessel 4300 includes a container member 4302. Vessel 4300 includes vacuum insulation panels 4304. Vessel 4300 includes a covering 4306. Vessel 4300 includes a handle 4308. Vessel 4300 includes flow insulation 4310. Vessel 4300 includes handle stiffeners 4312. Vessel 4300 includes a top enclosure 4314. Vessel 4300 includes a top stacking support 4316. Vessel 4300 includes foot members 4318. Vessel 4300 includes a spigot 4320.

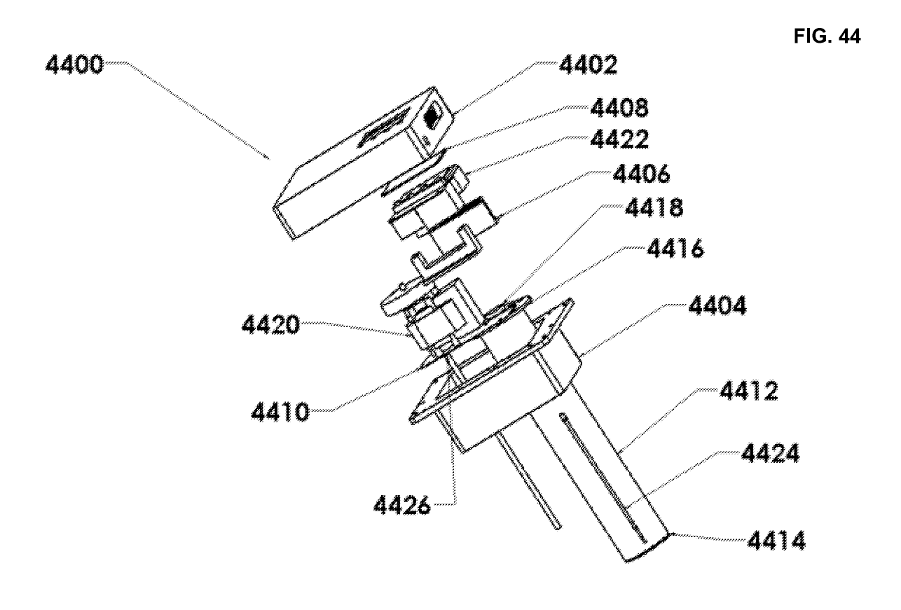

FIG. 44 illustrates one embodiment of a heater unit 4400. Heater unit 4400 includes an immersion heater housing top 4402. Heater unit 4400 includes an immersion heater housing bottom 4404. Heater unit 4400 includes immersion heater mounts 4406. Heater unit 4400 includes an immersion heater LCD cover 4408. Heater unit 4400 includes an immersion heater ground plate 4410. Heater unit 4400 includes an immersion heater sheath 4412. Heater unit 4400 includes an immersion heater bottom cap 4414. Heater unit 4400 includes an immersion heater cartridge gasket 4416. Heater unit 4400 includes an immersion heater cartridge 4418. Heater unit 4400 includes an immersion heater motor 4420. Heater unit 4400 includes a controller unit 4422. Heater unit 4400 includes an immersion heater temperature probe 4424. Heater unit 4400 includes a sleeve bearing 4426.

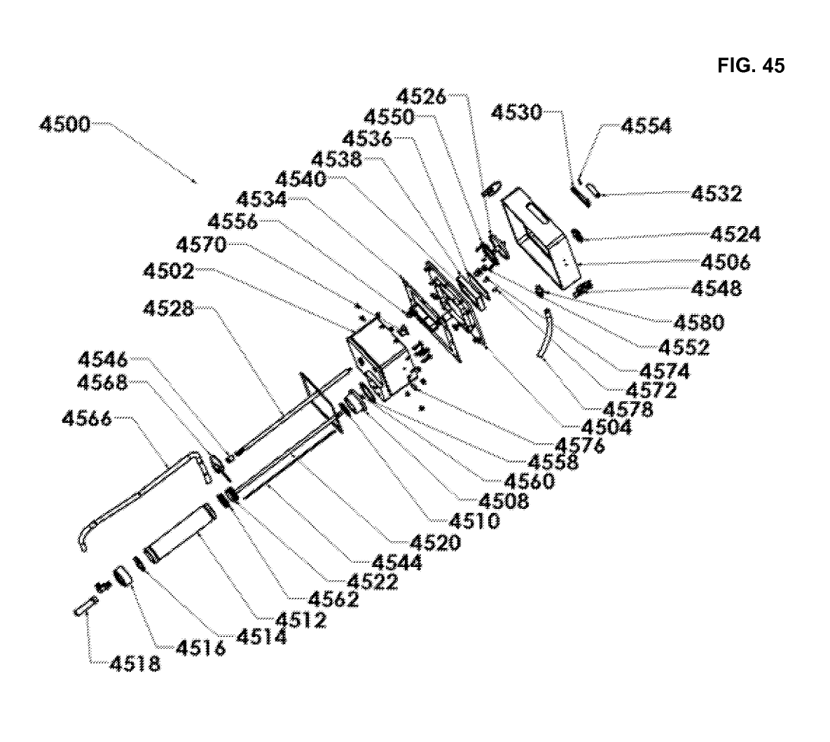

FIG. 45 illustrates one embodiment of a pump/agitator unit 4500. Pump/agitator unit 4500 includes a housing 4502. Pump/agitator unit 4500 includes a housing lid 4504. Pump/agitator unit 4500 includes a housing cover 4506. Pump/agitator unit 4500 includes an end cap 4508. Pump/agitator unit 4500 includes a pump inlet seal 4510. Pump/agitator unit 4500 includes a housing tube 4512. Pump/agitator unit 4500 includes a pump outlet seal 4514. Pump/agitator unit 4500 includes a pump bottom cap 4516. Pump/agitator unit 4500 includes a pump outlet tube 4518. Pump/agitator unit 4500 includes a pump shaft 4520. Pump/agitator unit 4500 includes a pump piston 4522. Pump/agitator unit 4500 includes a pump handle 4524. Pump/agitator unit 4500 includes an agitator gear adapter 4526. Pump/agitator unit 4500 includes mixer shaft 4528. Pump/agitator unit 4500 includes a mixer handle 4530. Pump/agitator unit 4500 includes a mixer handle knob 4532. Pump/agitator unit 4500 includes a pump/agitator gasket 4534. Pump/agitator unit 4500 includes a liquid crystal display 4536. Pump/agitator unit 4500 includes an electronics main board 4538. Pump/agitator unit 4500 includes an electronics cover box 4540. Pump/agitator unit 4500 includes a liquid crystal display cover 4542. Pump/agitator unit 4500 includes a thermocouple tube 4544. Pump/agitator unit 4500 includes an agitator propeller sleeve 4546. Pump/agitator unit 4500 includes a latch assembly 4548. Pump/agitator unit 4500 includes an agitator ring gear 4550. Pump/agitator unit 4500 includes an agitator spur gear 4552. Pump/agitator unit 4500 includes a dowel pin 4554. Pump/agitator unit 4500 includes a sleeve bearing 4556. Pump/agitator unit 4500 includes a top pump face O-ring 4558. Pump/agitator unit 4500 includes a pump shaft o-ring 4560. Pump/agitator unit 4500 includes a pump/agitator body o-ring 4562. Pump/agitator unit 4500 includes a pump plunger o-ring 4564. Pump/agitator unit 4500 includes a pump check valve tube 4566. Pump/agitator unit 4500 includes an agitator propeller 4568. Pump/agitator unit 4500 includes a breather vent 4570. Pump/agitator unit 4500 includes a digikey light emitting diode 4572. Pump/agitator unit 4500 includes a digihey switch 4574. Pump/agitator unit 4500 includes a sensor 4576. Pump/agitator unit 4500 includes a spout tube 4578. Pump/agitator unit 4500 includes a nylon check valve 4580.

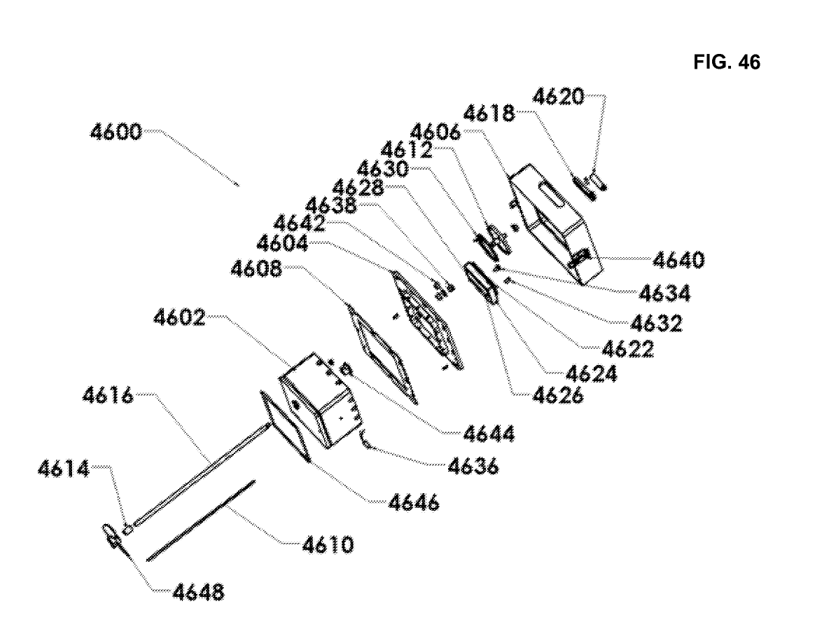

FIG. 46 illustrates one embodiment of an agitator unit 4600. Agitator unit 4600 includes a housing 4602. Agitator unit 4600 includes a housing lid 4604. Agitator unit 4600 includes a housing cover 4606. Agitator unit 4600 includes a gasket 4608. Agitator unit 4600 includes a thermocouple tube 4610. Agitator unit 4600 includes an agitator gear adapter 4612. Agitator unit 4600 includes a propeller sleeve 4614. Agitator unit 4600 includes an agitator shaft 4616. Agitator unit 4600 includes an agitator handle 4618. Agitator unit 4600 includes an agitator handle knob 4620. Agitator unit 4600 includes a liquid crystal display cover 4622. Agitator unit 4600 includes an electronics cover box 4624. Agitator unit 4600 includes an electronics main board 4626. Agitator unit 4600 includes a liquid crystal display 4628. Agitator unit 4600 includes a ring gear 4630. Agitator unit 4600 includes a digikey light emitting diode 4632. Agitator unit 4600 includes a digikey switch 4634. Agitator unit 4600 includes a sensor 4636. Agitator unit 4600 includes a spur gear 4638. Agitator unit 4600 includes a latch assembly 4640. Agitator unit 4600 includes a sleeve bearing 4642. Agitator unit 4600 includes a breather vent 4644. Agitator unit 4600 includes a body o-ring 4646. Agitator unit 4600 includes a propeller 4648.

### Example I

### Inactivation of Pathogenic Microorganisms in Raw Milk with Low Temperature, Extended Time Pasteurization

Low temperature (65° C.), extended time (2 hours) pasteurization was investigated as a method to inactivate pathogenic microorganisms (E. coli O157:H7, Listeria monocytogenes, and Salmonella enterica) in raw milk. Natural microbiota found to be resistant to the pasteurization were isolated and identified.

### Methods and Materials

Milk: Raw milk (Pride and Joy Dairy, Granger, Wash.) was purchased from a local health food store (TruHealth, Mill Creek, Wash.) and stored at 4° C. for 24 hours prior to use.

Preparation of Inocula: Strains of E. coli O157:H7, L. monocytogenes, and Salmonella enterica (Table 1) were used to create cocktails of inocula. Each bacterial strain was available as a frozen (−80° C.) stock cultures in tryptic soy broth (TSB, Becton Dickinson, Sparks, Md.) with 25% glycerol and was activated by streaking onto tryptic soy agar (TSA, Becton Dickinson) and incubating at 35° C. for 24 hours. Colonies of each strain were transferred to individual Tryptic Soy Broth (TSB; Acumedia, Lansing, Mich.) and incubated at 35° C. for 24 hours to achieve a cell density of approximately 10⁹ cells/ml. Inocula cocktails were prepared by mixing equal parts of TSB cultures in a sterile media bottle to achieve a total volume in excess of 125 ml. Cocktails were pelleted by centrifugation at maximum speed for 30 minutes (Beckman Model TJ-6). Pellets were resuspended in 100 ml of raw milk. Inoculated and uninoculated milk was aliquoted (12 ml) into sterile glass vials with screw cap lids (Kimble Glass, Part No. 60940A-16) and held at 4° C. prior to treatment. Cell density of inoculated and uninoculated milk samples were determined using standard dilution (0.1% Peptone Water; Acumedia) and spread-plating techniques on non-selective Tryptic Soy Agar (TSA; Acumedia) with incubation at 35° C. for 24 hours and appropriate selective and/or differential agar (see Table 2).

TABLE 1
Pathogenic bacteria inoculated into raw milk

| | | | Selective and/or |
|---|---|---|---|
| Genus and | | Non-Selective | Differential |
| Species | Strain designation | Medium | Medium |
| Escherichia coli | MEI 3254 | Tryptic Soy | Eosin Methylene |
| O157:H7 | MEI 10303 | Agar (TSA), | Blue (EMB) Agar, |
| | MEI 12579 | 35° C. | 35° C. |
| | MEI 13512 | | |
| | MEI 45403 | | |
| Listeria | ATCC 19115 | TSA, 35° C. | Modified Oxford |
| monocytogenes | MEI 887 | | (MOX) Agar, 35° C. |
| | MEI 20333 | | |
| | MEI 31639 | | |
| | MEI 40881 | | |
| Salmonella | Enteritidis ATCC 4931 | TSA, 35° C. | Xylose Lysine |
| enterica | Heidelberg ATCC 8326 | | Desoxycholate |
| | Javiana ATCC 10721 | | (XLD) Agar, 35° C. |
| | Senftenberg ATCC 42845 | | |
| | Typhimurium ATCC 14028 | | |

### Low Temperature, Extended Time Pasteurization Treatment

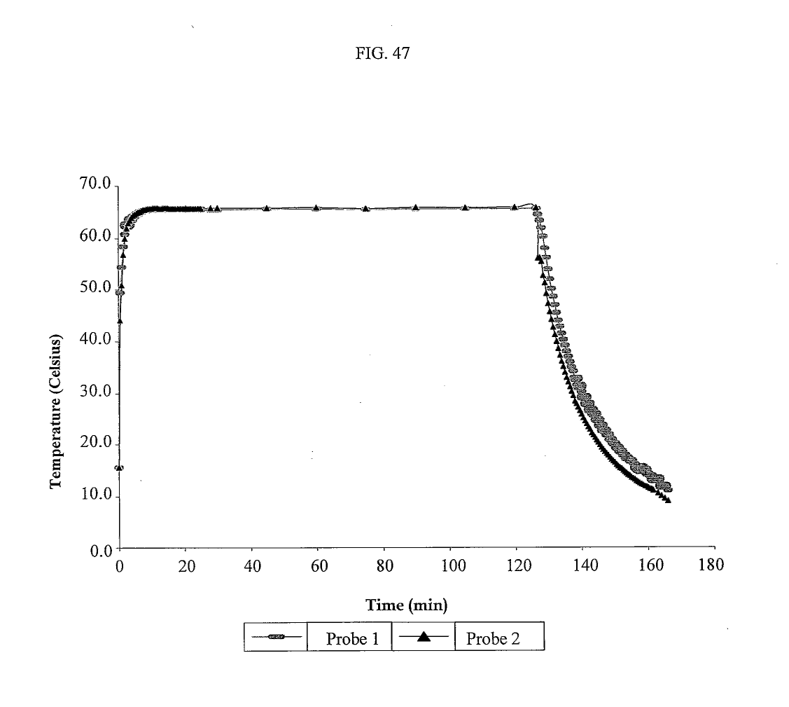

Three replicate samples of each inoculated milk and uninoculated milk were subjected to low temperature (65° C.), extended time (2 hours) pasteurization in a water bath (Fisher Scientific Isotemp 228). Arrangement of the samples in the water bath was random and documented. Two vials containing uninoculated raw milk were fitted with thermocouples and temperature was monitored during treatment and cooling (FIG. 47). Treatment time of 2 hours began once samples achieved 65.0° C. (come-up time 6.5 min). Following completion of treatment time, samples were immediately chilled prior to subsequent analyses. Three replicate untreated, control samples of inoculated and uninoculated milk were maintained at 4° C. prior to analysis.

### Microbiological Analysis

For direct enumeration of microbial populations, a range of serial dilutions of milk were prepared using 0.1% PW as the diluent. Aliquots of 0.1 ml of appropriate dilutions were aseptically removed and plated onto the appropriate combination of TSA, EMB, MOX, and/or XLD (Table 1). Plates were incubated at 35° C. for 48 hours. Populations were manually counted following incubation. Counts were converted to log CFU/g for reporting. For most probable number analyses, 1.0, 0.1, and 0.01 ml of milk were transferred to tubes containing 10 ml of LES media (IEH Laboratories, Seattle, Wash.). Tubes were incubated at 35° C. for 24 hours. Following incubation, individual tubes were streaked for isolation on appropriate selective media (Table 2). Selective media were incubated at 35° C. for 48 hours and observed for the presence of colonies typical of the pathogenic species. Survivors were calculated using standard most probable number methods.

Survivors recovered from treated samples of uninoculated milk were isolated onto TSA and examined for unique colony and cellular morphologies. These isolates were identified by DNA sequencing methods utilizing the 165 and 18S rDNA genomic regions.

### Quality Indicators

Uninoculated milk samples (treated and untreated; n=3) were analyzed for changes in quality indicators. Samples were analyzed visually for changes in texture and appearance. Samples were also analyzed for changes in odor. Changes in pH were determined using a double junction pH spear (Oakton Industries).

### Results

Initial microbial loads in uninoculated and inoculated milk are shown in Table 3. Levels of microorganisms in uninoculated milk ranged from 2.7 to 2.8 log CFU/ml. Inoculation with L. monocytogenes was achieved at a level of 9.0 to 9.4 log CFU/ml, whereas inoculation with E. coli O157:H7 and S. enterica was slightly higher (9.2-9.6 for E. coli O157:H7; 9.2-9.5 for S. enterica). Initial counts were similar on the non-selective and selective/differential media. Reduction of each microbial population of interest is also displayed in Table 3. No recovery of any of the pathogenic microorganisms was achieved by either direct plating or most probable number technique.

A low concentration (1.01 log CFU/ml) of survivors was recovered from the uninoculated milk. These survivors were further isolated and identified (Table 4). Quality indicators (pH, odor, and texture) were evaluated for uninoculated raw and pasteurized milk samples (Table 5). The pH of the pasteurized milk decreased 0.1 units compared to the raw product. The low temperature, extended time treatment also resulted in some changes to the texture and appearance of the product. Minimal changes were noticed in the odor of the pasteurized milk.

Low temperature (65° C.), extended time (2 hours) pasteurization reduced pathogenic microorganisms (E. coli O157:H7, L. monocytogenes, and S. enterica) in raw milk. Spores that are natural contaminants of raw milk may survive the low temperature, extended time pasteurization treatment.

TABLE 3
Microbial load of raw and low temperature,
extended time pasteurized milk

| | | Log Count CFU/g (Standard | |
|---|---|---|---|
| | | Deviation; n = 3) | |
| | | | Selective/ |
| | | Non-selective | Differential |
| Product | Inoculum | Medium | Medium |
| Raw Milk | Uninoculated | 2.72 (0.05) | N/A |
| | E. coli O157:H7 | 9.35 (0.15) | 9.38 (0.20) |
| | L. monocytogenes | 9.14 (0.19) | 9.09 (0.18) |
| | S. enterica | 9.38 (0.09) | 9.28 (0.09) |
| Pasteurized Milk | Uninoculated | 1.01 (0.02) | N/A |
| | E. coli O157:H7 | 0.00* | 0.00* |
| | L. monocytogenes | 0.00* | 0.00* |
| | S. enterica | 0.00* | 0.00* |

*0.00 indicates no survivors detected by direct plating (detection limit 1 CFU/ml) or by most probable number (detection limit 0.3 CFU/ml).

TABLE 4
Microorganisms isolated from uninoculated milk that survived
low temperature, extended time pasteurization treatment

| Isolate | Colony morphology | | |
|---|---|---|---|
| Desig- | (TSA, 35° C., | Cellular | |
| nation | 24-48 hours) | morphology | Identity |
| A | 5 mm translucent | Gram-positive long, | Bacillus |
| | rough edge, flax, | thin, small rods | licheniformis |
| | complex colonies | with significant | |
| | | extracellular debris | |
| B | 5 mm cream, smooth, | Gram-positive very | Bacillus |
| | flat, round, entire | large rods | megaterium |
| | colonies | | |
| C | 3 mm translucent | Gram-positive | Bacillus pumilus |
| | yellow, flat, | average length | |
| | round, concentric, | and width rods | |
| | entire colonies | | |
| D | 5 mm transparent, | Gram-positive thin, | Paenibacillus |
| | flat, very rough | small rods | lautus |
| | edge colonies | | |
| E | 10 mm cream, very | Gram-positive, | Bacillus |
| | raised, rough edge, | average length | amyloliquefaciens |
| | complex symmetrical | and width rods with | |
| | flower-like | excessive cellular | |
| | patterned edge | debris and capsule | |
| | colonies | | |
| F | 2 mm cream, very | Gram-positive thin | Bacillus |
| | rough edge colonies | rods varying in | licheniformis |
| | | length from short | |
| | | to very long | |
| G | 2-4 mm white fuzzy | Not analyzed | Trichocomaceae |
| | colonies (mold) | | Family |
| H | 2-3 mm cream, | Gram-positive short | Bacillus pumilus |
| | yellow, smooth, | length, average | |
| | round, entire | width rods | |
| | colonies | | |
| I | I 2 mm cream, | Gram-positive | Bacillus pumilus |
| | yellow, smooth, | medium to long | |
| | round entire | length, average | |
| | colonies | width rods | |
| J | 3-4 mm cream, | Gram-positive short | Bacillus |
| | raised, rough edge, | to medium length, | licheniformis |
| | complex colonies | average width | |
| | | rods with moderate | |
| | | extracellular debris | |
| K | 5 mm cream, white, | Gram-positive very | Bacillus |
| | very raised, | short, average width | amyloliquefaciens |
| | asymmetrical | rods with excessive | |
| | complex structure | cellular debris and | |
| | colonies | capsule | |
| L | 1 mm translucent, | Gram-positive short | Terribacillus |
| | white, round, | length, average | saccharophilus |
| | entire edge | width rods | |
| | colonies | | |
| M | 2 mm | Gram-positive | Bacillus clausii |
| | translucent/ | excessively | |
| | transparent cream/ | long rods in | |
| | tan, rough edge | long chains | |
| | colonies | | |
| N | 2-5 mm bulbous, | Gram-positive | Bacillus |
| | complex, cream/tan, | average length | licheniformis |
| | raised colonies | and width rods with | |
| | | extracellular debris | |
| O | 2-3 mm cream/tan, | Gram-positive | Bacillus pumilus |
| | round, entire | average length | |
| | colonies | and width rods with | |
| | | segmented pieces | |

TABLE 5
Quality indicators of raw and low temperature, extended
time pasteurized milk (n = 3 per product)

| Product | pH | Odor | Texture |
|---|---|---|---|
| Raw Milk | 6.71-6.72 | Odorless, no smell | free flowing, |
| | | | homogenous white |
| | | | fluid |
| Pasteurized Milk | 6.62-6.63 | Odorless to slightly | separated into two |
| | | “milky” smell | layers; yellow cream |
| | | | layer cooked and set |

### Example II

### Effect of Low Temperature, Extended Time Pasteurization of Raw Milk on the Survival of Thermoduric Bacteria

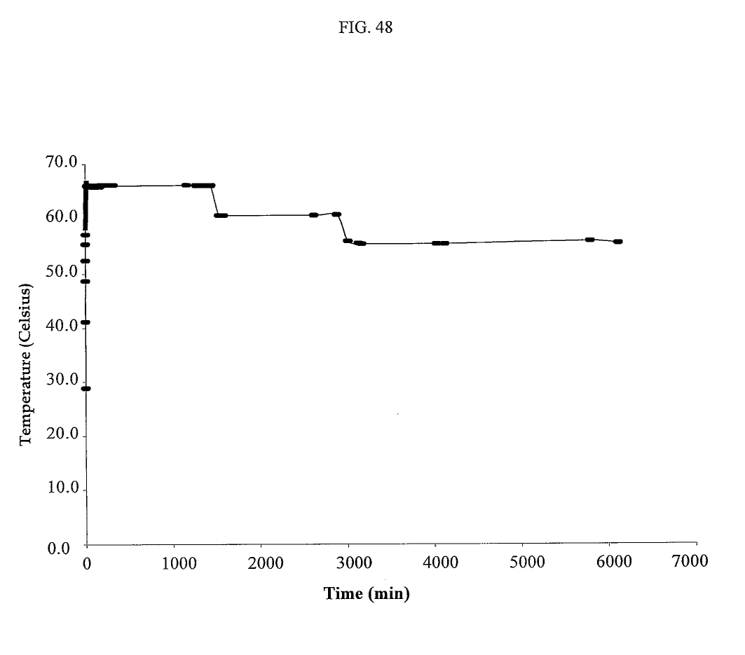

Low temperature (65° C.), extended time (24 hours) pasteurization with additional holding at >55° C. to inactivate thermoduric bacteria (Streptococcus thermophilus, Bacillus cereus spores, Geobacillus stearothermophilus spores, and Clostridium perfringens spores) in raw milk was investigated. FIG. 48 illustrates a temperature profile of milk throughout low temperature, extended time pasteurization and subsequent holding.

### Materials and Methods

Milk: Raw milk (Dungeness Valley Creamery, Sequim, Wash.) was purchased from a local health food store (TruHealth, Mill Creek, Wash.) and stored at 4° C. for 72 hours prior to use. Ten ml aliquots of inoculated and uninoculated milk were transferred to 20×150 mm glass screw cap test tubes.

### Preparation of Inocula

Strains of S. thermophilus, B. cereus, G. stearothermophilus, and C. perfringens (Table 1) served as the inocula. Each bacterial strain was available as a frozen (−80° C.) stock cultures with 25% glycerol and was activated by streaking onto appropriate medium and incubation conditions (see Table 1). Streptococcus thermophilus was transferred to M17 Broth (Becton Dickinson, Sparks, Md.) and incubated at 42° C. for 24 hours to achieve a cell density of approximately 10⁹ cells/ml. Broth was centrifuged at 10,000 rpm for 30 minutes and resuspended in raw milk to achieve a cell density of approximately 10⁶ CFU/ml.

Bacillus cereus and G. stearothermophilus were transferred to Nutrient Broth (TSB, Beckton Dickinson) and incubated for 24 hours at 37° and 55° C., respectively. Overnight cultures (0.5 ml) were spread plated onto Nutrient Agar and incubated for 24-72 hours at the appropriate temperature. Sporulation was determined by microscopic evaluation with simple crystal violet staining Spore crop was harvested by suspension of lawn in 10 ml of cold, sterile, distilled water. Suspensions were centrifuged and washed with water a total of 4 times. Between the second and third wash the suspension was pasteurized at 80° C. for 10 minutes to inactivate vegetative cells. Spore crops were stored at 4° C. prior to use. Spore crops were centrifuged at 10,000 rpm for 30 minutes and resuspended in raw milk to achieve a spore density of approximately 10⁶ CFU/ml.

Clostridium perfringens was transferred to thioglycollate broth with dextrose (Becton Dickinson) and incubated at 37° C. for 4 hours. This culture was used to inoculate a second tube of thioglycollate broth with dextrose and incubated at 37° C. for 4 hours. This culture was used to inoculate modified Duncan-Strong Sporulation Medium (per FDA Bacteriological Analytical Manual recipe) at a level of 10% with incubation at 37° C. for 24 hours. Sporulation was determined by microscopic evaluation with simple crystal violet staining Spore crop was centrifuged and washed with water a total of 4 times. Between the second and third wash, the suspension was pasteurized at 80° C. for 10 minutes to inactivate vegetative cells. Spore crops were stored at 4° C. prior to use. Spore was centrifuged at 10,000 rpm for 30 min and resuspended in raw milk to achieve a spore density of approximately 10⁶ CFU/ml.

TABLE 1
Thermoduric bacteria inoculated into raw milk

| Genus and | Strain | | |
|---|---|---|---|
| Species | designation | Total Count | Spore Count |
| Streptococcus | MEI #21119 | M17 Agar, | N/A |
| Thermophiles | | 42° C. | |
| Bacillus cereus | MEI # 232 | Tryptic Soy | 80° C. 10 min; |
| (spores) | | Agar, 37° C. | Tryptic Soy Agar, |
| | | | 37° C. |
| Geobacillus | MEI # 13 | Tryptic Soy | 80° C. 10 min; |
| Stearo- | | Agar, 55° C. | Tryptic Soy Agar, |
| thermophilus | | | 55° C. |
| (spores) | | | |
| Clostridium | MEI # 12312 | Tryptose Sulfite | 80° C. 10 min; |
| perfringens | | Cycloserine Agar, | Tryptose Sulfite |
| (spores) | | 37° C. | Cycloserine Agar, |
| | | (anaerobic) | 37° C. |
| | | | (anaerobic) |

### Low Temperature, Extended Time Pasteurization Treatment

Tubes of inoculated milk and uninoculated milk were subjected to low temperature (65° C.), extended time (24 hours) pasteurization in a water bath (VWR Precision Water Bath 50). Arrangement of the samples (tubes) in the water bath was random. One tube containing uninoculated raw milk was fitted with a thermocouple and temperature was monitored during treatment and storage. Following completion of the pasteurization treatment, the water bath temperature was reduced to 60° C. for 24 hours, and then reduced to 55° C. for 48 hours. This temperature profile was selected to mimic the storage conditions for use in a distribution chain and storage and container system. Samples subjected to 65° C. were analyzed after 24, 48, 72, and 96 hours. Additional samples were held at 55° C. and evaluated after 24, 48, and 72 hours. Untreated samples were analyzed to determine inoculation level.

### Microbiological Analysis

For direct enumeration of microbial populations, a range of serial dilutions of milk were prepared using 0.1% PW as the diluent. Aliquots of 0.1 ml of appropriate dilutions were aseptically removed and plated onto the appropriate media (Table 1). Plates were incubated 24-48 hours prior to enumeration. Populations were manually counted following incubation. Counts were converted to log CFU/g for reporting. Enumeration of spores was determined by standard pour plating methods following treatment at 80° C. for 10 minutes in appropriate medium (Table 1).

### Quality Indicators

Uninoculated milk samples (treated and untreated; n=3) were analyzed for changes in quality indicators. Samples were analyzed visually for changes in texture and appearance. Samples were also analyzed for changes in odor. Changes in pH were determined using a double junction pH spear (Oakton Industries).

### Results

Initial microbial loads in uninoculated and inoculated milk are shown in Table 2. Levels of microorganisms in uninoculated milk ranged from 3.24 to 3.35 log CFU/ml. Inoculation with S. thermophilus, B. cereus spores, and G. stearothermophilus spores was achieved at a level of 6.0 to 6.3 log CFU/ml, whereas inoculation with C. perfringens spores was slightly lower (5.51 log CFU/ml). Spore count method for C. perfringens was lower than expected in the raw milk; possible explanations include increased sensitivity of the spores to heat treatment and/or rapid germination of the spores in milk.

Reduction of each microbial population due to the low temperature pasteurization (65° C., 24 hours) is also displayed in Table 2. S. thermophilus populations and natural microflora were completely inactivated with the pasteurization treatment. C. perfringens spores were also quite sensitive to the low temperature pasteurization; however, an average total count of 2.77 log CFU/ml of C. perfringens was recovered from treated milk on TSC plates. The population of G. stearothermophilus was slightly reduced by the low temperature pasteurization (0.3 log reduction of total count and 0.4 log reduction of spore count). Total counts of B. cereus slightly increased (0.1 log CFU/ml) with the pasteurization treatment; however, B. cereus spore count was reduced 1 log CFU/ml.

Changes in the populations of sporeforming bacteria with pasteurization and subsequent holding at 60° C. and 55° C. are displayed in Table 3. Natural microflora and S. thermophilus were completely inactivated by the pasteurization treatment and were not recovered from milk with subsequent holding (data not shown). C. perfringens populations were reduced after the initial treatment of 65° C. for 24 hours and remained low throughout the subsequent holding period; however, C. perfringens was not completely eliminated. Treatment and subsequent holding of milk led to minimal reduction of total counts of G. stearothermophilus and B. cereus. Spore counts were minimally affected by subsequent holding at the temperatures used herein. Additional data on uninoculated and inoculated milk samples stored at 55° C. for up to 72 hours is presented in the appendix (Table 5).

Low temperature (65° C.), extended time (24 hours) pasteurization reduced natural microflora, S. thermophilus and C. perfringens in raw milk. B. cereus and G. stearothermophilus spores were resistant to the pasteurization treatment; however, no outgrowth of either organism was observed during the subsequent holding period. Organoleptic changes were observed in milk treated and held at the temperatures used herein.

TABLE 2
Microbial load of raw and low temperature,
extended time pasteurized milk

| | | | Milk Pasteurized | |
|---|---|---|---|---|
| | Raw Milk | | at 65° C., 24 h | |
| | Total | Spore | Total | Spore |
| Inoculum | Count | Count | Count | Count |
| Uninoculated | 3.29 (0.06) | N/A | <1.00 | N/A |
| S. thermophilus | 6.18 (0.05) | N/A | <1.00 | N/A |
| B. cereus | 6.28 (0.14) | 6.07 (0.14) | 6.39 (0.14) | 5.03 (0.03) |
| G. stearo- | 6.01 (0.20) | 5.80 (0.21) | 5.67 (0.03) | 5.39 (0.02) |
| thermophilus | | | | |
| C. perfringens | 5.51 (0.07) | 3.34 (0.46) | 2.77 (0.06) | 0.80 (0.17) |

TABLE 3
Microbial load of low temperature, extended time pasteurized milk
with extended holding at 60° C. and 55° C.

| | | Log Count CFU/g | |
|---|---|---|---|
| | | (Standard Deviation; n = 3) | |
| Product | Inoculum | Total Count | Spore Count |
| Pasteurized Milk | B. cereus | 6.39 (0.14) | 5.03 (0.03) |
| 65° C., 24 hours | G. stearothermophilus | 5.67 (0.03) | 5.39 (0.02) |
| | C. perfringens | 2.77 (0.06) | 0.80 (0.17) |
| Pasteurized Milk | B. cereus | 6.38 (0.19) | 5.66 (0.03) |
| 65° C., 24 hours | G. stearothermophilus | 5.64 (0.03) | 5.50 (0.13) |
| 60° C., 24 hours | C. perfringens | 1.44 (0.13) | 0.23 (0.40) |
| Pasteurized Milk | B. cereus | 6.22 (0.09) | 5.33 (0.09) |
| 65° C., 24 hours | G. stearothermophilus | 5.41 (0.02) | 5.38 (0.09) |
| 60° C., 24 hours | C. perfringens | 0.40 (0.70) | <0.00 |
| 55° C., 24 hours | | | |
| Pasteurized Milk | B. cereus | 6.16 (0.02) | 4.82 (0.11) |
| 65° C., 24 hours | G. stearothermophilus | 5.17 (0.15) | 5.38 (0.05) |
| 60° C., 24 hours | C. perfringens | 0.54 (0.94) | 0.46 (0.80) |
| 55° C., 48 hours | | | |

*<0.00 indicates no survivors detected by direct plating (detection limit 1 CFU/ml).

TABLE 4
Quality indicators of raw and low temperature,
extended time pasteurized milk (n = 3)

| Product | pH | Odor | Texture |
|---|---|---|---|
| Raw Milk | 6.57-6.57 | Odorless, no smell | free flowing, |
| | | | homogenous white |
| | | | fluid |
| Pasteurized Milk | 6.19-6.27 | Odorless, no smell | separated into two |
| 65° C., 24 hours | | | layers; thick off- |
| | | | white top layer |
| | | | with opaque white |
| | | | liquid below |
| Pasteurized Milk | 6.22-6.25 | Sour, formaldehyde | separated into two |
| 65° C., 24 hours | | odors | layers; thick solid |
| 60° C., 24 hours | | | top layer with |
| | | | opaque white |
| | | | liquid below |
| Pasteurized Milk | 6.24-6.28 | Sour odor | separated into two |
| 65° C., 24 hours | | | layers; thick solid |
| 60° C., 24 hours | | | top layer with |
| 55° C., 24 hours | | | opaque white |
| | | | liquid below |
| Pasteurized Milk | 6.19-6.29 | Sour odor | separated into two |
| 65° C., 24 hours | | | layers; thick solid |
| 60° C., 24 hours | | | top layer with |
| 55° C., 48 hours | | | opaque white |
| | | | liquid below |

TABLE 5
Microbial load of raw milk and milk
held at 55° C. for up to 72 hours

| | | Log Count CFU/g | |
|---|---|---|---|
| | | (Standard Deviation; n = 3) | |
| Product | Inoculum | Total Count | Spore Count |
| Raw Milk | Uninoculated | 3.29 (0.06) | N/A |
| | S. thermophiles | 6.18 (0.05) | N/A |
| | B. cereus | 6.28 (0.14) | 6.07 (0.14) |
| | G. stearothermophilus | 6.01 (0.20) | 5.80 (0.21) |
| | C. perfringens | 5.51 (0.07) | 3.34 (0.46) |
| Milk | Uninoculated | 1.53 (1.20) | N/A |
| 55° C., | S. thermophiles | 1.13 (0.51) | N/A |
| 24 hours | B. cereus | 6.30 (0.17) | 5.32 (0.03) |
| | G. stearothermophilus | 5.00 (0.11) | 5.75 (0.05) |
| | C. perfringens | <0.00 | <0.00 |
| Raw Milk | Uninoculated | <1.00 | N/A |
| 55° C., | S. thermophiles | <1.00 | N/A |
| 48 hours Milk | B. cereus | 6.21 (0.08) | 5.50 (0.07) |
| | G. stearothermophilus | 5.10 (0.06) | 5.30 (0.13) |
| | C. perfringens | 0.92 (1.59) | <0.00 |
| Raw Milk | Uninoculated | <1.00 | N/A |
| 55° C., | S. thermophiles | <1.00 | N/A |
| 72 hours Milk | B. cereus | 6.03 (0.12) | 5.39 (0.07) |
| | G. stearothermophilus | 5.14 (0.06) | 5.13 (0.14) |
| | C. perfringens | <0.00 | <0.00 |

*<1.00 indicates no survivors detected by direct plating (detection limit 10 CFU/ml).
*<0.00 indicates no survivors detected by direct plating (detection limit 1 CFU/ml).

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various embodiments described herein can be implemented, individually and/or collectively, by various types of electro-mechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electronics systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a voice-over IP system, etc.), (f) a business entity (e.g., an Internet Service Provider (ISP) entity such as Comcast Cable, Quest, Southwestern Bell, etc), or (g) a wired/wireless services entity (e.g., such as Sprint, Cingular, Nextel, etc.), etc.

Those skilled in the art will appreciate that a user may be representative of a human user, a robotic user (e.g., computational entity), and/or substantially any combination thereof (e.g., a user may be assisted by one or more robotic). In addition, a user as set forth herein, although shown as a single entity may in fact be composed of two or more entities. Those skilled in the art will appreciate that, in general, the same may be said of “sender” and/or other entity-oriented terms as such terms are used herein.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

What is claimed is:

1.-65. (canceled)

66. A device comprising:
a vessel that includes one or more container members,
one or more heater units operably associated with the vessel,
one or more control units configured to operate the one or more heater units,
one or more alert units that include one or more microprocessors that are configured to process temperature data and time data in accordance with one or more predetermined time versus temperature parameter sets and produce an alert when fluid contained within the vessel is safe for consumption.

67.-69. (canceled)

70. The device according to claim 66, wherein the vessel that includes one or more container members comprises:
one or more container members that include at least two walls with a vacuum space between the walls and one or more getters within the vacuum space.

71.-76. (canceled)

77. The device according to claim 66, wherein the one or more heater units operably associated with the vessel comprise:
one or more heater units that include one or more phase change materials.

78. The device according to claim 66, wherein the one or more heater units operably associated with the vessel comprise:
one or more heater units that include one or more cogeneration heaters.

79. (canceled)

80. The device according to claim 66, wherein the one or more heater units operably associated with the vessel comprise:
one or more heater units that are configured to collect radiant heat.

81. The device according to claim 66, wherein the one or more control units configured to operate the one or more heater units comprise:
one or more transmitters.

82. The device according to claim 66, wherein the one or more control units configured to operate the one or more heater units comprise:
one or more receivers.

83.-85. (canceled)

86. The device according to claim 66, wherein the one or more alert units that include one or more microprocessors that are configured to process temperature data and time data in accordance with one or more predetermined time versus temperature parameter sets and produce an alert when fluid contained within the vessel is safe for consumption comprise:
one or more databases that include time and temperature parameter sets for inactivation of pathogens in consumable food products.

87. The device according to claim 66, wherein the one or more alert units that include one or more microprocessors that are configured to process temperature data and time data in accordance with one or more predetermined time versus temperature parameter sets and produce an alert when fluid contained within the vessel is safe for consumption comprise:
one or more microprocessors that are configured to access one or more databases that include one or more time and temperature parameter sets for inactivation of pathogens in consumable food products.

88. A fluid sanitizing and storage method comprising:
heating one or more fluids to one or more temperatures within a range from about 50 degrees Celsius to about 80 degrees Celsius; and
maintaining the one or more fluids for a time period greater than about 60 minutes within the temperature range from about 50 degrees Celsius to about 80 degrees Celsius.

89. (canceled)

90. The fluid sanitizing and storage method according to claim 88, wherein the heating one or more fluids to one or more temperatures within a range from about 50 degrees Celsius to about 80 degrees Celsius comprises:
heating the one or more fluids to one or more temperatures within a range from about 60 degrees Celsius to about 80 degrees Celsius.

91. The fluid sanitizing and storage method according to claim 88, wherein the heating one or more fluids to one or more temperatures within a range from about 50 degrees Celsius to about 80 degrees Celsius comprises:
heating the one or more fluids to one or more temperatures within a range from about 65 degrees Celsius to about 80 degrees Celsius.

92.-94. (canceled)

95. The fluid sanitizing and storage method according to claim 88, wherein the heating one or more fluids to one or more temperatures within a range from about 50 degrees Celsius to about 80 degrees Celsius comprises:
heating the one or more fluids to one or more temperatures within a range from about 55 degrees Celsius to about 70 degrees Celsius.

96. The fluid sanitizing and storage method according to claim 88, wherein the heating one or more fluids to one or more temperatures within a range from about 50 degrees Celsius to about 80 degrees Celsius comprises:
heating the one or more fluids to one or more temperatures within a range from about 55 degrees Celsius to about 65 degrees Celsius.

97.-98. (canceled)

99. The fluid sanitizing and storage method according to claim 88, wherein the heating one or more fluids to one or more temperatures within a range from about 50 degrees Celsius to about 80 degrees Celsius comprises:
heating the one or more fluids to one or more temperatures within a range from about 55 degrees Celsius to about 65 degrees Celsius.

100. The fluid sanitizing and storage method according to claim 88, wherein the heating one or more fluids to one or more temperatures within a range from about 50 degrees Celsius to about 80 degrees Celsius comprises:
heating milk to one or more temperatures within a range from about 55 degrees Celsius to about 70 degrees Celsius.

101.-107. (canceled)

108. The fluid sanitizing and storage method according to claim 88, wherein the maintaining the one or more fluids for a time period greater than about 60 minutes within the temperature range from about 50 degrees Celsius to about 80 degrees Celsius comprises:
maintaining the one or more fluids at one or more temperatures within a range from about 55 degrees Celsius to about 65 degrees Celsius.

109. The fluid sanitizing and storage method according to claim 88, wherein the maintaining the one or more fluids for a time period greater than about 60 minutes within the temperature range from about 50 degrees Celsius to about 80 degrees Celsius comprises:
maintaining the one or more fluids at one or more temperatures within a range from about 55 degrees Celsius to about 60 degrees Celsius.

110. (canceled)

111. The fluid sanitizing and storage method according to claim 88, wherein the maintaining the one or more fluids for a time period greater than about 60 minutes within the temperature range from about 50 degrees Celsius to about 80 degrees Celsius comprises:
maintaining the one or more fluids at one or more temperatures within a range from about 55 degrees Celsius to about 65 degrees Celsius.

112. The fluid sanitizing and storage method according to claim 88, wherein the maintaining the one or more fluids for a time period greater than about 60 minutes within the temperature range from about 50 degrees Celsius to about 80 degrees Celsius comprises:
maintaining milk for a time period greater than about 120 minutes within the temperature range from about 50 degrees Celsius to about 80 degrees Celsius.

113.-114. (canceled)

115. The fluid sanitizing and storage method according to claim 88, wherein the maintaining the one or more fluids for a time period greater than about 60 minutes within the temperature range from about 50 degrees Celsius to about 80 degrees Celsius comprises:
maintaining the one or more fluids within a temperature range that inhibits growth of one or more microorganisms for a time period between about 60 minutes and about 7200 minutes.

116. The fluid sanitizing and storage method according to claim 88, wherein the maintaining the one or more fluids for a time period greater than about 60 minutes within the temperature range from about 50 degrees Celsius to about 80 degrees Celsius comprises:
maintaining the one or more fluids within a temperature range that inhibits growth of one or more microorganisms for a time period between about 60 minutes and about 4320 minutes.

117.-132. (canceled)

133. A pasteurization system comprising:
circuitry configured to operate one or more control units that dynamically control one or more heater units in accordance with one or more predetermined time versus temperature parameter sets that are specific for one or more fluids that are to be pasteurized, and
circuitry configured to operate one or more heater units in response to the circuitry configured to operate one or more control units that dynamically control one or more heater units in accordance with one or more predetermined time versus temperature parameter sets that are specific for one or more fluids that are to be pasteurized.

134. (canceled)

135. The system according to claim 133, wherein the circuitry configured to operate one or more control units that dynamically control one or more heater units in accordance with one or more predetermined time versus temperature parameter sets that are specific for one or more fluids that are to be pasteurized comprises:
circuitry configured to control one or more microprocessors that are configured to access one or more databases that include one or more time and temperature parameter sets for inactivation of pathogens in consumable food products and to control the one or more heater units in accordance with the one or more parameter sets.

136. The system according to claim 133, wherein the circuitry configured to operate one or more control units that dynamically control one or more heater units in accordance with one or more predetermined time versus temperature parameter sets that are specific for one or more fluids that are to be pasteurized comprises:
circuitry configured to control one or more transmitters.

137. The system according to claim 133, wherein the circuitry configured to operate one or more control units that dynamically control one or more heater units in accordance with one or more predetermined time versus temperature parameter sets that are specific for one or more fluids that are to be pasteurized comprises:
circuitry configured to control one or more receivers.

138. The system according to claim 133, wherein the circuitry configured to operate one or more control units that dynamically control one or more heater units in accordance with one or more predetermined time versus temperature parameter sets that are specific for one or more fluids that are to be pasteurized comprises:
circuitry configured to control one or more user interfaces.

139.-143. (canceled)

144. The system according to claim 133, wherein the circuitry configured to operate one or more heater units in response to the circuitry configured to operate one or more control units that dynamically control one or more heater units in accordance with one or more predetermined time versus temperature parameter sets that are specific for one or more fluids that are to be pasteurized comprises:
circuitry configured to control the one or more heater units that include one or more cogeneration heaters.

145.-148. (canceled)

149. The system according to claim 133, wherein the circuitry configured to operate one or more heater units in response to the circuitry configured to operate one or more control units that dynamically control one or more heater units in accordance with one or more predetermined time versus temperature parameter sets that are specific for one or more fluids that are to be pasteurized comprises:
circuitry configured to control the one or more heater units that are configured to maintain one or more fluids contained within the vessel at a temperature between about 55 degrees Celsius and about 70 degrees Celsius.

150. The system according to claim 133, further comprising:
circuitry configured to control one or more agitator units.

151.-154. (canceled)

155. The system according to claim 150, wherein the circuitry configured to control one or more agitator units comprises:
circuitry configured to control one or more agitators that are configured to degas milk.

156. The system according to claim 133, further comprising:
circuitry configured to control one or more dispenser units.

157.-158. (canceled)

159. The system according to claim 133, further comprising:
circuitry configured to control one or more monitoring units.

160. (canceled)

161. The system according to claim 159, wherein the circuitry configured to control one or more monitoring units comprises:
circuitry configured to control one or more monitoring units that are configured to monitor temperature history.

162.-163. (canceled)

164. The system according to claim 159, wherein the circuitry configured to control one or more monitoring units comprises:
circuitry configured to control one or more monitoring units that are configured to monitor location history.

165. (canceled)

166. The system according to claim 159, wherein the circuitry configured to control one or more monitoring units comprises:
circuitry configured to control one or more monitoring units that are configured to monitor fluid level history.

167. (canceled)

168. The system according to claim 159, wherein the circuitry configured to control one or more monitoring units comprises:
circuitry configured to control one or more monitoring units that are configured to monitor milk quality.

169.-173. (canceled)

174. The system according to claim 133, further comprising:
circuitry configured to control one or more user interfaces.

175. (canceled)

176. The system according to claim 174, wherein the circuitry configured to control one or more user interfaces comprises:
circuitry configured to control mobile device interfaces.

177. The system according to claim 133, further comprising:
circuitry configured to control one or more alert units that are configured to process temperature data and time data in accordance with one or more predetermined time versus temperature parameter sets that are specific for one or more fluids and produce an alert when the one or more fluids are safe for consumption.

178.-192. (canceled)

193. A system comprising:
a signal-bearing medium bearing:
one or more instructions for operating one or more heater units; and
one or more instructions for operating one or more control units configured to operate the one or more heater units, and
one or more instructions for operating one or more alert units that include one or more microprocessors that are configured to process temperature data and time data in accordance with one or more predetermined time versus temperature parameter sets and produce an alert when fluid contained within the vessel is safe for consumption.

194. The system of claim 193, wherein the signal-bearing medium includes a computer-readable medium.

195. The system of claim 193, wherein the signal-bearing medium includes a recordable medium.

196. The system of claim 193, wherein the signal-bearing medium includes a communications medium.
